(19) United States
(12) Patent Application Publication
(10) Pub. No.: US 2025/0192568 A1
(43) Pub. Date: Jun. 12, 2025

(54) SYSTEM AND METHODS FOR LOAD FREQUENCY CONTROL OF MULTI-AREA HYBRID RENEWABLE ENERGY POWER SYSTEM

(71) Applicant: KING FAHD UNIVERSITY OF PETROLEUM AND MINERALS, Dhahran (SA)

(72) Inventors: Muhammad Majid GULZAR, Dhahran (SA); Muhammad KHALID, Dhahran (SA)

(73) Assignee: KING FAHD UNIVERSITY OF PETROLEUM AND MINERALS, Dhahran (SA)

(21) Appl. No.: 18/530,736

(22) Filed: Dec. 6, 2023

(51) Int. Cl. H02J 3/38; H02J 3/46

(52) U.S. Cl. CPC H02J 3/381; H02J 3/46; H02J 2203/20; H02J 2300/24; H02J 2300/28

(57) ABSTRACT

A hybrid controller and method for mitigating frequency disturbances in a multi-area power plant including multiple thermal energy generators and renewable energy sources includes a cascaded fractional model predictive controller (CFMPC), first and second fractional-order proportional-integral-derivative controllers (FOPID-1 and FOPID-2) and a sooty terns controller. The CFMPC generates a minimized area central error (ACE) signal based on minimizing a controlled fitness equation, an ACE signal and a load power disturbance signal (ΔP_{L}). The FOPID-1 generates a frequency disturbance correction signal based on the frequency disturbance value (Δfᵢ). A combined frequency correction signal is generated by adding negative values of the minimized ACE signal and the frequency disturbance correction signal. The FOPID-2 receives the combined frequency correction signal and generates a frequency error correction signal. The sooty terns controller generates optimized gain parameters and transmits the optimized parameters to the FOPID-1 and the FOPID-2 to mitigate the frequency disturbances.

### STATEMENT REGARDING PRIOR DISCLOSURE BY THE INVENTORS

Aspects of this technology are described in an article titled “Cascaded Fractional Model Predictive Controller for Load Frequency Control in Multiarea Hybrid Renewable Energy System with Uncertainties”, published by Hindawi International Journal of Energy Research, Vol. 2023, which is incorporated herein by reference in its entirety.

### STATEMENT OF ACKNOWLEDGEMENT

The inventor(s) acknowledge the financial support provided by the Center of Renewable Energy and Power Systems, King Fahd University of Petroleum and Minerals (KFUPM), Riyadh, Saudi Arabia, through Project No. INRE2106. The inventor(s) further acknowledge the financial support provided by the Saudi Authority for Data and Artificial Intelligence (SDAIA)-KFUPM Joint Research Center for Artificial Intelligence (JRC-AI).

### BACKGROUND

### Technical Field

The present disclosure is directed to a method and system for load frequency control of uncertainties in a multi-area hybrid renewable energy power system.

### Description of Related Art

Electricity has played an essential role in the evolution of the industrialization process. Sources of electricity in conventional systems include thermal power plants, fossil fuel power plants, gas power plants and the like. Thermal energy power plants are used as base-load plants that are independent of weather conditions and can be operated whenever required.

In recent years, there has been rapid development and the use of renewable energy sources (RES) due to their freely available nature and their minimal environmental impact. Renewable energy sources contribute to the reduction of the carbon footprint in the power sector. Given the easy availability of RES, they are now integrated with conventional generators, such as grid or microgrid-connected RES, to meet the demands for electricity. However, RES are weather-dependent, resulting in intermittent electricity generation which negatively affects the power quality of the energy-generating system. Power quality variations in the energy-generating system manifest as frequency variations.

The regulation of frequency in energy-generating systems is typically managed through load frequency control (LFC) methods. LFC also oversees power flow control across multiple areas using tie-lines. The concept of the tie-line is well-established in the field, defined as an interconnection among various power-generating units at different locations to share and regulate power flow. This regulation addresses load variations in one power-generating unit affecting another or vice versa.

There has been extensive research on controlling methods of LFC to refine the frequency variation in a single area or a multi-area network. Over the decades, conventional control techniques for LFC, such as proportional-integral (PI), integral (I), and proportional-integral-derivative (PID) controllers, have been applied in industries due to their easy implementation and low complexity. However, conventional techniques have many limitations. For example, although the PID controller reduces the steady-state error, the drawback of using a traditional PID controller is that it is difficult to find its optimal state due to trade-offs between a derivative part and an integral part. Although increasing an integral portion fixes some of the issues, the integral term in the controller causes unwanted behavior during the transitory stage. Moreover, finding the optimal performance for PID controllers has become challenging due to the trade-off between derivative gain and integral gain.

Further research has sought to address the limitations of conventional methods, identifying new approaches for controlling Load Frequency Control (LFC) by combining traditional control techniques with newer algorithms. Examples include the bacteria foraging optimization algorithm (BFOA), ant colony optimization (ACO), salp swarm algorithm (SSA), firefly algorithm, and whale optimization algorithm (WOA). In a different study, an FOPI controller was developed using a dragonfly search algorithm in a multiarea power system. Additionally, the flexible structures of FOPID/FOPI/FOI were implemented for automatic generation control (AGC) in the power system to enhance the compatibility of fractional-order structures. Furthermore, cascaded controller designs, such as PI-PD and PD-PID, FOPI-FOPID using various optimizing algorithms, were employed in LFC for multiarea power energy systems. Particle swarm optimization (PSO) was utilized to tune FOPI-FOPD cascaded with fuzzy logic.

Modifications to the control structure have been the focus of study, and as a result, control structures have been designed to enhance the performance of the controller. For example, a fractional-order fuzzy PID controller was introduced for controlling Load Frequency Control (LFC) in a multiarea power system. Similarly, chaos game optimization (CGO) was applied to optimize FOPID-FOPI for a multiarea power system. Additionally, a tilted integral derivative (TID) was employed for LFC, both with and without a filter.

In another research effort, a model predictive controller (MPC) was implemented for a thermal-based power system where the impact of renewable energy sources (RES) was not considered. Similarly, an adaptive model predictive controller (AMPC) was formulated to address frequency oscillations perturbed by load disturbances in a hybrid power system. Recently, a master-slave-based controller was designed for a multi-area power system, investigating the effects of LFC and faults in the power system.

An application of a fractional order proportional integral-fractional order proportional derivative (FOPI-FOPD) cascade controller for load frequency control (LFC) of electric power generating systems was disclosed. (See: çelik, Emre, “Design of new fractional order PI-fractional order PD cascade controller through dragonfly search algorithm for advanced load frequency control of power systems”, Soft Computing 25, no. 2 (2021): 1193-1217). The proposed controller includes fractional order PI and fractional order PD controllers connected in cascade wherein orders of integrator and differentiator may be fractional. However, this reference does not disclose a solution for achieving rapid response in settling frequency deviations.

An automatic load frequency control (ALFC) of two-area multisource hybrid power system (HPS) was disclosed. (See: Veerasamy, Veerapandiyan, Noor Izzri Abdul Wahab, Rajeswari Ramachandran, Mohammad Lutfi Othman, Hashim Hizam, Andrew Xavier Raj Irudayaraj, Josep M. Guerrero, and Jeevitha Satheesh Kumar, “A Hankel matrix based reduced order model for stability analysis of hybrid power system using PSO-GSA optimized cascade PI-PD controller for automatic load frequency control”, IEEE Access 8 (2020): 71422-71446). However, this reference is unable to provide a solution for achieving rapid response in terms of undershoot and overshoot.

A reference incorporating a geothermal power plant (GTPP), a dish-Stirling solar thermal system (DSTS) and a high voltage direct current transmission (HVDC) link, with a conventional thermal system in automatic generation control of an interconnected power system under deregulated environment was disclosed. (See: Tasnin, Washima, and Lalit Chandra Saikia. “Deregulated AGC of multi-area system incorporating dish-Stirling solar thermal and geothermal power plants using fractional order cascade controller”, International Journal of Electrical Power & Energy Systems 101 (2018): 60-74). However, this reference does not provide a solution for achieving a rapid response in terms of overshoot.

A photovoltaic (PV) connected thermal system incorporating PV to operate at maximum power point (MPP) was disclosed. (See: Gulzar, Muhammad Majid, Syed Tahir Hussain Rizvi, Muhammad Yaqoob Javed, Daud Sibtain, and Rubab Salah ud Din. “Mitigating the load frequency fluctuations of interconnected power systems using model predictive controller”, Electronics 8, no. 2 (2019): 156). However, this reference does not provide a solution for achieving a rapid response in terms of minimum settling time, undershoot and overshoot.

Each of the aforementioned references suffers from one or more drawbacks hindering their adoption for providing a solution for achieving rapid response of a controller to uncertainties, such as power disturbances, in terms of minimum settling time, undershoot and overshoot. Moreover, the response times of the above references at the time of frequency fluctuation art are high.

Accordingly, it is one object of the present disclosure to provide methods and systems for mitigating out-of-bounds fluctuations in system frequency in a multi-area hybrid renewable energy power system.

### SUMMARY

In an exemplary embodiment, a hybrid control system for mitigating frequency disturbances in a multi-area power plant is disclosed. The multi-area power plant includes a first thermal energy generator located in a first geographic area and a second thermal energy generator located in a second geographic area. An output terminal of the second thermal energy generator is connected to an output terminal of the first thermal energy generator by a tie-line. The multi-area power plant further includes a plurality of renewable energy sources (RES) having output terminals connected to the tie-line. The multi-area power plant further includes a plurality of loads connected to the tie-line. The multi-area power plant further includes a first adder configured to receive a frequency disturbance value Δfᵢ multiplied by a frequency bias factor βᵢ and to receive a tie-line power disturbance signal ΔP_{tie,i} from the tie-line over a measurement interval i, add the frequency disturbance value Δfᵢ multiplied by the frequency bias factor βᵢ to the tie-line power disturbance signal ΔP_{tie,i} and generate an area central error (ACE) signal. The hybrid controller includes a cascaded fractional model predictive controller (CFMPC) including a set of CFMPC program instructions and at least one CFMPC processor configured to execute the set of CFMPC program instructions to receive the area central error (ACE) signal and a load power disturbance signal ΔP_{L}_{ᵢ} predict a future output of the power plant, minimize a controlled fitness equation (ITAE) based on the predicted future output, and generate a minimized ACE signal based on the minimizing the ITAE. The hybrid controller further includes a first fractional-order proportional-integral-derivative (FOPID-1) controller configured to receive the frequency disturbance value Δfᵢ and generate a frequency disturbance correction signal based on a set of FOPID-1 gain parameters and the frequency disturbance value Δfᵢ. The hybrid controller further includes a second adder configured to add a negative of the minimized ACE signal to a negative of the frequency disturbance correction signal and generate a combined frequency correction signal. The hybrid controller further includes a second fractional-order proportional integral derivative (FOPID-2) controller configured to receive the combined frequency correction signal from the second adder and generate a frequency error correction signal. The hybrid controller further includes a sooty terns controller configured to generate optimized controller gain parameters and transmit the optimized controller gain parameters to the FOPID-1 controller and the FOPID-2 controller. The multi-area power plant further includes a first droop controller configured to receive the frequency disturbance value Δfᵢ, calculate a first droop value 1/R₁, multiply the frequency disturbance value Δfᵢ by the first droop value 1/R₁, and generate a first droop control signal. The multi-area power plant further includes a first subtractor configured to receive the frequency error correction signal and the first droop control signal, subtract the first droop control signal from the frequency error correction signal, and transmit a first frequency error difference signal to the first thermal energy generator. The first thermal energy generator is configured to receive the first frequency error difference signal and generate a first power error signal ΔP_{R}_{₁} The multi-area power plant further includes a second droop controller configured to receive the frequency disturbance value Δfᵢ, calculate a second droop value 1/R₂, multiply the frequency disturbance value Δfᵢ by the second droop value 1/R₂, and generate a second droop control signal. The multi-area power plant further includes a second subtractor configured to receive the frequency error signal and the second droop control signal, subtract the second droop control signal from the frequency error correction signal and transmit a second frequency error difference signal to the second thermal energy generator. The second thermal energy generator is configured to receive the second frequency error difference signal and generate a second power error signal ΔP_{R}_{₂}. The multi-area power plant further includes a third adder configured to add the first power error signal ΔP_{R}_{₁}, the second power error signal ΔP_{R}_{₂}, and an RES power error signal ΔPRES, and generate a plant power error signal ΔPₛ. A third subtractor is configured to receive the plant power error signal ΔPₛ and subtract the load power disturbance signal ΔP_{L}_{ᵢ} and the tie-line power disturbance signal ΔP_{tie,i} from the plant power error signal ΔPₛ and generate a plant power output error signal. The multi-area power plant further includes a output generator configured to receive the plant power output error signal and generate the frequency disturbance value Δfᵢ. The multi-area power plant further includes a feedback connection line configured to transmit the frequency disturbance value Δfᵢ to the first droop controller, the second droop controller and the first adder.

In another exemplary embodiment, a two-area hybrid power control system for mitigating frequency disturbances is disclosed. The two-area hybrid power control system includes a first power system located in a first geographic area, a second power system located in a second geographic area, a tie-line configured to connect an output terminal of the first power system with an output terminal of the second power system, The first power system includes a first controller (CSMPC-FOPID-1), a first thermal energy generator connected in series with the CSMPC-FOPID-1. The first thermal energy generator is configured to generate a first thermal generator power disturbance signal ΔP_{R}_{₁}. The first power system further includes a first plurality of renewable energy resources (RES-1). Each RES-1 has an RES-1 output terminal configured to generate a first RES-1 power disturbance signal ΔPᵣₑₛ_{₁}. The first power system further includes a first load configured to generate a first load power disturbance signal ΔP_{L}_{₁} at a load output terminal, a first adder connected to an input terminal of the CSMPC-FOPID-1. The first adder is configured to generate a first area central error (ACE-1) signal. The first power system further includes a second adder connected to receive the first thermal generator power disturbance signal ΔP_{R}_{₁}, the first RES-1 power disturbance signal ΔPᵣₑₛ_{₁} the load power disturbance signal ΔP_{L}_{₁}, and a tie-line power disturbance signal ΔPₜᵢₑ from the tie-line, sum the first thermal generator power disturbance signal ΔP_{R}_{₁} with the first RES-1 power disturbance signal ΔPᵣₑₛ_{₁}, subtract the first load power disturbance signal ΔP_{L}_{₁}, subtract the tie-line power disturbance signal ΔPₜᵢₑ, and generate a first geographic area power disturbance signal ΔPₛ_{₁}. The first power system further includes a first output generator configured to receive the first geographic area power disturbance signal ΔPₛ_{₁} convert the first geographic area power disturbance signal ΔPₛ_{₁} to a first geographic area frequency disturbance value Δfᵢ, and output the first geographic area frequency disturbance value Δf₁ at a first output generator output terminal connected to the tie-line and a first feedback connection line connected to the tie-line. The first feedback connection line is configured to transmit the first geographic area frequency disturbance value Δfᵢ to an input terminal of the first adder. The second power system includes a second controller (CSMPC-FOPID-2), a second thermal energy generator connected in series with the CSMPC-FOPID-2. The second thermal energy generator is configured to generate a second thermal generator power disturbance signal ΔP_{R}_{₂}. The second power system further includes a second plurality of renewable energy resources (RES-2). Each RES-2 has an RES-2 output terminal configured to generate a second RES-2 power disturbance signal ΔPᵣₑₛ_{₂}. The second power system further includes a second load configured to generate a second load power disturbance signal ΔP_{L}_{₂} from a load output terminal, a third adder connected to an input terminal of the CSMPC-FOPID-2. The third adder is configured to generate a second area central error (ACE-2) signal. The second power system further includes a fourth adder 534 connected to receive the second thermal generator power disturbance signal ΔP_{R}_{₂}, the second RES-2 power disturbance signal ΔPᵣₑₛ_{₂}, the load power disturbance signal ΔP_{L}_{₂}, and the tie-line power disturbance signal ΔPₜᵢₑ, sum the second thermal generator power disturbance signal ΔP_{R}_{₂} with the second RES-2 power disturbance signal ΔPᵣₑₛ_{₂}, subtract the second load power disturbance signal ΔP_{L}_{₂}, subtract the tie-line power disturbance signal ΔPₜᵢₑ, and generate a second geographic area power disturbance signal ΔPₛ_{₂}. The second power system further includes a second output generator configured to receive the second geographic area power disturbance signal ΔPₛ_{₂} convert the second geographic area power disturbance signal ΔPₛ_{₂} to a second geographic area frequency disturbance value Δf₂, and output the second geographic area frequency disturbance value Δf₂ at a second output generator output terminal connected to the tie-line, and a second feedback connection line connected to the tie-line. The second feedback connection line is configured to transmit the second geographic area frequency disturbance value Δf₂ to an input terminal of the third adder. The CSMPC-FOPID-1 includes a first cascaded fractional model predictive controller (CFMPC₁) including a set of CFMPC₁ program instructions and at least one CFMPC₁ processor configured to execute the set of CFMPC₁ program instructions to receive the ACE-1 signal and the first load power disturbance signal ΔP_{L}_{₁}, predict a future power output of the first power system, minimize a first controlled fitness equation (ITAE₁) based on the predicted future power output of the first power system, and generate a minimized ACE-1 signal based on the minimizing the ITAE₁, a first fractional-order proportional-integral-derivative (FOPID-1) controller configured to receive the frequency disturbance value Δfᵢ and generate a first frequency disturbance correction signal based on a set of first FOPID-1 gain parameters and the first frequency disturbance value Δfᵢ, a fifth adder configured to add a negative of the minimized ACE-1 signal to a negative of the first frequency disturbance correction signal and generate a first combined frequency correction signal, a second fractional-order proportional integral derivative (FOPID-2) controller configured to receive the first combined frequency correction signal from the fifth adder and generate a first frequency error correction signal, a first sooty terns controller configured to generate a set of first optimized controller gain parameters and transmit the set of first optimized controller gain parameters to the FOPID-1 controller 604-1 and the FOPID-2 controller. The CSMPC-FOPID-2 includes a second cascaded fractional model predictive controller (CFMPC₂) including a set of CFMPC₂ program instructions and at least one CFMPC₂ processor configured to execute the set of CFMPC₂ program instructions to receive the ACE-2 signal and the second load power disturbance signal ΔP_{L}_{₂}, predict a future output of the second power system, minimize a second controlled fitness equation (ITAE₂) based on the predicted future output of the second power system, and generate a minimized ACE-2 signal based on the minimizing the ITAE₂, a third fractional-order proportional-integral-derivative (FOPID-3) controller configured to receive the second frequency disturbance value Δf₂ and generate a second frequency disturbance correction signal based on a set of FOPID-3 gain parameters and the second frequency disturbance value Δf₂, a sixth adder configured to add a negative of the minimized ACE-2 signal to a negative of the second frequency disturbance correction signal and generate a second combined frequency correction signal, a fourth fractional-order proportional integral derivative (FOPID-4) controller configured to receive the second combined frequency correction signal from the sixth adder and generate a second frequency error correction signal, a second sooty terns controller configured to generate a set of second optimized controller gain parameters and transmit the set of second optimized controller gain parameters to the FOPID-3 controller and the FOPID-4 controller; and a transmission line 558 connected at a first end to the tie-line. A first terminal of a second end is connected to a second input terminal of the first adder and a second terminal of the second end is connected to a second input terminal of the third adder. The transmission line 558 is configured to feed back a combined area tie-line power disturbance value ΔPₜᵢₑ_{_{1,2}} to the first adder and the third adder.

In another exemplary embodiment, a method for mitigating frequency disturbances in a multi-area power plant which includes a plurality of generators and a plurality of renewable energy sources (RES). The method comprises connecting, by a first adder, an output terminal of a cascaded fractional model predictive controller (CFMPC) and an output terminal of a first fractional-order proportional-integral-derivative (FOPID-1) controller to an input terminal of a second fractional-order proportional integral derivative (FOPID-2) controller 408, wherein the CFMPC includes a set of CFMPC program instructions and at least one CFMPC processor configured to execute the set of CFMPC program instructions for receiving an area central error (ACE) signal and a load power disturbance signal ΔP_{L}_{ᵢ} predicting a future output of the power plant, minimizing a controlled fitness equation (ITAE) based on the predicted future output, and generating a minimized ACE signal based on the minimizing the ITAE. The method further comprises generating, by a sooty terns controller, optimized controller gain parameters and transmitting the optimized controller gain parameters to the FOPID-1 controller and the FOPID-2 controller, wherein the sooty terns controller includes a sooty terns controller memory configured to store sooty terns controller program instructions including a sooty terns optimization algorithm (STOA), a set of FOPID-1 gain parameter constraints and a set of FOPID-2 gain parameter constraints, and at least one sooty terns controller configured to execute the STOA to optimize the ITAE, transmit the optimized ITAE to the MPC, and calculate the optimized controller gain parameters of the FOPID-1 controller and the FOPID-2 controller. The method further comprises receiving a frequency disturbance signal Δf at an input terminal of the FOPID-1 controller. The method further comprises generating a frequency disturbance correction signal at an output terminal of the FOPID-1 controller. The method further comprises combining, by the first adder, the minimized ACE signal and the frequency disturbance correction signal to generate a combined frequency correction signal. The method further comprises applying the combined frequency correction signal and a first droop control signal to an input of a first thermal generator located in a first geographic area. The method further comprises generating, by the first thermal generator, a first power error signal ΔP_{R}_{₁} The method further comprises applying the combined frequency correction signal and a second droop control signal to an input of a second thermal generator located in a second geographic area. The method further comprises generating, by the second thermal generator, a second power error signal ΔP_{R}_{₂}. The method further comprises combining, by a second adder, the first power error signal ΔP_{R}_{₁} the second power error signal ΔP_{R}_{₂}, an RES power error signal ΔPRES from a plurality of RES, connected to the multi-area power plant. The method further comprises generating, by the second adder, a power disturbance signal. The method further comprises subtracting, by a first subtractor, the power load disturbance feedback signal ΔP_{L} received from at least one load connected to the multi-area power plant, and a tie-line power disturbance signal ΔPₜᵢₑ from the power disturbance signal. The method further comprises generating, by the first subtractor, a plant power output error signal ΔPₛ. The method further comprises converting, by a generator, the plant power output error signal ΔPₛ to a frequency disturbance signal Δf. The method further comprises converting, by a frequency to power converter, the frequency disturbance signal Δf to a tie-line power disturbance signal ΔPₜᵢₑ. The method further comprises receiving, by a bias controller, the frequency disturbance signal Δf over a feedback line, and multiplying the frequency disturbance signal Δf by a frequency bias factor μ. The method further comprises combining, by a third adder, the tie-line frequency disturbance signal ΔPₜᵢₑ and the frequency disturbance signal Δf multiplied by the frequency bias factor 3. The method further comprises generating, by the third adder, the ACE signal. Minimizing the ACE mitigates the frequency disturbances in the multi-area power plant.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates a multi-area power plant, according to certain embodiments.

FIG. 2 illustrates a solar energy system used in the multi-area power plant, according to certain embodiments.

FIG. 3 illustrates a wind energy system used in the multi-area power plant, according to certain embodiments.

FIG. 4 illustrates a high-level view of a hybrid controller, according to certain embodiments.

FIG. 5 illustrates a two-area hybrid power control system for mitigating frequency disturbances, according to certain embodiments.

FIG. 6A illustrates a cascaded fractional model predictive controller (CFMPC) —fractional order proportional-integral-derivative (FOPID) controller for a first area, according to certain embodiments.

FIG. 6B illustrates a CFMPC-FOPID controller for a second area, according to certain embodiments.

FIG. 7 illustrates an STOA flowchart for the CFMPC-FOPID controller, according to certain embodiments.

FIG. 8 illustrates a load pattern applied in both areas for testing a performance of the CFMPC-FOPID based controller, according to certain embodiments.

FIG. 9 illustrates comparative frequency deviation response curves of different controllers in the first area upon application of fluctuating load pattern in both areas, according to certain embodiments.

FIG. 10 illustrates comparative frequency deviation response curves of different controllers in the second area upon application of fluctuating load pattern in both areas, according to certain embodiments.

FIG. 11 illustrates power exchange pattern (tie-line) curves between the two-areas under a similar load condition, according to certain embodiments.

FIG. 12 illustrates different load pattern curves applied in both areas for testing the performance of the CFMPC-FOPID based controller, according to certain embodiments.

FIG. 13 illustrates frequency deviation response curves of the CFMPC-FOPID based controller in the first area on application of a fluctuating but distinct load pattern in both areas, according to certain embodiments.

FIG. 14 illustrates frequency deviation response curves of the CFMPC-FOPID based controller in the second area on application of fluctuating but distinct load pattern in both areas, according to certain embodiments.

FIG. 15 illustrates power exchange pattern (tie-line) curves between the two-areas under a distinct load, according to certain embodiments.

FIG. 16A illustrates analysis curves of the CFMPC-FOPID based controller for area-1 under uncertainty in the system parameters at +50% variation of parameter, according to certain embodiments.

FIG. 16B illustrates frequency deviation curves of a CFMPC-FOPID based controller for area-2 under uncertainty in the system parameters at +50% variation of parameter, according to certain embodiments.

FIG. 17A illustrates tie-line power response curves of the CFMPC-FOPID based controller under uncertainty in the system parameters at +50% variation of parameter, according to certain embodiments.

FIG. 17B illustrates analysis curves of the CFMPC-FOPID based controller for area-1 under uncertainty in the system parameters at −50% variation of parameter, according to certain embodiments.

FIG. 18A illustrates frequency deviation curves of the CFMPC-FOPID based controller 104 for area-2 under uncertainty in the system parameters at −50% variation of parameter, according to certain embodiments.

FIG. 18B illustrates tie-line power response curves of the CFMPC-FOPID based controller under uncertainty in the system parameters at −50% variation of parameter, according to certain embodiments.

FIG. 19A illustrates nonlinearities and sensitivity response analysis curves of the CFMPC-FOPID based controller in a first area, according to certain embodiments.

FIG. 19B illustrates nonlinearities and sensitivity response analysis curves of the CFMPC-FOPID based controller in a second area, according to certain embodiments.

FIG. 20A illustrates sensitivity response analysis curves for CFMPC-FOPID based controller in the first area to verify the robustness of the CFMPC-FOPID based controller, according to certain embodiments.

FIG. 20B illustrates sensitivity response analysis curves for CFMPC-FOPID based controller in a second area to verify the robustness of the CFMPC-FOPID based controller, according to certain embodiments.

FIG. 21 illustrates sensitivity response analysis curves for the tie-line to verify the robustness of the CFMPC-FOPID based controller, according to certain embodiments.

FIG. 22A illustrates a generation response of the wind power output curve, according to certain embodiments.

FIG. 22B illustrates a generation response of a photovoltaic (PV) system output curve, according to certain embodiments.

FIG. 23A illustrates a load pattern generation curve in an automatic generation control (AGC)-deregulated environment, according to certain embodiments.

FIG. 23B illustrates an overall impact analysis of the renewable source into the power system and the performance of the CFMPC-FOPID based controller in a first area in an AGC-deregulated environment, according to certain embodiments.

FIG. 23C illustrates an overall impact analysis of the renewable source into the power system and the performance of the CFMPC-FOPID based controller in a second area in an AGC-deregulated environment, according to certain embodiments.

FIG. 23D illustrates an overall impact analysis of the renewable source over the tie-line power pattern in an AGC-deregulated environment, according to certain embodiments.

FIG. 24 illustrates power system stability response curves with the CFMPC-FOPID based controller, according to certain embodiments.

FIG. 25 illustrates a convergence analysis curves of the CFMPC-FOPID based controller, according to certain embodiments.

FIG. 26 illustrates a flowchart of a method for mitigating frequency disturbances in a multi-area power plant, according to certain embodiments.

FIG. 27 is an illustration of a non-limiting example of details of computing hardware used in the computing system, according to certain embodiments.

FIG. 28 is an exemplary schematic diagram of a data processing system used within the computing system, according to certain embodiments.

FIG. 29 is an exemplary schematic diagram of a processor used with the computing system, according to certain embodiments.

FIG. 30 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise. Furthermore, the terms “approximately,” “approximate”, “about” and similar terms generally refer to ranges that include the identified value within a margin of 20%, 10%, or preferably 5%, and any values therebetween.

The terms “hybrid controller” and “CFMPC-FOPID based controller” represent the same controller and are used throughout the disclosure synonymously.

The terms “solar energy system”, “solar system”, “PV array”, “PV source”, “PV based system”, “photovoltaic array”, “renewable energy source” or “PV based unit” are used throughout the disclosure synonymously.

Furthermore, the terms “wind energy system”, “wind system”, “renewable energy source”, “wind firm system” or “wind turbine”, are used throughout the disclosure synonymously.

Furthermore, the terms “power plant”, “power system” are used throughout the disclosure synonymously.

Aspects of this disclosure are directed to a hybrid control system, a two-area hybrid power control system and a method for a hybrid controller for synchronizing renewable energy sources (RES) with hydroelectric energy generators to a point of common coupling (PCC) of a utility grid. The hybrid control system includes a cascaded fractional model predictive controller (CFMPC) configured to receive an area central error (ACE) signal from each of the RES and the hydroelectric energy generator and output an error correction signal; a first fractional order proportional-integral-derivative (FOPID) controller configured to receive a frequency error value from each of the RES and the hydroelectric energy generator and output a combined frequency error; an adder configured to combine the error correction signal and the combined frequency error and generate a combined error signal; a second FOPID controller configured to receive the combined error signal and minimize the ACE signal; and a sooty terns controller configured to calculate controller gain parameters of the MPC, the first FOPID controller and the second FOPID controller and transmit the controller gain parameters to the MPC, the first FOPID controller and the second FOPID controller. The CFMPC-FOPID controller minimizes the ACE signal value to zero in order to stabilize the frequency variation. The details of the hybrid controller are explained further in the description.

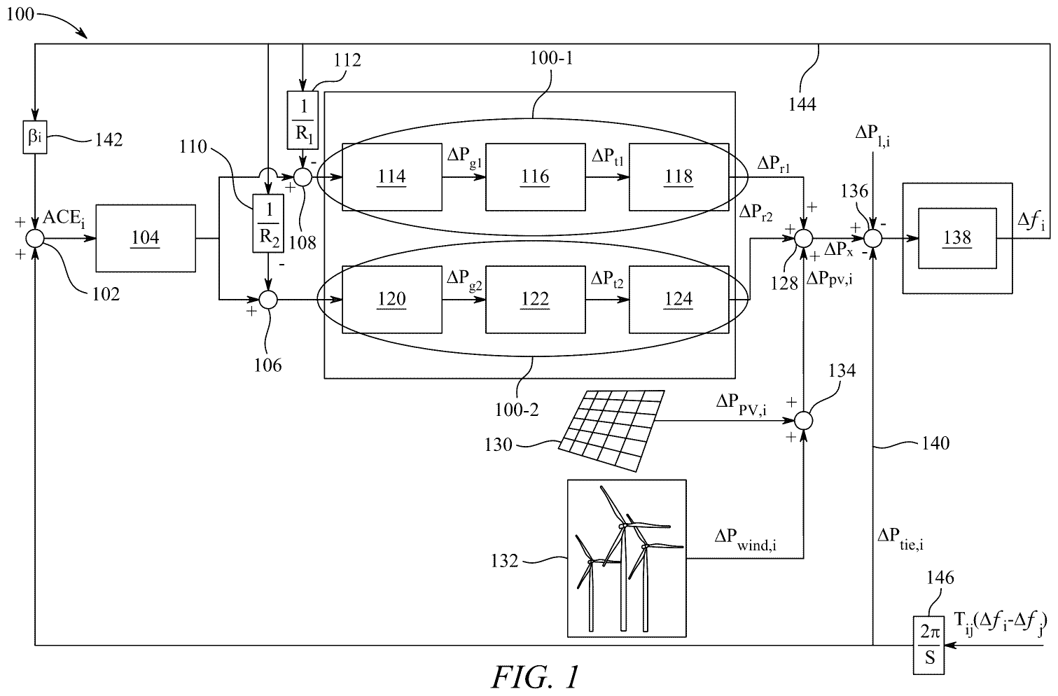

FIG. 1 illustrates a multi-area power plant 100, according to an embodiment. The multi-area power plant 100 may include at least two or more power plants or power systems. The power plant may refer to an electrical power plant, a thermal power plant, a hydropower plant, a nuclear power plant, a steam-electric power plant, a coal-fired power plant, a geothermal power plant and the like. Although the disclosure is described by considering thermal power plants, it is not restrictive to the thermal power plants alone and encompasses other types of power plants.

The multi-area power plant 100 has one or more regions or areas of electrical network. Each region of the one or more regions has a thermal power system, such as a first thermal energy generator 100-1 and a second thermal energy generator 100-2. The first thermal energy generator 100-1 and the second thermal energy generator 100-2 are physically separated by a certain geographical distance. As such, the first thermal energy generator 100-1 and the second thermal energy generator 100-2 are located in a first geographic area and a second geographic area, respectively. The first thermal energy generator 100-1 includes a first governor 114 with a dead band block, a first turbine with a rotor block 116 and a first reheater block 118. Each of the blocks of the first thermal energy generator 100-1 are connected in series. Similarly, the second thermal energy generator 100-2 includes a second governor 120 with a dead band block, a second turbine with a rotor block 122 and a second reheater block 124. Each of the blocks in the second thermal energy generator 100-2 are also connected in series.

The operation of the first thermal energy generator 100-1 is now described in detail. The first governor 114 with dead band block supports controlling the frequency under unbalanced loading. A transfer function of the first governor 114 with dead band block is given as below:

$${G}_{gov} ( s ) = \frac{0.8 - ( \frac{0.2}{π} ) s}{1 + {sT}_{g 1}} \qquad ( 1 )$$

where T_{g1} is the governor time constant of the first thermal energy generator 100-1.

The first governor 114 with dead band block is configured to generate an output as provided below:

$$Δ {P}_{g 1} ( s ) = Δ {P}_{ref} ( s ) - \frac{1}{R 1} Δ {f}_{i} ( s ) . \qquad ( 2 )$$

where, ΔP_{ref} is the reference power and Δfᵢ is the change in frequency, while a droop value is presented by

$$\frac{1}{R} .$$

Accordingly, the first governor with dead band block 114 is configured to receive the first droop control signal

$$\frac{1}{R 1} Δ {f}_{i} ( s )$$

and subtract it from a reference power ΔP_{ref}(s) generated from a hybrid controller 104 and output a power change signal ΔPg₁. S is a complex function value of a Laplace transform. The Laplace transform has been used to convert real variables in the system loop to complex variables as is commonly done to simplify calculations.

The output ΔP_{g1}(s) of the first governor with dead band block 114 is fed as an input to the first turbine at the rotor block 116. The rotor block 116 has a transfer function as given below:

$${G}_{t} ( s ) = \frac{{K}_{t}}{1 + {sT}_{g 1}} , \qquad ( 3 )$$

The first turbine with the rotor block 116 is configured to receive the power change signal ΔPg₁, modify the speed of the rotor and generate an output ΔPₜ₁.

The output ΔPₜ₁ of the first turbine with the rotor block 116 is fed as input to the first reheater block 118. The first reheater block 118 has a transfer function as below:

$${G}_{r} ( s ) = \frac{1 + {sK}_{r 1} {T}_{r 1}}{1 + {sT}_{r 1}} , \qquad ( 4 )$$

where Kᵣ₁ represents the reheat gain of the reheater block and Tri represents the reheat time constant.

The first reheater block 118 is configured to generate a first power error signal ΔPr₁ as an output when the input ΔPₜ₁ is fed to the first reheater block 118.

Similarly, the operation of the second thermal energy generator 100-2 is now described in detail. The transfer function of the second governor with dead band block 120 as given below:

$${G}_{gov} ( s ) = \frac{0.8 - ( \frac{0.2}{π} ) s}{1 + {sT}_{g 2}} , \qquad ( 5 )$$

where T_{g2} is the governor time constant of the second thermal energy generator 100-2.

The second governor with dead band block 120 is configured to generate an output as given below:

$$Δ {P}_{g 2} ( s ) = Δ {P}_{ref} ( s ) - \frac{1}{R 2} Δ {f}_{i} ( s ) , \qquad ( 6 )$$

where, ΔP_{ref} is the reference power and Δfᵢ is the change in frequency, while the droop value is presented by

$$\frac{1}{R 2} .$$

Accordingly, the second governor with dead band block 120 is configured to receive the second droop control signal

$$\frac{1}{R 2} Δ {f}_{i} ( s )$$

and subtract it from a reference power ΔP_{ref}(s) generated from the hybrid controller 104 and output a power change signal ΔPg₂.

The output ΔP_{g2}(s) of the second governor with dead band block 120 is fed as an input to the second turbine with the rotor block 122. The second turbine with the rotor block 122 has a transfer function as provided below:

$${G}_{t} ( s ) = \frac{{K}_{t}}{1 + {sT}_{g 2}} , \qquad ( 7 )$$

where Kₜ is the governor gain and T_{g2} represents the time constant of the governor of the second turbine.

The second turbine with the rotor block 122 is configured to receive the power change signal ΔP_{g2}, modify the speed of the rotor and generate an output ΔPₜ₂.

The output ΔPₜ₂ of the second turbine with the rotor block 122 is fed as input to the second reheater block 124. The second reheater block 124 has a transfer function as below:

$${G}_{r} ( s ) = \frac{1 + {sK}_{r 2} {T}_{r 2}}{1 + {sT}_{r 2}} , \qquad ( 8 )$$

where Kᵣ₂ represents the reheat gain and Tᵣ₂ represents the time constant of the second reheater block.

The second reheater block 124 is configured to generate an output as ΔPᵣ₂(s) as an output from the second reheater block 124 when the input ΔPₜ₂ is fed to the second reheater block 124, where t refers to a time window of measurement of the power.

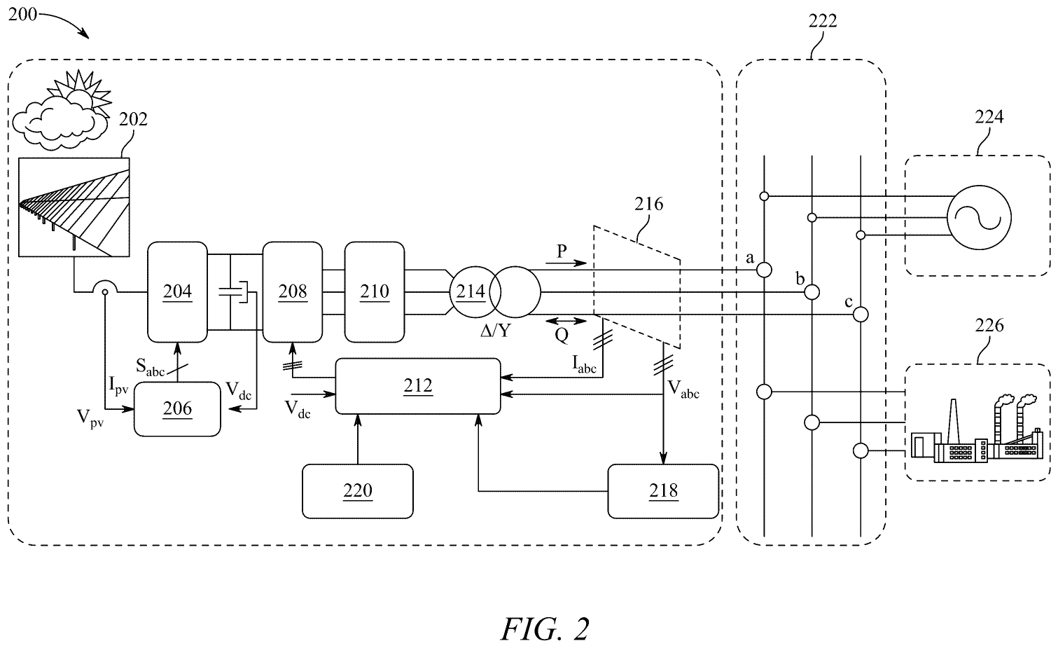

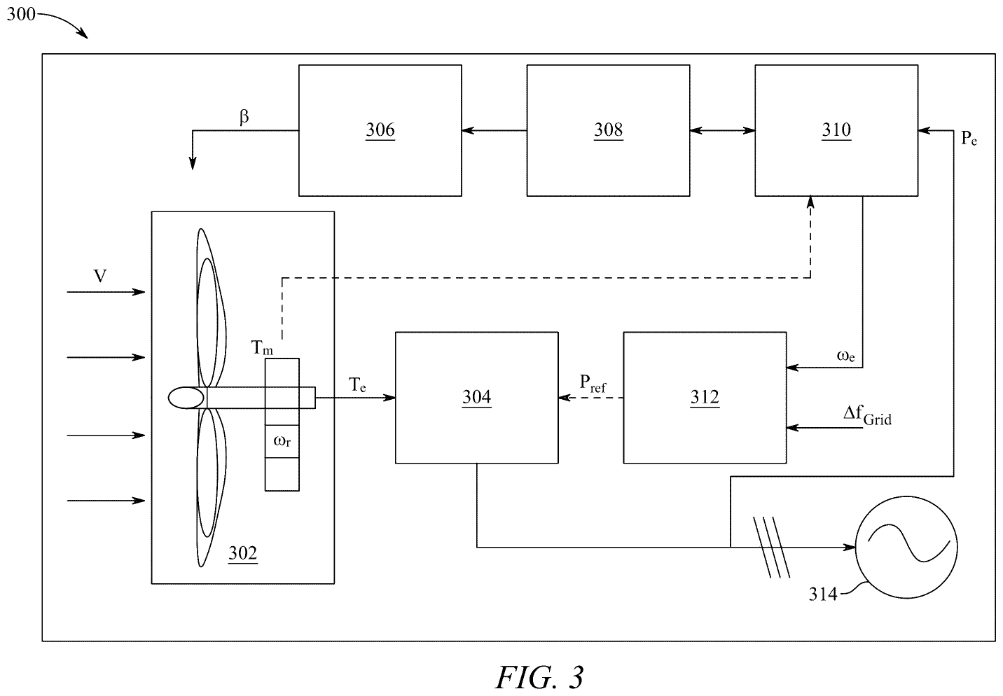

The multi-area power plant 100 further includes a plurality of renewable energy sources (RES). The plurality of renewable energy sources may be selected from the group containing a wind energy system 132, a solar energy system 130, a biomass energy system, a geothermal energy system, a tidal energy system or the like. As an exemplary embodiment, the present disclosure is described by considering the wind energy system 132 and the solar energy system 130 as a plurality of RES integrated with the multi-area power plant 100. However, any other existing renewable energy sources described earlier may be used as the RES. As such, the RES may include at least one photovoltaic array 130 and at least one wind turbine 132. Accordingly, thermal energy generators 100-1 and 100-2 incorporate the PV array for extracting solar energy and the wind turbine for extracting wind energy. In an embodiment, more than two RES may be integrated with the multi-area power plant 100. The detail working and mathematical expression for the used solar energy system 130 and the wind energy system 132 is now described in FIG. 2 and FIG. 3, respectively.

FIG. 2 illustrates a solar energy system 200 used in the multi-area power plant 100, according to an embodiment. The solar energy system 200 is representative of solar energy system 130 in FIG. 1. The exemplary solar energy system 200 generates at a maximum power point with 1000 W/m² at 25° C. The solar energy system 200 includes one or more components, such as PV array 202, a DC-DC converter 204 for achieving a maximum power point tracking (MPPT), a 3-phase voltage-source inverter (VSI) or inverter 208 for converting DC into an AC source for satisfying the AC based power systems. The solar energy system 200 further includes a filter 210 to reduce the ripples output through the 3-phase VSI or inverter 208, a coupling transformer 214 to couple the PV array 202 with a point of common coupling 222, an AC measurement system 215, a phase lock loop 218 connected with an AC measurement system 216, a grid side inverter controller 212, a reference PQ unit 220 and an MPPT unit 206. The solar energy system 200 is electrically connected with a utility grid 224 and a load 226. In an embodiment, the load may refer to an industrial load or a residential load. MPP of the solar array connection is at I=750 A, which corresponds to an MPP of 4.5 MW. In an embodiment, the DC-DC converter 204 is a buck or boost or a buck-boost converter.

The model of the solar energy system 200 is configured for a capacity of 30 kW penetrating at a level of 45% into the utility grid 224. The gain between AC and DC is derived by:

$$X = \frac{Vdc}{Vac} , \qquad ( 9 )$$

where X presents the gain between the AC and DC value which is selected as 0.7. The constant DC voltage V_{dc} is selected to be 6 kV, which is the operating voltage of the PV array. The DC value is constant, thus by selecting X for this particular system, the amplitude of the AC voltage remains constant, but the AC current and power fluctuate with the DC value.

The operating voltage V° output needed at the boost converter (DC-DC converter 204) is obtained by

$${V}_{o} = \frac{{V}_{AC , rms}}{X} = \frac{11 / √ 3}{0.7} = 9.07 kV . \qquad ( 10 )$$

The calculation of the boost converter gain is expressed in equation (11) and the final boost converter gain is provided as below:

$$M = \frac{{V}_{o}}{X} = \frac{9.07 kV}{6 kV} = 1.51 . \qquad ( 11 )$$

$${G}_{Boost} = \frac{1}{M} = \frac{1}{1.51} . \qquad ( 12 )$$

After defining the gain of the boost converter or the DC-DC converter 204, the transfer function of the inverter is found for the conversion of DC current into AC current.

The AC current is given by i_{ac}=Iₘ cos ωt. Its equivalent transfer function is calculated by

$$\frac{s}{{s}^{2} + {ω}^{2}} ,$$

where ω=2πf=2(3.14)(50)=314159 rad/sec.

The transfer function of the inverter 208 is the ratio of the output current of the inverter 208 to the input current of the inverter 208. The input current to the inverter 208 is the output DC current of the DC-DC converter 204 that is expressed by 1/s. The representation of the transfer function of the inverter 208 is given as below:

$${G}_{Inverter} = \frac{{i}_{ac}}{{i}_{input}} = \frac{s}{{s}^{2} + {ω}^{2}} \div \frac{1}{s} = \frac{s}{{s}^{2} + {ω}^{2}} = \frac{s}{{s}^{2} + 98700} . \qquad ( 13 )$$

The output is fed to the utility grid 224 from the PV array 202 in the form of power, thus, the instantaneous power p(t) is given as below:

$$p ( t ) = \frac{{V}_{m}}{{I}_{m}} {i}_{AC}^{2} \qquad ( 14 )$$

In equation (6) the

$$\frac{{V}_{m}}{{I}_{m}}$$

represents the real part of the impedance because of the purely resistive load. Taking the Laplace transformation of equation (14), yields equation (15).

$$P ( s ) = \frac{{V}_{m} {I}_{m}}{2 s} + \frac{{V}_{m} {I}_{m}}{2 s} \frac{s}{{s}^{2} + {( 2 ω )}^{2}} \qquad ( 15 )$$

The AC current is transformed into an instantaneous power transfer function Gᵢₙₛₜ(s) given below:

$${G}_{inst} ( s ) = \frac{P ( s )}{{i}_{ac} ( s )} = {V}_{m} ( \frac{( {s}^{2} + {ω}^{2} ) ( {s}^{2} + {( 2 ω )}^{2} )}{{s}^{2} ( {s}^{2} + {( 4 ω )}^{2} )} ) = \frac{6351 {s}^{4} + ( 1.88 \times {10}^{9} ) {s}^{2} + ( 1.237 \times {10}^{14} )}{{s}^{4} + ( 3.948 \times {10}^{5} ) {s}^{2}} \qquad ( 16 )$$

The average power received from the instantaneous power yields an average transfer function G_{avg}(s) represented as below:

$${G}_{avg} ( s ) = \frac{{P}_{avg} ( S )}{P ( S )} = \frac{( {S}^{2} + {( 4 W )}^{2} )}{2 ( {S}^{2} + {( 2 W )}^{2} )} = \frac{{s}^{2} + ( 3.948 \times {10}^{5} )}{2 {s}^{2} + ( 3.948 \times {10}^{5} )} \qquad ( 17 )$$

The solar energy system 200 is thus configured to provide 4.5 MW of average output power. In an embodiment, the solar energy system 130, 200 is configured to generate the output power as ΔP_{PV}.

FIG. 3 illustrates a wind energy system 300 used in the multi-area power plant 100, according to an embodiment. The wind energy system 300 is representative of the wind energy system 132 in FIG. 1. The wind energy system 300 includes a plurality of components, such as a wind turbine 302, a generator 304 connected with the blade of the wind turbine 302 and an electrical control circuit 312. The wind energy system 300 further includes plurality of other components such as a pitch actuator 306, a pitch controller 308 and a rotor speed controller 310. The wind energy system 300 is connected with a grid 314. As the wind having a velocity wind v strikes the wind turbine 302, a force is exerted on the blades of the wind turbine 302, that urges the wind turbine 302 to move in the direction of the wind v. The shaft of the wind turbine 302 converts the kinetic energy of the wind v into mechanical energy. The output wind power equation that drives the rotation of the wind turbine 302 is provided as below:

$${P}_{w} = \frac{1}{2} ρ {a}^{2} {V}_{w}^{3} {C}_{p} ( TSR , β ) . \qquad ( 18 )$$

$${C}_{p} = 0.5 ( TSR - 0.2 \; 22 {β}^{2} - 5 \text{.6} ) {e}^{- 0 \text{.17} TSR} \qquad ( 19 )$$

$$TSR = \frac{r p m \times π D}{60 V} , \qquad ( 20 )$$

The parameters in equations (18)-(20) are: ρ indicates the air density

$$( \frac{Kg}{{m}^{3}} ) ,$$

Cₚ is the power coefficient, the blade pitch angle is represented by β[deg], a[m²] represents the area swept by the blades, TSR is turn speed ratio; and Vₙ [m/s] is the wind speed, where blade rotor diameter and are denoted by Dm and rpm [rev/min] respectively.

The total capacity of the wind energy system 300 is 33 MW. The modelling of the wind energy system 300 with transfer functions representing the pitch control, the pitch actuator and the induction generator are represented by equations (21)-(24):

$${G}_{P} ( s ) = \frac{{K}_{P 1} ( 1 + {sT}_{P 1} )}{( 1 + s )} . \qquad ( 21 )$$

$${G}_{H} ( s ) = \frac{{K}_{P 2}}{( 1 + {sT}_{P 2} )} . \qquad ( 22 )$$

$${G}_{D} ( s ) = \frac{{K}_{P 3}}{( 1 + s {T}_{P 3} )} . \qquad ( 23 )$$

$${G}_{I} ( s ) = \frac{1}{( 1 + {sT}_{w} )} . \qquad ( 24 )$$

The wind energy system 132, 300 is configured to generate output power symbolized by ΔP_{wind}.

Referring back to FIG. 1, the multi-area power plant 100 further includes a fourth adder 134. The fourth adder is configured to add the output power ΔP_{PV} from the solar energy system 130, 200 and the output power ΔP_{wind} from the wind energy system 132, 300 and generate the RES power error signal ΔPRES (shown as ΔP_{pv,I} in FIG. 1).

The multi-area power plant 100 further includes a third adder 128. The third adder 128 is configured to add the first power error signal ΔPr₁ from the output of the first reheater 118, the second power error signal ΔPr₂ from the output of the second reheater block 124 and the RES power error signal ΔP_{RES}, and generate a plant power error signal ΔPₛ.

The multi-area power plant 100 further includes a tie-line 140. An output terminal of the second thermal energy generator 100-2 is connected to an output terminal of the first thermal energy generator 100-1 by the tie-line 140. Also, each renewable energy sources 130 and 132 has output terminal connected to the tie-line 140.

The multi-area power plant 100 includes a plurality of loads. The connection of two-area is formed by a tie-line from where the power sharing between two areas take place. In an embodiment, the plurality of loads may refer to the electrical loads due to household loads, industrial loads, commercial loads or alike. Each of the plurality of loads are connected to the tie-line 140 and configured to generate a collective load power disturbance signal ΔP_{L}_{ᵢ}

The tie-line power disturbance signal ΔP_{tie,i} is generated from the tie-line 140. The generation of the tie-line power disturbance signal ΔP_{tie,i} is described in detail later in the disclosure.

The multi-area power plant 100 further includes a third subtractor 136. The third subtractor 136 is configured to receive the plant power error signal ΔPₛ, the load power disturbance signal ΔP_{L}_{ᵢ} and tie-line power disturbance signal ΔP_{tie,i}. Upon receiving the three signals, the third subtractor 136 is configured to subtract the load power disturbance signal ΔP_{L}_{ᵢ} and the tie-line power disturbance signal ΔP_{tie,i} from the plant power error signal ΔPₛ. Thus, third subtractor 136 generates a plant power output error signal as a resulting signal at the output of the third subtractor 136.

The multi-area power plant 100 further includes an output generator 138. The transfer function of the output generator 138 is given by:

$$1 / {M}_{i} s + {D}_{i}$$

where Dᵢ is the disturbance factor.

The output generator 138 is configured to receive the plant power output error signal from the output of the third subtractor and generate a frequency disturbance value Δfᵢ.

The multi-area power plant 100 further includes a feedback connection line 144, a first droop controller 112, a second droop controller 110 and frequency bias factor βᵢ controller 142. The feedback connection line 144 is connected between the output of the output generator 138 and an input of the first droop controller 112, an input the second droop controller 110 and at an input of the frequency bias factor βᵢ controller 142. The first droop controller 112 is configured to receive the frequency disturbance value Δfᵢ. Once the frequency disturbance value Δfᵢ is received, the first droop controller 112 calculates a first droop value 1/R₁ and multiply the frequency disturbance value Δfᵢ by the first droop value 1/R₁. Accordingly, the first droop controller 112 generates a first droop control signal. Similarly, the second droop controller 110 is configured to receive the frequency disturbance value Δfᵢ. Once the frequency disturbance value Δfᵢ is received, the second droop controller 110 calculates a second droop value 1/R₁ and multiplies the frequency disturbance value Δfᵢ by the second droop value 1/R₁. Accordingly, the second droop controller 110 generates a second droop control signal.

Further, the multi-area power plant 100 includes a frequency to power converter 146. The frequency to power converter 146 is connected from the output of the output generator 138. As such, the frequency to power converter 146 is configured to receive frequency disturbance signal Δf and multiply it with the transfer function of the frequency to power converter 146 as

$$2 π {T}_{ij} ( Δ fi - Δ fj ) / S , \qquad ( 25 )$$

and generates the tie-line power disturbance signal ΔPₜᵢₑᵢ.

The multi-area power plant 100 further includes a first adder 102. The first adder 102 has two input terminals. The first input terminal is configured to receive the frequency disturbance value Δfᵢ multiplied by a frequency bias factor βᵢ. The second input terminal is configured to receive the tie-line power disturbance signal ΔP_{tie,i} from the tie-line 140 over a measurement interval i. Once both signals are received the first adder 102 is configured to add the frequency disturbance value Δfᵢ multiplied by the frequency bias factor βᵢ to the tie-line power disturbance signal ΔP_{tie,i}. Additional of the two signals generates an area central error (ACEᵢ) signal at the output of the first adder 102, given by:

$${ACE}_{i} = {B}_{i} Δ {f}_{i} + Δ {Tie}_{ij} i \neq j ; \qquad ( 26 )$$

where Bᵢ, represents the frequency bias factor parameter.

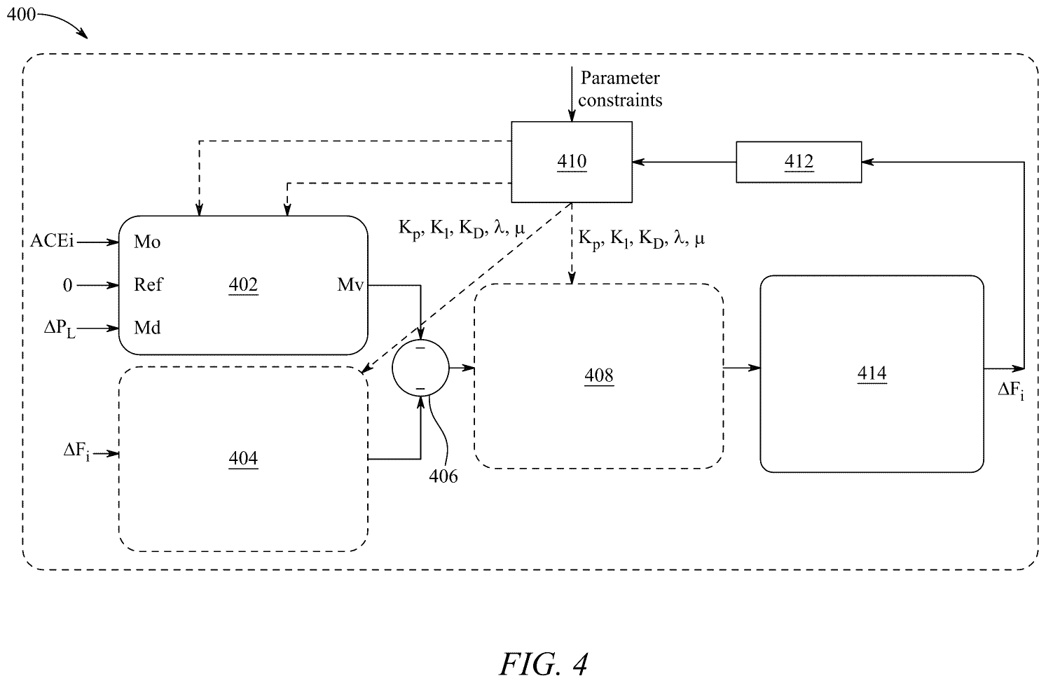

The multi-area power plant 100 further includes a hybrid controller 104. The hybrid controller 104 is configured to mitigate the frequency disturbances in the multi-area power plant 100. In an embodiment, only one hybrid controller 104 is used to mitigate the frequency disturbances in the multi-area power plant 100 where the hybrid controller 104 is controlling plants located at both geographical locations. The output of the first adder 102 is connected with the input of a hybrid controller 104. Thus, the hybrid controller 104 is configured to receive the area central error (ACEᵢ) and generate a frequency error correction signal at the output of the hybrid controller 104. The frequency correction signal is thus used to mitigate frequency disturbances. The generation of the frequency error correction signal from the area central error (ACEᵢ) is described in detail in FIG. 4.

The multi-area power plant 100 includes a first subtractor 108. Once the hybrid controller 104 generates the frequency error correction signal at its output terminal, the first subtractor 108 is configured to receive the frequency error correction signal and the first droop control signal from the first droop controller 112. The first subtractor 108 subtracts the first droop control signal from the frequency error correction signal. The difference between the two signals thus creates a first frequency error difference signal. The first frequency error difference signal is thus transmitted as an input to the first thermal energy generator 100-1. Based upon the first frequency error difference signal, the first thermal energy generator 100-1 generates the first power error signal ΔP_{R}_{₁} using the first governor 114, the first team turbine with rotor block 116, and the first reheater block 118.

The multi-area power plant 100 further includes a second subtractor 106. Once the hybrid controller 104 generates the frequency error correction signal at its output terminal, the second subtractor 106 is configured to receive the frequency error correction signal and the second droop control signal from the second droop controller 110. The second subtractor 106 subtracts the second droop control signal from the frequency error correction signal. The difference between the two signals creates a second frequency error difference signal. The second frequency error difference signal is thus transmitted as an input to the second thermal energy generator 100-2. Based upon the second frequency error difference signal, the second thermal energy generator 100-2 generates the second power error signal ΔP_{R}_{₂} using the second governor block 120, the second steam turbine with rotor block 122, and the second reheater block 124.

The multi-area power plant 100 further includes the hybrid controller 104. The hybrid controller 104, its internal structure and working for mitigating the frequency disturbance is now described in detail in FIG. 4.

FIG. 4 illustrates the hybrid controller 400. The hybrid controller 400 is representative of the hybrid controller 104 in FIG. 1. The hybrid controller 104 is a CFMPC cascaded with a FOPID controller. The hybrid controller 104 may be referred to as a computerized computation block having plurality of control instructions stored in the memory (not shown) of the hybrid controller 104 to perform a method of mitigating the frequency disturbance in the multi-area power plant 100 of FIG. 1. The hybrid controller 400 includes at least one CFMPC processor 402, a first fractional-order proportional-integral-derivative (FOPID-1) controller 404, a second fractional-order proportional-integral-derivative (FOPID-2) controller 408, an adder 406, a sooty terns controller 410 and an ITAE computation block 412.

The CFMPC processor 402 includes a set of CFMPC program instructions to receive the area central error (ACEᵢ) signal, a load power disturbance signal ΔP_{L}_{ᵢ} and an initial reference power of zero and predict a future output of the power plant, minimize a controlled fitness equation (ITAE) based on the predicted future output, and generate a minimized ACE signal based on the minimizing the ITAE.

The first fractional-order proportional-integral-derivative (FOPID-1) controller 404 includes a FOPID-1 processor including a set of FOPID-1 program instructions configured to receive the frequency disturbance value Δfᵢ and generate a frequency disturbance correction signal based on a set of FOPID-1 gain parameters and the frequency disturbance value Δfᵢ. The FOPID-1 controller includes a memory (not shown) configured to store a mathematical equation of the transfer function as given as:

$$G ( s ) = {K}_{P} + \frac{{K}_{I}}{{s}^{λ 1}} + {K}_{D} {s}^{μ 1} . \qquad ( 27 )$$

In equation (27) the parameters K_{P}, K_{I}, K_{D} denote the gains of the FOPID controller. Also, λ₁ and μ₁ are defined as a first integrator fractional parameter constraint λ₁ for the integrator and a first differentiator fractional parameter constraint for the differentiator, respectively. Also λ₁ and μ₁ are limited between (0 to 1) which is an improvement over a conventional PID controller as the tuning can be closely adjusted. Accordingly, the FOPID-1 controller 404 includes plurality of tunable parameters as below:

$${X}_{i} ( t ) = [ {K}_{p 1} , {K}_{l 1} , {K}_{D 1} , {λ}_{1} , {μ}_{1} ] . \qquad ( 28 )$$

Accordingly, the set of FOPID-1 gain parameter constraints include a first integrator fractional parameter constraint λ₁ and a first differentiator fractional parameter constraint μ₁.

Initially, when the frequency disturbance is not present in the multi-area power plant 100, the tunable parameters have a predefined initial value. However, when a frequency disturbance is present in the multi-area power plant 100, the tunable parameters are updated by a sooty terns controller 410 to mitigate the frequency disturbance.

The adder 406 has two inputs. One of the inputs is coupled with the output of the CFMPC processor 402 and the other input is connected to the output of the FOPID-1 controller 404. Also, before adding the values from the CFMPC processor 402 and the FOPID-1 controller 404, the adder 406 is configured to invert the output signals from the CFMPC processor 402 as well as FOPID-1 controller 404. As such, the adder 406 is configured to add a negative of the values obtained by the CFMPC processor 402 to a negative of the frequency disturbance correction signal obtained from the FOPID-1 controller 404 and generate a combined frequency correction signal. In an embodiment, the adder 406 may include two inverting circuits connected at the two inputs of the adder 406 to receive values obtained by the CFMPC processor 402 and the FOPID-1 controller 404, add negatives of both of the signals and generate the combined frequency correction signal.

The second fractional-order proportional-integral-derivative (FOPID-2) controller 408 refers to a FOPID-2 processor including a set of FOPID-2 program instructions configured to receive the combined frequency correction signal from the adder 406 and generate a frequency error correction signal. The FOPID-2 controller 408 also includes a memory (not shown) configured to store a mathematical equation of the transfer function as given below:

$$G ( s ) = {K}_{P} + \frac{{K}_{I}}{{s}^{λ 2}} + {K}_{D} {s}^{μ 2} . \qquad ( 29 )$$

The FOPID-2 processor uses eq. (29) in executing the program instructions to calculate the frequency error correction signal. In equation (23) the parameters K_{P}, K_{I}, K_{D} denote the gains of the FOPID-2 controller. Also, λ₂ and μ₂ are defined as a second integrator fractional parameter constraint λ₁ for an integrator and a second differentiator fractional parameter constraint for a differentiator, respectively. Also, λ₂ and μ₂ are limited between (0 to 1) which is an improvement over a conventional PID controller as the tuning can be closely adjusted. Accordingly, the FOPID-2 controller 408 includes plurality of tunable parameters as below:

$${X}_{j} ( t ) = [ {K}_{p 2} , {K}_{I 2} , {K}_{D 2} , {λ}_{2} , {μ}_{2} ] . \qquad ( 30 )$$

Accordingly, the set of FOPID-1 gain parameter constraints also include the second integrator fractional parameter constraint λ and the second differentiator fractional parameter constraint μ.

Initially, when the frequency disturbance is not present in the multi-area power plant 100, the tunable parameters have a predefined initial value. However, when frequency disturbance is present in the multi-area power plant 100, the tunable parameters are updated by the sooty terns controller 410 to mitigate the frequency disturbance.

The sooty terns controller 410 is configured to generate optimized controller gain parameters and transmit the optimized controller gain parameters to the FOPID-1 controller and the FOPID-2 controller.

The ITAE computation block 412 refers to an ITAE processor having program instructions configured to compute the fitness function. The fitness function is defined in a memory (not shown) of the ITAE computation block 412 as below:

$$ITAE = {\int }_{0}^{∞} t ( \vert Δ {f}_{i} \vert + \vert Δ {P}_{tie , i} \vert ) dt . \qquad ( 31 )$$

The output of the ITAE computation block 412 is connected with the input of the sooty terns controller 410.

The hybrid controller 400 further includes a multi-area representation block 414. The multi-area representation block 414 represents physical components of the multi-area power plant 100 in FIG. 1 apart from the hybrid controller 104. For example, the output of the FOPID-2 controller is passed through the first droop controller 112 and the second droop controller 110, respectively, as well as a first subtractor 108 and the second subtractor 106, respectively, before being supplied as input to the multi-area representation block 414. As such, the multi-area representation block 414 represents the first thermal energy generator and the second thermal energy generators 100-1, 100-2, respectively, intermediate circuits such as PV array 130, wind system 132, third adder 128, third subtractor 136, plurality of loads, output generator 138, the frequency bias factor βᵢ controller 142 and the first adder 102. Accordingly, the output from the multi-area representation block 414 is the output from the output generator 138 in FIG. 1 as Δfᵢ. In an embodiment, the multi-area representation block 414 may also include plurality of loads.

The hybrid controller 104 is described with reference to FIG. 1 to FIG. 4. Initially, when there is no disturbance in frequency, the output from the output generator 138 Δfᵢ will be zero. Also, at the same time, the ΔPₜᵢₑ=zero, representing a non-disturbed condition of the multi-area power plant 100. At this time, the input to the first FOPID-1 controller 404 i.e., Δfᵢ is also zero. Similarly, input to the CFMPC processor 402 is also zero as area central error (ACEᵢ) is zero and the load variation ΔP_{L} is also zero.

When, a load variation in any one area occurs, a change in frequency Δfᵢ is observed by the output generator 138. The output generator 138 feeds Δfᵢ to the ITAE computation block 412 of the hybrid controller 104, 400. At the same time, a non-zero ΔPₜᵢₑ exists on the tie-line 140. The ITAE computation block 412 uses equation 22 to compute the controlled fitness equation or fitness function as below:

$$ITAE = {\int }_{0}^{∞} t ( \vert Δ {f}_{i} \vert + \vert Δ {P}_{tie , i} \vert ) dt . \qquad ( 32 )$$

Upon computing the fitness equation, the ITAE computation block 412 inputs the ITAE value to the sooty terns controller 410.

The sooty terns controller 410 includes a sooty terns controller memory (not shown). The memory (not shown) stores sooty terns controller program instructions including a sooty terns optimization algorithm (STOA). The optimization algorithm (STOA) is defined in the memory of the sooty terns memory. The sooty terns controller memory (not shown) includes plurality of mathematical equations as below:

$${\vec{C}}_{st} = {S}_{A} \times {\vec{P}}_{st} ( z ) , \qquad ( 33 )$$

$${S}_{A} = {C}_{f} - ( z \times ( \frac{{c}_{f}}{{Iter}_{max}} ) ) , \qquad ( 34 )$$

where, \vec{C}ₛₜ defines the sooty terns (ST) position that does not encounter another ST position, \vec{P}ₛₜ is the present ST location, z denotes the current iteration, S_{A} is the ST motion in a given search region, and C_{f} is a regulating variable to alter S_{A}.

The sooty terns memory further stores a set of FOPID-1 gain parameter constraints and a set of FOPID-2 gain parameter constraints. The sooty terns controller 410 further includes at least one sooty terns controller (not shown) and a sooty terns processor (not shown) which is configured to execute the program instructions. The sooty terns controller is configured to execute a plurality of mathematical equations as below:

$${\vec{M}}_{st} = {C}_{B} \times ( {\vec{P}}_{bst} ( z ) - {\vec{P}}_{st} ( z ) , \qquad ( 35 )$$

$${C}_{B} = 0.5 \times {R}_{and} , \qquad ( 36 )$$

where \vec{M}ₛₜ indicates the different locations of a ST, \vec{P}_{bst} is the best of ST, C_{B} signifies a random variable, and R_{and} is a random number in the interval. The sooty terns controller updates the location of the ST using below equations:

$${\vec{D}}_{st} = {\vec{C}}_{st} + {\vec{M}}_{st} , \qquad ( 37 )$$

where \vec{D}ₛₜ demonstrates the distinction between the ST and the ST with the best fitness. Further, the ST exhibits helical motion in the air, as shown in equations (38)-(41).

$${x}^{′} = {R}_{adi} \times sin ( i ) . \qquad ( 38 )$$

$${y}^{′} = {R}_{adi} \times cos ( i ) . \qquad ( 39 )$$

$${z}^{′} = {R}_{adi} \times i . \qquad ( 40 )$$

$$r = u \times {e}^{kv} . \qquad ( 41 )$$

Based upon above equations, the processor of the sooty terns controller executes the plurality of equation (33-41) and optimizes the ITAE. Based upon the optimized ITAE, the sooty terns controller computes new optimized gain parameters for FOPID-1 controller and the FOPID-2 controller. For example, the new optimized values are a set of values represented by Xᵢ(t):

Xᵢ(t)=[Kₚ₁₁,K_{I11},K_{D11},λ₁₁,μ₁₁,K_{P22},K_{I22},K_{D22},λ₂₂,μ₂₂].

Once the optimized value of the gain parameters for FOPID-1 controller and the FOPID-2 controller are found, the sooty terns controller transmits the optimized controller gain parameters to the FOPID-1 controller and FOPID-2 controller.

Accordingly, the sooty terns controller 410 optimizes the first integrator fractional parameter constraint λ₁ and the first differentiator fractional parameter constraint μ₁ as well as the second integrator fractional parameter constraint λ₂ and the second differentiator fractional parameter constraint μ₂ and transmits the optimized first integrator fractional parameter constraint λ₁ and the optimized first differentiator fractional parameter constraint μ₁ as well as the second integrator fractional parameter constraint λ₂ and the second differentiator fractional parameter constraint μ₂ to the FOPID-1 controller 404 and the FOPID-2 controller 408. Further, the sooty terns controller transmits the optimized ITAE to the CFMPC processor 402. The CFMPC processor 402 includes a model predictive control algorithm that works based on forecasting to solve problems. When the frequency disturbance occurs, an ACEᵢ signal is generated at the output of the first adder 102 and a load power disturbance signal ΔP_{L} is generated.

The CFMPC processor 402 receives the ACEᵢ signal as input as well as ΔP_{L}_{_{L}} along with a reference load power disturbance signal (which is initialized to zero). The CFMPC processor 402 also receives the optimized ITAE value from the sooty terns controller 410. The CFMOC processor 402 has a memory to include plurality of mathematical equations shown below:

$$x ( k + 1 ) = Ax ( k ) + {BS}_{i} {u}_{p} ( k ) . \qquad ( 42 )$$

$$y ( k ) = {s}_{o}^{- 1} Cx ( k ) + {s}_{o}^{- 1} {DS}_{i} {u}_{p} ( k ) . \qquad ( 43 )$$

In the equations (42)-(43), A, B, C and D denote the constant state space matrices, and S₀ and Sᵢ represent the diagonal matrices of the input and output scale factor respectively. The symbol uₚ represents the dimensionless vector. Thus equations (42)-(43) can be expressed in terms of columns of the constant state space matrices, as shown below:

$$x ( k + 1 ) = Ax ( k ) + {B}_{u} ( k ) + {B}_{v} v ( k ) + {B}_{d} d ( k ) , \qquad ( 44 )$$

$$y ( k ) = Cx ( k ) + {D}_{v} v ( k ) + {D}_{d} d ( k ) , \qquad ( 45 )$$

where, u(k) is the input signal and x(k) is the system state, v(k) is a measurable turbulence, d(k) are unmeasured disruptions, y(k) is the system outputs, Bᵤ, Bᵥ, and B_{d} are the equivalent columns of BSᵢ, the Dᵥ and D_{d} are the corresponding columns of sₒ⁻¹DSᵢ. The cost function of CFMPC is given by equation (46):

$${min}_{Δ u ( k ) , … , Δ u ( k + M - 1 )} \{ {\sum }_{j = 0}^{m - 1} Δ {u}^{T} ( k + j ) R Δ u ( k + j ) + {\sum }_{i = 0}^{P - 1} Δ {y}^{T} ( k + i ) \} , \qquad ( 46 )$$

where Q and R are the weighting vectors for balancing the square future control and performance predictive error. The control and prediction horizons are depicted by M and P and sample time is denoted by T.

Accordingly, based upon the equations (42)-(46), the CFMPC processor 402 minimizes the controlled fitness equation (ITAE) and predicts the future output of the plant.

Based upon the predicted output, the CFMPC processor 402 generates a minimized ACE signal at its output which is fed to one of the input terminals of the adder 406. The minimized ACE signal refers to a signal at which the frequency disturbance tends to decrease or even reduces to zero, leading to normalization of state of the plant from the frequency deviation state.

At the same time the frequency disturbance occurs, the first FOPID-1 controller 404 also receives the frequency disturbance value Δfᵢ at its input and calculates the transfer function of the FOPID-1 controller given by:

$$G ( s ) + {K}_{P} + \frac{{K}_{I}}{{S}^{λ 1}} + {K}_{D} {s}^{μ 1} \qquad ( 47 )$$

Based upon eq. (47), the FOPID-1 controller 404 generates a frequency disturbance correction signal based on a set of FOPID-1 gain parameters transmitted by the sooty terns controller 410 and the frequency disturbance value Δfᵢ. The generated frequency disturbance correction signal is also transmitted to the second input of the adder 406.

The adder 406 adds the negative of the minimized ACE signal to the negative of the frequency disturbance correction signal and generates a combined frequency correction signal. The combined frequency correction signal is passed to the cascaded FOPID-2 controller 408.

The FOPID-2 controller 408 receives the combined frequency correction signal at its input terminal and calculates the transfer function of the FOPID-2 controller 408 given by:

$$G ( s ) = {K}_{P} + \frac{{K}_{I}}{{S}^{λ 2}} + {K}_{D} {s}^{μ 2} \qquad ( 48 )$$

Based upon equation (48), the FOPID-2 controller 408 generates a frequency error correction signal based on a set of FOPID-2 gain parameters transmitted by the sooty terns controller 410. The generated frequency error correction signal is transmitted to the output of the FOPID-2 controller 408.

The frequency error correction signal from the output of the FOPID-2 controller 408 is communicated to one of the inputs of the first subtractor 108 and the second subtractor 106, respectively. The first subtractor 108 receives the frequency error correction signal.

When the frequency disturbance occurs, the frequency disturbance value Δfᵢ is also received by the first droop controller 112 and the second droop controller 110. The first droop controller 112 calculates a first droop value 1/R1, multiplies the frequency disturbance value Δfᵢ by the first droop value 1/R1, and generates a first droop control signal at output terminal of the first droop controller 112. Similarly, the second droop controller 110 receives the frequency disturbance value Δfᵢ, calculates a second droop value 1/R2, multiplies the frequency disturbance value Δfᵢ by the second droop value 1/R2, and generates a second droop control signal at output terminal of the second droop controller 110.

Accordingly, the first subtractor also 108 receives a first droop control signal from the output terminal of the first droop controller 112, which is then provided as input to the second terminal of the first subtractor also 108. Similarly, the second subtractor 106 also receives a second droop control signal from the output terminal of the second droop controller 110 which is then provided as input to the second terminal of the second subtractor 106.

After the first subtractor 108 receives the frequency error correction signal at one of the input terminals and the first droop control signal at the second input terminal, the first subtractor 108 subtracts the first droop control signal from the frequency error correction signal and transmits a first frequency error difference signal to the first thermal energy generator 100-1. Similarly, after the second subtractor 106 receives the frequency error correction signal at one of the input terminals and the second droop control signal at the second input terminal, the second subtractor 106 subtracts the second droop control signal from the frequency error correction signal and transmits the second frequency error difference signal to the second thermal energy generator 100-2.

The first thermal energy generator 100-1, upon receiving the first frequency error difference signal from the first subtractor 108, generates a first power error signal ΔP_{R}_{₁} using equations (1), (2), (3) and (4) described earlier.

Similarly, the second thermal energy generator 100-2, upon receiving the second frequency error difference signal from the second subtractor 106, generates a second power error signal ΔP_{R2} using equations (5), (6), (7) and (8) described earlier.

Now the third adder 128 adds the first power error signal ΔP_{R}_{₁} received from the first thermal energy generator 100-1, the second power error signal ΔP_{R}_{₂} received from the second thermal energy generator 100-2 and an RES power error signal ΔP_{RES} received from plurality of renewable sources. Addition of the three signals generates a plant power error signal ΔPₛ at the output of the third adder 128.

Since, when the frequency disturbance occurs, a signal corresponding to the tie-line power disturbance signal ΔP_{tie,I} also occurs at the tie-line 140 based upon the frequency to power converter 146 according to the equation as below:

$$2 π {T}_{ij} ( Δ fi - Δ fj ) / S . \qquad ( 49 )$$

At the same time, due to the frequency disturbance Δfᵢ, a load power disturbance signal ΔP_{L}_{ᵢ} is also generated.

The third subtractor 136 receives the plant power error signal ΔPₛ and subtracts the load power disturbance signal ΔP_{L}_{ᵢ} and the tie-line power disturbance signal ΔP_{tie,i} from the plant power error signal ΔPₛ and generates a plant power output error signal. The generated plant power output error signal is fed as input to the output generator 138.

The output generator 138 has a transfer function given by:

$${G}_{gen} ( s ) = \frac{1}{M 1 s + D} . \qquad ( 50 )$$

If the output generator 138 still finds a deviation in frequency (i.e., Δfi is still non-zero) even at the new generated parameters of the FOPID-1 controller 404 and FOPID-2 controller 408, the deviation value in frequency Δfi is again fed back to the ITAE computation block 412 of the hybrid controller 400. Further the new deviation value in frequency (i.e., frequency disturbance Δfᵢ) is also fed back through the feedback connection line 144 to the first droop controller 112, the second droop controller 110 and the first adder 102.

The first adder 102 adds the receives a new frequency disturbance value (Δfᵢ) multiplied by the frequency bias factor βᵢ. The first adder 102 further receive the tie-line power disturbance signal ΔP_{tie,i} from the tie-line 140 over a measurement interval i. The first adder 102 adds the frequency disturbance value Δfᵢ multiplied by the frequency bias factor βᵢ to the tie-line power disturbance signal ΔP_{tie,i} and generates the area central error (ACEᵢ) signal at the new frequency disturbance value (Δfᵢ). Mathematically ACEᵢ is given by:

$$\begin{matrix}{ACE}_{i} = {B}_{i} Δ {f}_{i} + Δ {Tie}_{ij} & i \neq j\end{matrix} \qquad ( 51 )$$

The new value of the area central error (ACEᵢ) is again fed back to the hybrid controller 104 which is representative of the hybrid controller 400.

Accordingly, the hybrid controller 104, 400 again repeats the process of optimization process of the gain parameter constraints of the FOPID-1 controller 404, the FOPID-2 controller 408 using the sooty terns controller 410 and the ITAE computation block 412. The entire process repeats for plurality of iterations till the ACEᵢ is completely minimized to zero. Accordingly, the hybrid controller 104, 400 continues to iterate the process until the ACEᵢ signal is completely minimized at plurality of gain parameter constraints of the FOPID-1 controller 404 and the FOPID-2 controller 408 using the sooty terns controller 410. Finally, when the ACE signal is minimized at the optimal gain parameter constraints of the FOPID-1 controller 404 and FOPID-2 controller 408 extracted from the iteration from the sooty terns controller 410, the multi-area power plant 100 is completely stabilized. Accordingly, the frequency disturbances of the power plant are regulated by minimizing the ACEᵢ signal.

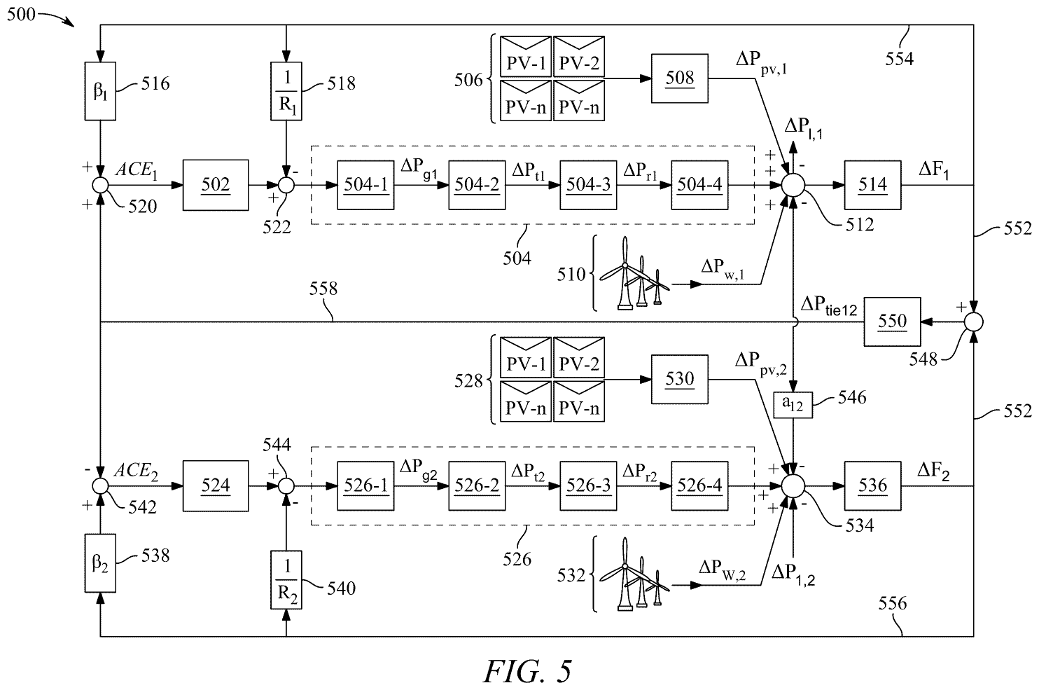

FIG. 5 illustrates a two-area hybrid power control system 500 for mitigating frequency disturbances, according to an embodiment. The overall configuration 500 presents a different embodiment compared to multi-area power plant in FIG. 1, however, the CSMPC-FOPID controllers are the same as the CSMPC-FOPID controller described with respect to FIG. 4. In this embodiment, each power plant has a separate hybrid controller 502 (i.e., first CSMPC-FOPID-1 controller) and 524 (i.e., a second CSMPC-FOPID-2 controller), a separate PV system 506 and a wind energy system 532. Also, each power plant has a separate output generators 415 and 536. The details and workings of the two-area hybrid power control system for mitigating frequency disturbances are now described in detail.

The overall configuration 500 of a two-area hybrid power control system 500 includes two or more power plants or power systems 504 and 526. The first power system 504 and the second power system 526 may refer to any of an electrical power plant, a thermal power plant, a hydropower plant, a nuclear power plant, a steam-electric power plant, a coal-fired power plant, a geothermal power plant and the like. In an exemplary embodiment thermal power plants are included in a first power system and a second power system, however this is not restrictive.

The first power system 504 and the second power system 526 are physically separated by a certain geographical distance. As such the first power system 504 and the second first power system 504 are located in a first geographic area and a second geographic area, respectively.

The first power system 504 includes a first governor with a dead band block 504-1, a first turbine with a rotor block 504-2, a first reheater block 504-3 and a first generation rate constraint (GRC) block 504-4. Each of the blocks of the first power system 504 are connected in series. Similarly, the second power system 526 includes a second governor with a dead band block 526-1, a second turbine with a rotor block 526-2, a second reheater block 526-3. Each of the blocks in the second power system 526 are connected in series. The GRC restricts the power generation when it reaches the maximum value. During the design of the thermal power system, the GRC was set at value 0:002puMW sec-1 for both the GRC blocks 504-4 and 526-4.

A mathematical model of the first power system 504 is now described in detail. The transfer function of the first governor with dead band block 504-1 is given by:

$${G}_{gov} ( s ) = \frac{0.8 - ( \frac{0.2}{π} ) s}{1 + {sT}_{g 1}} . \qquad ( 51 )$$

The first governor with dead band block 504-1 is configured to generate an output given by:

$$Δ {P}_{g 1} ( s ) = Δ {P}_{ref} ( s ) - \frac{1}{R 1} Δ {f}_{i} ( s ) . \qquad ( 52 )$$

where, ΔP_{ref} is the reference power and Δfᵢ is the change in frequency, while droop value is presented b

$$\frac{1}{R} .$$

Accordingly, the first governor with dead band block 504-1 is configured to receive the first droop control signal

$$\frac{1}{R 1} Δ {f}_{i} ( s )$$

and subtract it by a first subtractor 522 from a reference power ΔP_{ref}(s) generated from a CFMPC-FOPID-1 controller 502 and output a power change signal ΔPg₁.

The output ΔP_{g1}(s) of the first governor with dead band block 504-1 is fed as an input to the first steam turbine with rotor block 504-2. The first turbine with rotor block 504-2 has a transfer function:

$${G}_{t} ( s ) = \frac{1}{1 + {sT}_{t 1}} . \qquad ( 53 )$$

The first turbine with rotor block 504-2 is configured to receive the power change signal ΔPg₁, modify the speed of the rotor and generate an output ΔPₜ₁.

The output ΔPₜ₁ of the first turbine with rotor block 504-2 is further fed as input to the first reheater block 504-3. The first reheater block 504-3 has a transfer function as given below:

$${G}_{r} ( s ) = \frac{1 + {sK}_{r 1} {T}_{r 1}}{1 + {sT}_{r 1}} . \qquad ( 54 )$$

The first reheater 504-3 is configured to generate a first power disturbance signal ΔPr₁ as an output from the first reheater block 504-3 when the input ΔPₜ₁ is fed to the first reheater block 504-3. The first power disturbance signal ΔPr₁ is further passed through the first GRC block 504-4.

Similarly, a mathematical model of the second first power system 526 is now described in detail. The transfer function of the second governor with the dead band block 526-1 is given by:

$${G}_{g o v} ( s ) = \frac{0.8 - ( \frac{0.2}{π} ) s}{1 + s {T}_{g 2}} . \qquad ( 55 )$$

The second governor with the dead band block 526-1 is configured to generate an output given by:

$$Δ {P}_{g 2} ( s ) = Δ {P}_{r e f} ( s ) - \frac{1}{R 2} Δ {f}_{i} ( s ) , \qquad ( 56 )$$

where ΔP_{ref} is the reference power and Δfᵢ is the change in frequency, while the droop value is presented by

$$\frac{1}{R 2} .$$

Accordingly, the second governor with the dead band block 526-1 is configured to receive the second droop control signal

$$\frac{1}{R 2} Δ {f}_{i} ( s )$$

and subtract it by a second subtractor 544 from a reference power ΔP_{ref}(s) generated from a second controller CSMPC-FOPID-2 524 and output a power change signal ΔP_{g2}(s).

The output ΔP_{g2}(s) of the second governor with the dead band block 526-1 is fed as an input to the second turbine with the rotor block 526-2. The second turbine with the rotor block 526-2 has a transfer function given by:

$${G}_{t} ( s ) = \frac{1}{1 + s {T}_{t 2}} . \qquad ( 57 )$$

The second turbine with the rotor block 526-2 is configured to receive the power change signal ΔPg₂, modify the speed of the rotor and generate an output ΔPₜ₂.

The output ΔPₜ₂ of the second turbine with the rotor block 526-2 is further fed as input to the second reheater block 526-3. The second reheater block 526-3 has a transfer function given by:

$${G}_{r} ( s ) = \frac{1 + s {K}_{r 2} {T}_{r 2}}{1 + {sT}_{r 2}} \qquad ( 58 )$$

The second reheater block 124 is configured to generate an output as ΔPᵣ₂(s) as an output from the second reheater block 124 when the input ΔPₜ₂ is fed to the second reheater block 124. The second power disturbance signal ΔPr₂ is further passed through the second GRC block 526-4.

The two-area power plant 500 further includes a plurality of renewable energy sources (RES). The plurality of renewable energy sources may be at least a first wind farm system 510 and a first solar energy system or a photovoltaic array 506 in the first power system 504, and at least a second wind firm 532 and a second solar energy system or a photovoltaic array 528 in the second power system 526. As such, the RES may include at least one photovoltaic array 506 and at least one wind turbine 510 in the first power system 504. Similarly, the RES may again include at least one photovoltaic array 528 and at least one wind turbine 532 in the second power system 526. The output of the photovoltaic array 506 may be connected with an inverter 508 to generate an AC value at the output terminal of the inverter 508. The detailed workings and mathematical expressions for the solar energy systems 506, 528 and the wind energy systems 510, 532 are the same as described in earlier in the discussion of FIG. 2 and FIG. 3, respectively. Thus the descriptions of the solar energy systems 506, 528 and the wind energy systems 510, 532 are not repeated herein.

The power from the first solar energy system 506, after passing through the first inverter 508, is configured to generate a variation in output power as ΔP_{PV1}. Also, the second wind firm is configured to generate a variation in output power as ΔP_{w1}. Similarly, the second solar energy system 528, after passing through the second inverter 530, is configured to generate a variation in output power as ΔP_{PV2}. Also, the second wind firm 532 is configured to generate a variation in output power as ΔP_{w2}.

The two-area power plant 500 further includes a second adder 512 configured to add ΔP_{PV1} and ΔP_{w1} and generate a first RES-1 power disturbance signal ΔPᵣₑₛ_{₁}. The outputs of the solar system 506 and the wind energy system 510 are added to generate a combined first RES-1 power disturbance signal ΔPᵣₑₛ_{₁} for the first power system 504. Similarly, the two-area power plant 500 further includes a fourth adder 534 configured to add ΔP_{PV2} and ΔP_{w2} and generate a second RES-2 power disturbance signal ΔPres₂. Here, the output of the solar generation system 528 and the wind energy system 532 are added to generate a combined second RES-2 power disturbance signal ΔPres₂ for the second power system 504.

The two-area power plant 500 further includes a tie-line 552. An output terminal of the first power system 504 is connected to an output terminal of the second power system 526 by the tie-line 552.

The two-area power plant 500 further includes a first load configured to generate a first load power disturbance signal ΔP_{L}_{₁} at a load output terminal towards the first power system 504. Similarly, the two-area power plant 500 further includes a second load configured to generate a second load power disturbance signal ΔPL₂ at a load output terminal towards the second power system 526. As explained earlier, the connection of two-area is formed by a tie-line 552 from where the power sharing between two areas take place. In an example, the first load and the second loads may refer to a plurality of electrical loads, such as household loads, industrial loads, commercial loads and the like.

The tie-line power disturbance signal ΔPₜᵢₑ₁₂ is generated from the tie-line 552. The generation of the tie-line power disturbance signal ΔPₜᵢₑ₁₂ is described in detail later in the disclosure.

The second adder 512 of the two-area power plant 500 further is connected to receive the first thermal generator power disturbance signal ΔP_{R}_{₁}, the first RES-1 power disturbance signal ΔPᵣₑₛ_{₁}, the load power disturbance signal ΔP_{L}_{₁}, and a tie-line power disturbance signal ΔPₜᵢₑ from the tie-line 552. Once all four signals are received, the second adder 512 sums the first thermal generator power disturbance signal ΔP_{R}_{₁} with the first RES-1 power disturbance signal ΔPres1, subtracts the first load power disturbance signal ΔP_{L1} and subtracts the tie-line power disturbance signal ΔPₜᵢₑ, and generates a first geographic area power disturbance signal ΔPₛ_{₁}. In an embodiment, a subtractor (not shown) may be used which could receive the load power disturbance signal ΔP_{L}_{₁}, and a tie-line power disturbance signal ΔPₜᵢₑ from the tie-line 552 and add them. The sixth added may then add the first thermal generator power disturbance signal ΔP_{R}_{₁} and the first RES-1 power disturbance signal ΔPᵣₑₛ_{₁}. Additionally, the output from the subtractor (not shown) may be used to subtract the load power disturbance signal ΔP_{L}_{₁}, and a tie-line power disturbance signal ΔPₜᵢₑ to receive a first geographic area power disturbance signal ΔPₛ_{₁}.

Similarly, the fourth adder 534 of the two-area power plant 500 is connected to receive the second thermal generator power disturbance signal ΔP_{R2}, the second RES-2 power disturbance signal ΔPres₂, the load power disturbance signal ΔPL₂, and a tie-line power disturbance signal ΔPₜᵢₑ from the tie-line 552. Once all four signals are received, the fourth adder 534 sums the second thermal generator power disturbance signal ΔP_{R2} with the second RES-2 power disturbance signal ΔPres₂, subtracts the second load power disturbance signal ΔPL₂ and subtracts the tie-line power disturbance signal ΔPₜᵢₑ, and generates a second geographic area power disturbance signal ΔPₛ_{₂}. In an embodiment, a multiplier block a₁₂ 546 may be connected in the supply line of ΔPₜᵢₑ for amplification purposes.

The two-area power plant 500 further includes a first output generator 514. The transfer function of the first output generator 514 is given by:

$$1 / {M}_{1} s + {D}_{1}$$

where Dᵢ is the disturbance factor for the first output generator 514.

The first output generator 514 is configured to receive the first geographic area power disturbance signal ΔPₛ_{₁} from the output of the second adder 512 and convert the first geographic area power disturbance signal ΔPₛ_{₁} to a first geographic area frequency disturbance value Δf₁. The first geographic area frequency disturbance value is the output of the first output generator 514 which is transmitted to the tie-line 552.

Similarly, the two-area power plant 500 further includes a second output generator 536. The second output generator 536 is also configured to receive the second geographic area power disturbance signal ΔPₛ_{₂} from the output of the fourth adder 534 and convert the second geographic area power disturbance signal ΔPₛ_{₂} to a second geographic area frequency disturbance value Δf₂. The second geographic area frequency disturbance value Δf₂ is the output of the second output generator 536 which is also transmitted to the tie-line 552.

The two-area power plant 500 further includes a first feedback connection line 554, a first droop controller 518 in the first power system 504, a second droop controller 540 in the second power system 526, a first frequency bias factor β₁ controller 516 in the first power system 504, a second frequency bias factor 32 controller 538 in the second power system 526. The first feedback connection line 554 is connected between the output of the first output generator 514 and an input of the first droop controller 518. Also, a second feedback connection line 556 is connected between the output of the second output generator 536 and an input of the second droop controller 540. The first droop controller 518 is configured to receive the frequency disturbance value Δfᵢ. Once the frequency disturbance value Δfᵢ is received, the first droop controller 518 calculates a first droop value 1/R₁ and multiplies the frequency disturbance value Δfᵢ by the first droop value 1/R₁. Accordingly, the first droop controller 518 generates a first droop control signal. Similarly, the second droop controller 540 is configured to receive the frequency disturbance value Δf₂. Once the frequency disturbance value Δf₂ is received, the second droop controller 540 calculates a second droop value 1/R₂ and multiplies the frequency disturbance value Δf₂ by the second droop value 1/R₂. Accordingly, the second droop controller 540 generates a second droop control signal.

The multi-area power plant 100 includes a fifth adder 548. The fifth adder 548 is configured to add the first geographic area frequency disturbance value Δfᵢ to the second geographic area frequency disturbance value Δf₂.

The multi-area power plant 100 includes a frequency to power converter 550. The frequency to power converter 550 is connected from the output of the fifth adder 548. As such, the frequency to power converter 550 is configured to receive frequency disturbance signal Δf as (Δfᵢ+Δf₂) and multiply it with the transfer function of the frequency to power converter 146 as:

$$2 π {T}_{i 12} / S \qquad ( 59 )$$

and generate a combined area tie-line power disturbance value ΔPₜᵢₑ_{_{1,2}}_{.}

The two-area power plant 500 further includes the first adder 520. The first adder 520 has two input terminals. The first input terminal is configured to receive the frequency disturbance value Δfᵢ multiplied by a first frequency bias factor controller Pᵢ 516 using the first feedback connection line 554 connected to the tie-line 552. The second input terminal is configured to receive the tie-line power disturbance signal ΔP_{tie1,2} from the output of the frequency to power converter 550 over a measurement interval i. Similarly, the two-area power plant 500 further includes a third adder 542. The third adder 524 also has two input terminals. The first input terminal is configured to receive the second frequency disturbance value Δf₂ multiplied by a second frequency bias factor controller βᵢ 538 using the second feedback connection line 556 connected to the tie-line 552. The second input terminal is configured to receive the tie-line power disturbance signal ΔP_{tie1,2} from the output of the frequency to power converter 550 over a measurement interval i.

Further, the first adder 520 is configured to add the first geographic area frequency disturbance value Δfᵢ multiplied by the first frequency bias factor β₁ to the tie-line power disturbance signal ΔP_{tie,1,2}. Addition of the two signals thus generates a first area central error (ACE₁) signal at the output of the first adder 520.

Similarly, the third adder 542 is configured to add the second geographic area frequency disturbance value Δf₂ multiplied by the second frequency bias factor 32 to the tie-line power disturbance signal ΔP_{tie,1,2}. Addition of the two signals thus generates a second area central error (ACE₂) signal at the output of the third adder 542.

Mathematically,

$$\begin{matrix}{ACE}_{1} = {B}_{1} Δ {f}_{1} + {ΔTi e}_{i = 1 j = 2} & i \neq j\end{matrix} \qquad ( 60 )$$

$$\begin{matrix}{ACE}_{2} = {B}_{2} Δ {f}_{2} + {ΔTi e}_{i = 1 j = 2} & i \neq j\end{matrix} \qquad ( 61 )$$

where B₁ and B₂ represent the frequency bias factor parameters.

The two-area power plant 500 further includes a first controller 502 for the first power plant 504 and a second controller 524 for the second power plant 526. The first controller 502 and the second controller 524 is also referred to as a CSMPC-FOPID-1 controller 502 and CSMPC-FOPID-2 524, respectively. Both controllers 502 and 524 are configured to mitigate the frequency disturbances in the two-area power plant 500. The output of the first adder 520 is connected with the input of a CSMPC-FOPID-1 controller 502. The first adder 520 is configured to generate a first area central error ACE-1 signal that is supplied as input to the CSMPC-FOPID-1 controller 502. Similarly, the output of the third adder 542 is connected with the input of a CSMPC-FOPID-1 524. The third adder 542 is configured to generate a second area central error ACE-2 signal that is supplied as input to the CSMPC-FOPID-2 524.

Thus, the CSMPC-FOPID-1 controller 502 is configured to receive the first area central error ACEᵢ and generate a first frequency error correction signal at the output of the CSMPC-FOPID-1 controller 502. Similarly, the CSMPC-FOPID-2 controller 524 is configured to receive the second area central error ACE₂ and generate a second frequency error correction signal at the output of the CSMPC-FOPID-2 524.

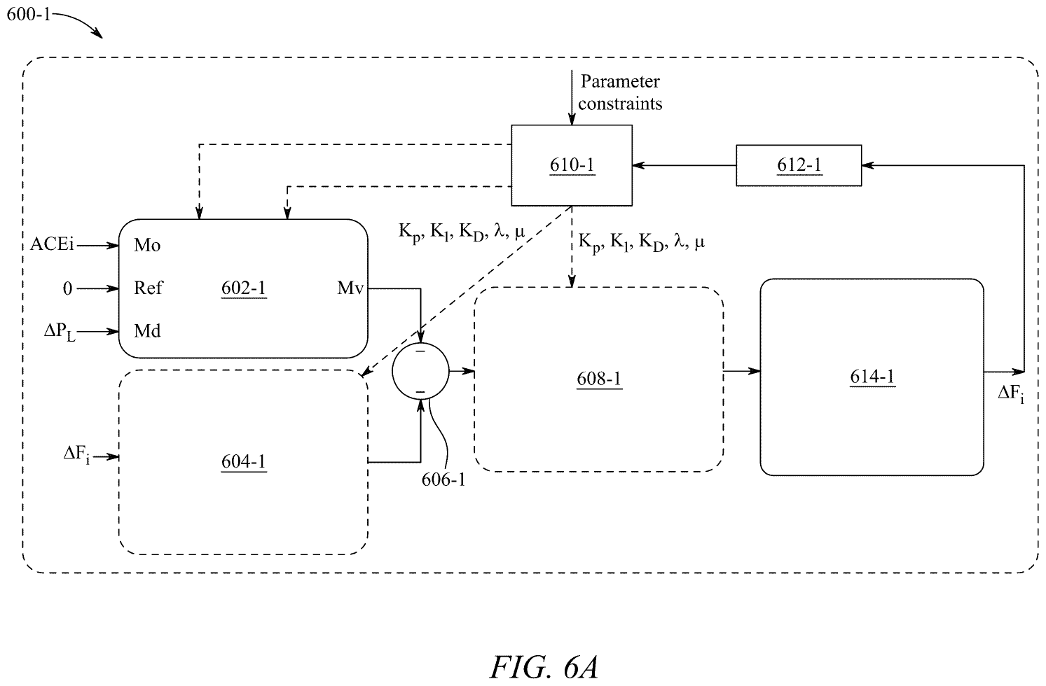

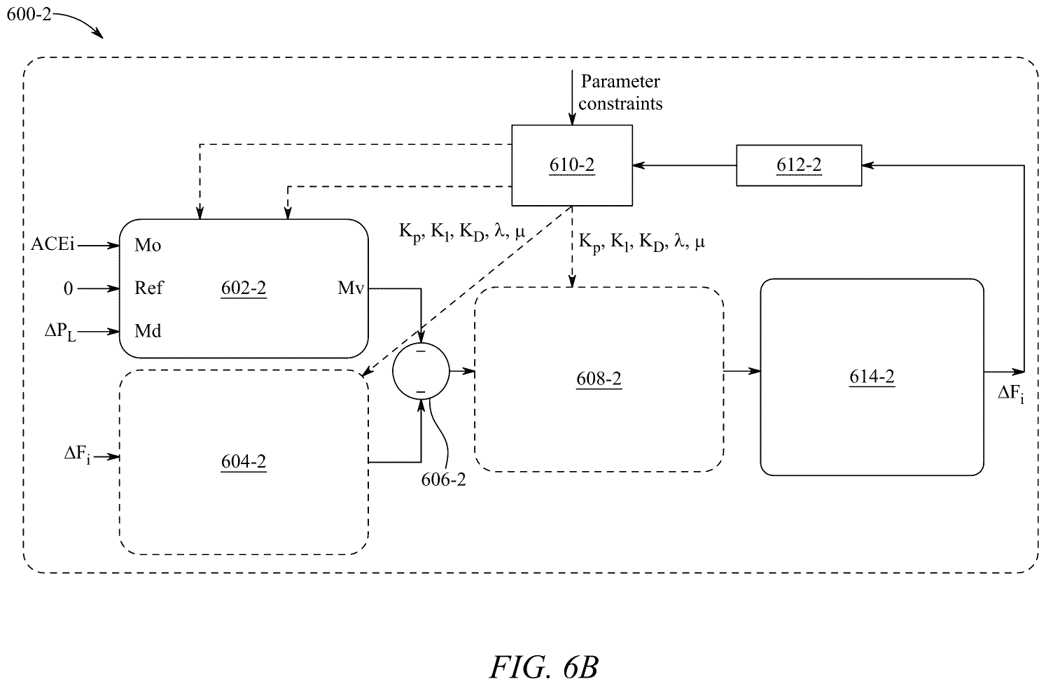

The first frequency correction signal and the second frequency correction signal is thus used to mitigate frequency disturbances in the first power plant 504 and the second power generation system 526. The generation of the first frequency error correction signal and the second frequency error correction signal from the first area central error ACEᵢ and the second area central error ACE₂ is described in detail later in FIG. 6A and FIG. 6B.

The two-area power plant 500 further includes a first subtractor 522. Once the CSMPC-FOPID-1 controller 502 generates the first frequency error correction signal at its output terminal, the first subtractor 522 is configured to receive the first frequency error correction signal and the first droop control signal from the first droop controller 518. The first subtractor 522 subtracts the first droop control signal from the first frequency error correction signal. The difference between the two signals thus creates a first frequency error difference signal. The first frequency error difference signal is thus transmitted as an input to the first thermal energy generator 504. Based upon the first frequency error difference signal, the first thermal energy generator 504 generates the first power error signal ΔP_{R}_{₁} using the first governor with a dead band block 504-1, the first turbine with rotor block 504-2, the first reheater block 504-3 and the first GRC block 504-4.

The two-area power plant 500 further includes a second subtractor 544. Once the CSMPC-FOPID-2 controller 502 generates the second frequency error correction signal at its output terminal, the second subtractor 544 is configured to receive the second frequency error correction signal and the second droop control signal from the second droop controller 540. The second subtractor 544 subtracts the second droop control signal from the second frequency error correction signal. The difference between the two signals thus creates a second frequency error difference signal. The second frequency error difference signal is thus transmitted as an input to the second thermal energy generator 526. Based upon the second frequency error difference signal, the second thermal energy generator 526 generates the second power error signal ΔP_{R}_{₂} using the second governor with the dead band block 526-1, the second steam turbine with rotor block 526-2, the second reheater block 526-3 and the second GRC block 526-4.

The two-area power plant 500 further includes the CFMPC-FOPID-1 controller 502 in the first power system 504 and the CFMPC-FOPID-2 controller 524 in the second power system 526. The internal structure and working of the CFMPC-FOPID-1 controller 502 and the CFMPC-FOPID-2 controller 524 for mitigating the frequency disturbance in the first area and the second area are now described in detail in FIG. 6A and FIG. 6B.

FIG. 6A illustrates the first CFMPC-FOPID-1 controller 600-1, according to an embodiment. The first CFMPC-FOPID-1 controller 600-1 is representative of the CFMPC-FOPID-1 controller 502 in FIG. 5 and has essentially the same structure as described in FIG. 4. The first CFMPC-FOPID-1 controller 600-1 is a fractional model predictive controller (CFMPC) cascaded with a FOPID controller. The first CFMPC-FOPID-1 controller 600-1 may be referred to as a computerized computation block having plurality of control instructions stored in the memory (not shown) of the first CFMPC-FOPID-1 controller 600-1 to perform a method of mitigating the frequency disturbance in the two-area power plant 500 of FIG. 5. The first CFMPC-FOPID-1 controller 600-1 includes at least one CFMPC processor 602-1, a first fractional-order proportional-integral-derivative (FOPID-1) controller 604-1, a second fractional-order proportional-integral-derivative (FOPID-2) controller 608-1, a sixth adder 606-1, a first sooty terns controller 610-1 and a first ITAE computation block 612-1.

The CFMPC processor 602-1 includes a set of CFMPC program instructions to receive the area central error (ACE₁) signal and a load power disturbance signal ΔP_{L1}, predict a future output of the power plant 504, minimize a controlled fitness equation (ITAE1) based on the predicted future output, and generate a minimized ACE-1 signal based on the minimizing the first ITAE₁.

The first fractional-order proportional-integral-derivative (FOPID-1) controller 604-1 may refer to an FOPID-1 processor including a set of FOPID-1 program instructions configured to receive the frequency disturbance value Δfᵢ and generate a frequency disturbance correction signal based on a set of FOPID-1 gain parameters and the frequency disturbance value Δfᵢ. The FOPID-1 controller 604-1 includes a memory (not shown) configured to store a mathematical equation of the transfer function as given by:

$$G ( s ) = {K}_{P} + \frac{{K}_{I}}{{s}^{λ 1}} + {K}_{D} {s}^{μ 1} . \qquad ( 62 )$$

In equation (62) the parameters K_{P}, K_{I}, K_{D} denote gains of the FOPID-1 controller 604-1. Also, λ₁ and μ₁ are defined as a first integrator fractional parameter constraint λ₁ for an integrator and a first differentiator fractional parameter constraint for a differentiator, respectively. Also λ₁ and μ₁ are limited between (0 to 1), which is an improvement over a conventional PID controller as the tuning can be closely adjusted. Accordingly, the FOPID-1 controller 604-1 includes plurality of tunable parameters as below:

$${X}_{1} ( t ) = [ {K}_{p 1} , {K}_{I 1} , {K}_{D 1} , {λ}_{1} , {μ}_{1} ] \qquad ( 63 )$$

Accordingly, the set of FOPID-1 gain parameter constraints include a first integrator fractional parameter constraint λ₁ and a first differentiator fractional parameter constraint μ₁.

Initially, when the frequency disturbance is not present in the two-area 500, the tunable parameters have a predefined initial value. However, when frequency disturbance is present in the two-area power system 500, the tunable parameters are updated by the first sooty terns controller 610-1 to mitigate the frequency disturbance.

The sixth adder 606-1 has two inputs. One of the inputs is attached with the output of the CFMPC processor 602-1 and the other input is attached with the output of the FOPID-1 controller 604-1. Also, before adding the values from the CFMPC processor 602-1 and the FOPID-1 controller 604-1 with each other, the sixth adder 606-1 is configured to invert the output signals from the CFMPC processor 602-1 as well as FOPID-1 controller 604-1. As such, the sixth adder 606-1 is configured to add a negative of the values obtained by the CFMPC processor 602-1 to a negative of the frequency disturbance correction signal obtained from the FOPID-2 controller 604-1 and generate a first combined frequency correction signal.

The first FOPID-2 controller 608-1 may refer to an FOPID-2 processor including a set of FOPID-2 program instructions configured to receive the first combined frequency correction signal from the ninth adder 606-1 and generate a first frequency error correction signal. The first FOPID-2 controller 608-1 also includes a memory (not shown) configured to store a mathematical equation of the transfer function as given below:

$$G ( s ) = {K}_{P} + \frac{{K}_{I}}{{s}^{λ 2}} + {K}_{D} {s}^{μ 2} . \qquad ( 64 )$$

In equation (64) the parameters K_{P}, K_{I}, K_{D} denotes the gains of the first FOPID-2 controller 608-1. Also, λ₂ and μ₂ are defined as a second integrator fractional parameter constraint λ₁ for an integrator and a second differentiator fractional parameter constraint for a differentiator, respectively. Also λ₂ and μ₂ are limited between (0 to 1) which is an improvement over a conventional PID controller as the tuning can be closely adjusted. Accordingly, the first FOPID-2 controller 608-1 includes plurality of tunable parameters as below:

$${X}_{i} ( t ) = [ {K}_{p 2} , {K}_{I 2} , {K}_{D 2} , {λ}_{2} , {μ}_{2} ] . \qquad ( 65 )$$

Accordingly, the set of FOPID-2 gain parameter constraints also include the second integrator fractional parameter constraint λ₂ and the second differentiator fractional parameter constraint μ2.

FIG. 6B illustrates the second CFMPC-FOPID-2 controller 600-2. The second CFMPC-FOPID-2 controller 600-2 is representative of the CFMPC-FOPID-2 controller 524 in FIG. 5. The second CFMPC-FOPID-2 controller 600-2 is a fractional model predictive controller (CFMPC) cascaded with FOPID controller. The second CFMPC-FOPID-2 controller 600-2 may be referred to as a computerized computation block having plurality of control instructions stored in the memory (not shown) of the second CFMPC-FOPID-2 controller 600-2 to perform a method of mitigating the frequency disturbance in the two-area power plant 500 of FIG. 5. The second CFMPC-FOPID-2 controller 600-2 includes at least one second CFMPC processor 602-2, a third fractional-order proportional-integral-derivative (FOPID-3) controller 604-2, a fourth fractional-order proportional-integral-derivative (FOPID-4) controller 608-2, a seventh adder 606-2, a second sooty terns controller 610-2 and a second ITAE-2 computation block 612-2.

The second CFMPC processor 602-2 includes a set of CFMPC program instructions to receive the area central error (ACE₂) signal and a load power disturbance signal ΔPL₂, predict a future output of the power plant 526, minimize a controlled fitness equation (ITAE₂) based on the predicted future output, and generate a minimized ACE-2 signal based on the minimizing the ITAE₂.

The third fractional-order proportional-integral-derivative (FOPID-3) controller 604-2 may refer to an FOPID-3 processor including a set of FOPID-3 program instructions configured to receive the frequency disturbance value Δf₂ and generate a frequency disturbance correction signal based on a set of FOPID-3 gain parameters and the frequency disturbance value Δf₂. The third FOPID-3 controller 604-2 includes a memory (not shown) configured to store a mathematical equation of the transfer function as given as below:

$$G ( s ) = {K}_{P} + \frac{{K}_{I}}{{s}^{λ 3}} + {K}_{D} {s}^{μ 3} . \qquad ( 66 )$$

In equation (23) the parameters K_{P}, K_{I}, K_{D} denotes gains of the third FOPID-3 controller 604-2. Also, λ₃ and μ₃ are defined as a first integrator fractional parameter constraint λ₃ for an integrator and a first differentiator fractional parameter constraint for a differentiator, respectively. Also λ₃ and μ₃ are limited between (0 to 1) which is an improvement over a conventional PID controller as the tuning can be closely adjusted. Accordingly, the third FOPID-3 controller 604-2 includes plurality of tunable parameters as below:

$${X}_{1} ( t ) = [ {K}_{p 3} , {K}_{I 3} , {K}_{D 3} , {λ}_{3} , {μ}_{3} ] . \qquad ( 67 )$$

Accordingly, the set of FOPID-3 gain parameter constraints include a first integrator fractional parameter constraint λ₃ and a first differentiator fractional parameter constraint μ₃.

Initially, when the frequency disturbance is not present in the two-area 500, the tunable parameters have a predefined initial value. However, when frequency disturbance is present in the two-area power system 500, the tunable parameters are updated by the sooty terns controller 610-3 to mitigate the frequency disturbance.

The seventh adder 606-2 has two inputs. One of the inputs is attached with the output of the second CFMPC processor 602-2 and the other input is attached with the output of the FOPID-3 controller 604-3. Also, before adding the values from the second CFMPC processor 602-2 and the third FOPID-3 controller 604-2 with each other, the seventh adder 606-2 is configured to invert the output signals from the CFMPC processor 602-3 as well as the third FOPID-3 controller 604-2. As such, the seventh adder 606-2 is configured to add a negative of the values obtained by the Second CFMPC processor 602-2 to a negative of the frequency disturbance correction signal obtained from the third FOPID-3 controller 604-2 and generate a second combined frequency correction signal.

The fourth FOPID-4 controller 608-2 may refer to an FOPID-4 processor including a set of FOPID-4 program instructions configured to receive the second combined frequency correction signal from the seventh adder 606-2 and generate a second frequency error correction signal. The fourth FOPID-4 controller 608-2 also includes a memory (not shown) configured to store a mathematical equation of the transfer function as given as below:

$$G ( s ) = {K}_{P} + \frac{{K}_{I}}{{S}^{λ 4}} + {K}_{D} {s}^{μ4} . \qquad ( 68 )$$

In equation (23) the parameters K_{P}, K_{I}, K_{D} denotes the gains of the fourth FOPID-4 controller 608-2. Also, λ₄ and μ₄ are defined as a second integrator fractional parameter constraint λ₄ for an integrator and a second differentiator fractional parameter constraint for a differentiator, respectively. Also λ₄ and λ₄ are limited between (0 to 1) which is an improvement over a conventional PID controller as the tuning can be closely adjusted. Accordingly, the fourth FOPID-4 controller 608-2 includes plurality of tunable parameters as below:

$${X}_{i} ( t ) = [ {K}_{p 4} , {K}_{I 4} , {K}_{D 4} , {λ}_{4} , {μ}_{4} ] . \qquad ( 69 )$$

Accordingly, the set of FOPID-4 gain parameter constraints also include the second integrator fractional parameter constraint λ₄ and the second differentiator fractional parameter constraint μ₄.

Initially, when the frequency disturbance is not present in the two-area power system 500, the tunable parameters have a predefined initial value. However, when a frequency disturbance is present in the two-area power system 500, the tunable parameters are updated by the second sooty terns controller 610-2 to mitigate the frequency disturbance.

The first sooty terns controller 610-1 is configured to generate optimized controller gain parameters and transmit the optimized controller gain parameters to the FOPID-1 controller 604-1 and the first FOPID-2 controller 608-1. Similarly, the second sooty terns controller 610-2 is configured to generate optimized controller gain parameters and transmit the optimized controller gain parameters to the third FOPID-3 controller 604-2 and the fourth FOPID-4 controller 608-2.

The first ITAE computation block 612-1 may refer to an ITAE processor having program instructions configured to compute the fitness function. The fitness function is defined in a memory (not shown) of the first ITAE computation block 612-1 as below:

$$ITAE = {\int }_{0}^{∞} t ( \vert Δ {f}_{1} \vert + \vert Δ {P}_{tie 1 , 2} \vert ) dt . \qquad ( 70 )$$

The output of the first ITAE computation block 612-1 is connected with the input of the first sooty terns controller 610-1.

Similarly, the second ITAE-2 computation block 612-2 may refer to an ITAE processor having program instructions configured to compute the fitness function. The fitness function is defined in a memory (not shown) of the second ITAE-2 computation block 612-2 as below:

$$ITAE = {\int }_{0}^{∞} t ( \vert Δ {f}_{2} \vert + \vert Δ {P}_{tie 1 , 2} \vert ) dt \qquad ( 71 )$$

The output of the second ITAE-2 computation block 612-2 is also connected with the input of the second sooty terns controller 610-2.

In both FIGS. 6A and 6B, each CFMPC-FOPID controller 600-1 and 600-2 includes a multi-area representation block 614-1 and 614-2, respectively. The multi-area representation block 614-1 and 614-2 is analogous to the multi-area representation block 414 in FIG. 4. The entire explanation is thus not repeated herein.

Now the working of the CFMPC-FOPID-1 controller 502, 600-1 as well as CFMPC-FOPID-2 controller 524, 600-2 is described with reference to FIGS. 5 and 6. Initially, when there is no disturbance in frequency, the output from the output generator 138 Δfᵢ will be zero. Also, at the same time, the ΔP_{tie1,2}=zero. It would represent a non-disturbed condition of the two-area power plant 50. At this time, the input to the first FOPID-1 controller 604-1 as well as the input to the third FOPID-3 controller 604-2, i.e., Δf₁ and Δf₂ are also zero. Similarly, input to the first FOPID-1 controller 604-1 and second CFMPC-2 processor 602-2 is also zero as the first area central error (ACE₁) as well as the second area central error (ACE₂) is zero and the load variation ΔP_{L1} and ΔPL₂ is also zero.

When a load variation in a first area occurs, a change in frequency Δfᵢ is observed by the first output generator 514. The first output generator 514 feeds Δfᵢ to the first ITAE-1 computation block 612-1 of the CFMPC-FOPID-1 controller 502, 600-1. At the same time, a non-zero ΔP_{tie1,2} exists on the tie-line 552. The first ITAE-1 computation block 612-1 uses equation 22 to compute the controlled fitness equation or fitness function as below:

$$ITAE = {\int }_{0}^{∞} t ( \vert Δ {f}_{1} \vert + \vert Δ {P}_{tie , 1 , 2} \vert ) dt \qquad ( 72 )$$

Upon computing the fitness equation, the first ITAE-1 computation block 612-1 inputs the ITAE value to the first sooty terns controller 610-1.

Similarly, when a load variation in the second area occurs, a change in frequency Δf₂ is observed by the second output generator 536. The second output generator 536 feeds Δf₂ to the second ITAE-2 computation block 612-2 of the CFMPC-FOPID-2 controller 524, 600-2. The ITAE-2 computation block 612-2 uses equation 73 to compute the controlled fitness equation or fitness function as below:

$$ITAE = {\int }_{0}^{∞} t ( \vert Δ {f}_{2} \vert + \vert Δ {P}_{tie , 1 , 2} \vert ) dt . \qquad ( 73 )$$

Upon computing the fitness equation, the ITAE-2 computation block 612-2 inputs the ITAE value to the second sooty terns controller 610-2.
The first sooty terns controller 610-1 includes a first sooty terns controller memory (not shown). The memory (not shown) stores sooty terns controller program instructions including a sooty terns optimization algorithm (STOA). The optimization algorithm (STOA) is defined in the memory of the sooty terns memory. The sooty terns controller memory (not shown) includes plurality of mathematical equations as below:

$${\vec{C}}_{st} = {S}_{A} \times {\vec{P}}_{st} ( z ) . \qquad ( 74 )$$

$${S}_{A} = {C}_{f} - ( z \times ( \frac{{c}_{f}}{{Iter}_{max}} ) ) . \qquad ( 75 )$$

where, \vec{C}ₛₜ defines the sooty terns (ST) position that does not encounter another ST position, \vec{P}ₛₜ is the present ST location, z denotes the current iteration, S_{A} is the ST motion in a given search region, and C_{f} is a regulating variable to alter S_{A}.

The memory of the first sooty terns controller 610-1 further stores a set of FOPID-1 gain parameter constraints and a set of FOPID-2 gain parameter constraints. The first sooty terns controller 610-1 further includes at least one sooty terns controller (not shown). The sooty terns controller is further configured to execute plurality of mathematical equations as below:

$${\vec{M}}_{st} = {C}_{B} \times ( {\vec{P}}_{bst} ( z ) - {\vec{P}}_{st} ( z ) . \qquad ( 76 )$$

$${C}_{B} = 0.5 \times {R}_{a n d} . \qquad ( 77 )$$

where \vec{M}ₜ₃ indicates the different locations of a ST, \vec{P}_{bst} is the best of ST, C_{B} signifies a random variable, and R_{and} is a random number in the interval. The sooty terns controller updates the location of the ST using the following equations:

$${\vec{D}}_{st} = {\vec{C}}_{st} + {\vec{M}}_{st} . \qquad ( 78 )$$

\vec{D}ₛₜ demonstrates the distinction between the ST and the ST with the best fitness. Further, the ST exhibit helical motion in the air, as shown in equation (79)-(82).

$${x}^{′} = {R}_{adi} \times sin ( i ) . \qquad ( 79 )$$

$${y}^{′} = {R}_{adi} \times cos ( i ) . \qquad ( 80 )$$

$${z}^{′} = {R}_{adi} \times i . \qquad ( 81 )$$

$$r = u \times {e}^{k v} . \qquad ( 82 )$$

Similarly, the second sooty terns controller 610-2 includes a second sooty terns controller memory (not shown). The memory (not shown) stores sooty terns controller program instructions including a sooty terns optimization algorithm (STOA). The optimization algorithm (STOA) is defined in the memory of the sooty terns memory. The sooty terns controller memory (not shown) includes plurality of mathematical equations as below:

$${\vec{C}}_{st} = {S}_{A} \times {\vec{P}}_{st} ( z ) . \qquad ( 83 )$$

$${S}_{A} = {C}_{f} - ( z \times ( \frac{{c}_{f}}{{Iter}_{max}} ) ) . \qquad ( 84 )$$

where, \vec{C}ₛₜ defines the sooty terns (ST) position that does not encounter another ST position, \vec{P}ₛₜ is the present ST location, z denotes the current iteration, S_{A} is the ST motion in a given search region, and C_{f} is a regulating variable to alter S_{A}.

The second sooty terns controller 610-2 further stores a set of FOPID-1 gain parameter constraints and a set of FOPID-2 gain parameter constraints. The second sooty terns controller 610-2 further includes at least one sooty terns controller (not shown). The sooty terns controller further configured to execute plurality of mathematical equations as below:

$${\vec{M}}_{st} = {C}_{B} \times ( {\vec{P}}_{bst} ( z ) - {\vec{P}}_{st} ( z ) . \qquad ( 85 )$$

$${C}_{B} = 0.5 \times {R}_{a n d} . \qquad ( 86 )$$

where \vec{M}ₛₜ indicates the different locations of a ST, \vec{P}_{bst} is the best of ST, C_{B} signifies a random variable, and R_{and} is a random number in the interval. The sooty terns controller updates the location of the ST using the following equation:

$${\vec{D}}_{st} = {\vec{C}}_{st} + {\vec{M}}_{st} . \qquad ( 87 )$$

\vec{D}ₛₜ demonstrates the distinction between the ST and the ST with the best fitness. Further, the ST exhibit helical motion in the air, as shown in equations (88)-(91).

$${x}^{′} = {R}_{adi} \times sin ( i ) . \qquad ( 88 )$$

$${y}^{′} = {R}_{adi} \times cos ( i ) . \qquad ( 89 )$$

$${z}^{′} = {R}_{adi} \times i . \qquad ( 90 )$$

$$r = u \times {e}^{k v} \qquad ( 91 )$$

Based upon equations (79) to (91), the first sooty terns controller 610-1 as well as the second sooty terns controller 610-2 execute the plurality of equations (79-91) and optimizes the ITAE-1 and ITAE-2. Based upon the optimized ITAE-1 the first sooty terns controller 610-1 computes a new optimized gain parameter for FOPID-1 controller 604-1 and the first FOPID-2 controller 608-1.

Similarly, based upon the optimized ITAE-2, the second sooty terns controller 610-2 computes a new optimized gain parameter for the third FOPID-3 controller 604-2 and the fourth FOPID-4 controller 608-2.

The new optimized value for FOPID-1 and FOPID-2 are as below:

X₁(t)=[Kₚ₁₁,K_{I11},K_{D11},λ₁₁,μ₁₁,Kₚ₂₂,K_{I22},K_{D22},λ₂₂,μ₂₂]

The new optimized value for FOPID-3 and FOPID-4 are as below

X₁(t)=[Kₚ₃₃,K_{I33},K_{D33},λ₃₃,μ₃₃,K_{P44},K_{I44},K_{D44},λ₄₄,μ₄₄]

Once the optimized value of the gain parameter for FOPID-1 controller 604-1 and the first FOPID-2 controller 608-1 are found, the first sooty terns controller 610-1 transmits the optimized controller gain parameters to the FOPID-1 controller 604-1 and first FOPID-2 controller 608-1.

Similarly, the second sooty terns controller 610-2 transmits the optimized controller gain parameters to the third FOPID-3 controller 604-2 and the fourth FOPID-4 controller 608-2.

Accordingly, the first sooty terns controller 610-1 optimizes the first integrator fractional parameter constraint λ₁ and the first differentiator fractional parameter constraint μ₁ as well as the second integrator fractional parameter constraint λ₂ and the second differentiator fractional parameter constraint μ₂ and transmits the optimized first integrator fractional parameter constraint λ₁ and the optimized first differentiator fractional parameter constraint μ₁ as well as the second integrator fractional parameter constraint λ₂ and the second differentiator fractional parameter constraint μ₂ to the FOPID-1 controller 404 and the FOPID-2 controller 408.

Further, the sooty terns controller transmits the optimized ITAE to the CFMPC processor 402.

Similarly, the second sooty terns controller 610-2 optimizes the first integrator fractional parameter constraint λ₃ and the first differentiator fractional parameter constraint μ₃ as well as the second integrator fractional parameter constraint λ₄ and the second differentiator fractional parameter constraint μ₄ and transmits the optimized first integrator fractional parameter constraint λ₃ and the optimized first differentiator fractional parameter constraint μ₃ as well as the second integrator fractional parameter constraint λ₄ and the second differentiator fractional parameter constraint μ₄ to the third FOPID-3 controller 604-2 and the fourth FOPID-4 controller 608-2.

Further, each sooty terns controller 610-1 and 610-2 transmits the optimized ITAE i.e., ITAE-1 and ITAE-2 to the CFMPC processor 602-1 and CFMPC processor 602-1, respectively. When the frequency disturbance occurs, ACEᵢ signal and ACE₂ is generated at the output of the ninth adder 606-1 and the seventh adder 606-2, respectively based upon equation 22 described earlier. Also, a load power disturbance signal ΔP_{L1} and ΔPL₂ is generated. The CFMPC processor 602-1 receives the ACE₁ signal as input as well as ΔP_{L}_{ᵢ} along with a reference load power disturbance signal (which is zero). The CFMPC processor 602-1 also receives the optimized ITAE value from the first sooty terns controller 610-1. The CFMOC processor 602-1 has a memory which includes plurality of mathematical equation as below:

$$( k + 1 ) = A x ( k ) + B {S}_{i} {u}_{p} ( k ) . \qquad ( 92 )$$

$$y ( k ) = {s}_{o}^{- 1} C x ( k ) + {s}_{o}^{- 1} D {S}_{i} {u}_{p} ( k ) . \qquad ( 93 )$$

From the equations (92)-(93) A, B, C and D denotes the constant state space matrices, and S₀ and Sᵢ are representing the diagonal matrices of the input and output scale factor respectively. The uₚ represents the dimensionless vector.

$$x ( k + 1 ) = A x ( k ) + {B}_{u} ( k ) + {B}_{v} v ( k ) + {B}_{d} d ( k ) . \qquad ( 94 )$$

$$y ( k ) = C x ( k ) + {D}_{v} v ( k ) + {D}_{d} d ( k ) . \qquad ( 95 )$$

where, u(k) is the input signal and x(k) is the system state, v(k) is a measurable turbulence, d(k) is an unmeasured of disruptions, y(k) is the system outputs, Bᵤ, Bᵥ, and B_{d} are the equivalent columns of BSᵢ, the Dᵥ and D_{d} are the corresponding columns of sₒ⁻¹DSᵢ. The cost function of ITAE-1 is given by equation (96):

$${min}_{Δ u ( k ) , … , Δ u ( k + M - 1 )} \{ {\sum }_{j = 0}^{m - 1} Δ {u}^{T} ( k + j ) R Δ u ( k + j ) + {\sum }_{i = 0}^{P - 1} Δ {y}^{T} ( k + i ) \} . \qquad ( 96 )$$

Q and R are the weighting vectors for balancing the square future control and performance predictive error. Control and prediction horizons are depicted by M and P and sample time is denoted by T. Accordingly, based upon plurality of equation from (92)-(96), the CFMPC processor 602-1 tries to minimize the controlled fitness equation (ITAE-1) and predict the future output of the plant 504.

A similar process is executed for CFMPC-2 processor 602-2 for minimizing the controlled fitness equation (ITAE-2) and predicting the future output of the plant 526.

Based upon the predicted output, the CFMPC-2 processor 602-1 generates a minimized ACEᵢ signal at its output which is fed to one of the input terminals of the sixth adder 606-1. Similarly, based upon the predicted output, the CFMPC-2 processor 602-2 generates a minimized ACE₂ signal at its output which is fed to one of the input terminals of the seventh adder 606-2.

At the same time when the frequency disturbance occurs, the FOPID-1 controller 604-1 as well as a third FOPID-3 controller 604-2 simultaneously receive the frequency disturbance value Δf₁ and Δf₂ at its input and passes through the transfer function of the FPOID-1 controller 604-1 and the third FOPID-3 controller 604-2, respectively, with equation as below:

$$G ( s ) = {K}_{P} + \frac{{K}_{I}}{{S}^{λ 1}} + {K}_{D} {s}^{μ 1} . \qquad ( 97 )$$

$$G ( s ) = {K}_{P} + \frac{{K}_{I}}{{S}^{λ 3}} + {K}_{D} {s}^{μ 3} . \qquad ( 98 )$$

Based upon the above equation, the FOPID-1 controller 604-1 generates a first frequency disturbance correction signal based on a set of FOPID-1 gain parameters transmitted by the first sooty terns controller 610-1 and the frequency disturbance value Δfᵢ. Similarly, based upon the above equation, the third FOPID-3 controller 604-2 generates a second frequency disturbance correction signal based on a set of FOPID-3 gain parameters transmitted by the second sooty terns controller 610-2 and the frequency disturbance value Δf₂.

The generated first frequency disturbance correction signal as well as the second frequency disturbance correction signal transmitted to the second input of the sixth adder 606-1 and the second input of the seventh adder 606-2, respectively.

The sixth adder 606-1 adds the negative of the minimized ACEᵢ signal to the negative of the first frequency disturbance correction signal and generates a first combined frequency correction signal. The first combined frequency correction signal is passed to the cascaded first FOPID-2 controller 608-1. Similarly, the seventh adder 606-2 adds the negative of the minimized ACE₂ signal to the negative of the second frequency disturbance correction signal and generate a second combined frequency correction signal. The second combined frequency correction signal is passed to the cascaded fourth FOPID-4 controller 608-2.

The first FOPID-2 controller 608-1 receives the first combined frequency correction signal at its input terminal and passes through the transfer function of the first FOPID-2 controller 608-1 with equation as below:

$$G ( s ) = {K}_{P} + \frac{{K}_{I}}{{S}^{λ 2}} + {K}_{D} {s}^{μ 2} . \qquad ( 99 )$$

Similarly,

The fourth FOPID-4 controller 608-2 receives the second combined frequency correction signal at its input terminal and passes through the transfer function of the fourth FOPID-4 controller 608-2 with equation as below:

$$G ( s ) = {K}_{P} + \frac{{K}_{J}}{{S}^{λ 4}} + {K}_{D} {s}^{μ 4} . \qquad ( 100 )$$

Based upon the above equation, the first FOPID-2 controller 608-1 generates a first frequency error correction signal based on a set of FOPID-2 gain parameters transmitted by the first sooty terns controller 610-1. The generated first frequency error correction signal is transmitted to the output of the first FOPID-2 controller 608-1. Similarly, the fourth FOPID-4 controller 608-2 also generates a second frequency error correction signal based on a set of FOPID-4 gain parameters transmitted by the second sooty terns controller 610-2. The generated second frequency error correction signal is transmitted to the output of the fourth FOPID-4 controller 608-2.

The first frequency error correction signal from the output of the first FOPID-2 controller 608-1 is passed to one of the inputs of the first subtractor 522. Similarly, Now the second frequency error correction signal from the output of the fourth FOPID-4 controller 608-2 is passed to one of the inputs of the fifth subtractor 544.

When the frequency disturbance occurs, the first frequency disturbance value Δf₁ is also received by the first droop controller 518. Similarly, the second frequency disturbance value Δf₂ is also received by the second droop controller 540. The first droop controller 518 calculates a first droop value 1/R1, multiply the first frequency disturbance value Δfi by the first droop value 1/R1, and generate a first droop control signal at output terminal of the first droop controller 518. Similarly, the second droop controller 540 also receives the second frequency disturbance value Δf₂, calculate a second droop value 1/R2, multiply the second frequency disturbance value Δf₂ by the second droop value 1/R2, and generates a second droop control signal at output terminal of the second droop controller 540.

Accordingly, the first subtractor 522 receives a first droop control signal from the output terminal of the first droop controller 518 which is provided as input to the second terminal of the fourth subtractor 522. Similarly, the second subtractor 544 also receives a second droop control signal from the output terminal of the second droop controller 540 which is provided as input to the second terminal of the second subtractor 544.

After the first subtractor 522 receives the first frequency error correction signal at one of the input terminals and the first droop control signal at the second input terminal, the first subtractor 522 subtracts the first droop control signal from the first frequency error correction signal, and transmits a first frequency error difference signal to the first thermal energy generator 504. Similarly, after the second subtractor 544 also receives the second frequency error correction signal at one of the input terminals and the second droop control signal at the second input terminal, the second subtractor 544 subtracts the second droop control signal from the second frequency error correction signal, and transmits the second frequency error difference signal to the second thermal energy generator 526.

The first thermal energy generator 504, upon receiving the first frequency error difference signal from the first subtractor 522, generates a first thermal generator power disturbance signal ΔP_{R}_{₁} using equations (1), (2), (3) and (4) described earlier. Similarly, the second thermal energy generator 526, upon receiving the second frequency error difference signal from the second subtractor 544, generates a second thermal generator power disturbance signal ΔP_{R2} using equations (5), (6), (7) and (8) described earlier.

The second adder 512 adds the first thermal generator power disturbance signal ΔP_{R}_{₁} received from the first thermal energy generator 504, the first RES-1 power disturbance signal ΔPᵣₑₛ_{₁}, received from plurality of renewable sources, the load power disturbance signal ΔP_{L}_{₁}, and the tie-line power disturbance signal ΔP_{tie1,2}, sum the first thermal generator power disturbance signal ΔP_{R}_{₁} with the first RES-1 power disturbance signal ΔPᵣₑₛ_{₁}, subtract the first load power disturbance signal ΔP_{L}_{₁}, subtract the tie-line power disturbance signal ΔP_{tie1,2}, and generate a first geographic area power disturbance signal ΔPₛ_{₁};

Similarly, the fourth adder 534 adds the second thermal generator power disturbance signal ΔP_{R2} received from the second thermal energy generator 526, the second RES-2 power disturbance signal ΔPᵣₑₛ_{₂}, received from plurality of renewable sources, the load power disturbance signal ΔPL₂, and the tie-line power disturbance signal ΔP_{tie1,2}, sum the second thermal generator power disturbance signal ΔP_{R}_{₂} with the second RES-2 power disturbance signal ΔPᵣₑₛ_{₂}, subtract the second load power disturbance signal ΔPL₂, subtract the tie-line power disturbance signal ΔP_{tie1,2}, and generate a second geographic area power disturbance signal ΔPₛ_{₂}.

The generated first geographic area power disturbance signal ΔPₛ_{ᵢ} is fed as input to the first output generator 514. Similarly, the generated second geographic area power disturbance signal ΔPₛ_{₂} is fed as input to the second output generator 536. The first output generator 514 has transfer function as below:

$${G}_{gen} ( s ) = \frac{1}{M 1 S + D 1} . \qquad ( 101 )$$

Also

The second output generator 536 has transfer function as below:

$${G}_{gen} ( s ) = \frac{1}{M 2 S + D 2} \qquad ( 102 )$$

Now if the first output generator 514 still finds a deviation in frequency (i.e., Δf1 is still non-zero) even at the new generated parameters of the FOPID-1 controller 604-1 and first FOPID-2 controller 608-1, the deviation value in frequency Δf1 is again fed back to the first ITAE-1 computation block 612-1 of the CFMOC-FOPID-1 controller 502. Similarly, if the second output generator 536 also finds a deviation in frequency (i.e., Δf1 is still non-zero) even at the new generated parameters of the third FOPID-3 controller 604-2 and fourth FOPID-4 controller 608-2, the deviation value in frequency Δf₂ is again fed back to the second ITAE-2 block 612-2 of the CFMOC-FOPID controller 524.

The new deviation value in frequency (i.e., frequency disturbance Δfᵢ) is again fed back through the first feedback connection line 554 to the first droop controller 518 and the fifth adder 520. Similarly, the new deviation value in frequency (i.e., frequency disturbance Δf₂) is again fed back through the second feedback connection line 556 to the second droop controller 540 and the third adder 542.

The first adder 520 adds the receives a new frequency disturbance value (Δfᵢ) multiplied by the frequency bias factor βᵢ. The first adder 520 further receive the tie-line power disturbance signal ΔP_{tie,1,2} from the transmission line 558 over a measurement interval i. The first adder 520 adds the frequency disturbance value Δfᵢ multiplied by the frequency bias factor β₁ to the tie-line power disturbance signal ΔP_{tie,1,2} and generates the first area central error (ACE-1) signal at the new frequency disturbance value (Δfᵢ). Mathematically

$${ACE}_{1} = {B}_{1} Δ {f}_{1} + {ΔTie}_{1 , 2} i \neq j \qquad ( 103 )$$

The new value of the first area central error (ACE-1) is again fed back to the CFMPC-FOPID controller-1 502 which is representative of the CFMPC-FOPID controller 600-1 in FIG. 6A.

Similarly, the third adder 542 adds the receives a new frequency disturbance value (Δf₂) multiplied by the frequency bias factor β₂. The third adder 542 further receive the tie-line power disturbance signal ΔP_{tie,1,2} from the transmission line 558 over a measurement interval i. The third adder 542 adds the frequency disturbance value Δf₂ multiplied by the frequency bias factor β₂ to the tie-line power disturbance signal ΔP_{tie,1,2} and generates the second area central error (ACE-2) signal at the new frequency disturbance value (Δf₂). Mathematically

$${ACE}_{2} = {B}_{2} Δ {f}_{2} + Δ {Tie}_{1 , 2} i \neq j \qquad ( 104 )$$

The new value of the first area central error (ACE-2) is again fed back to the CFMPC-FOPID-1 controller 502 which is representative of the CFMPC-FOPID-1 controller 600-2 in FIG. 6B.

Accordingly, the CFMPC-FOPID-1 controller 502, 600-1 again repeats the process of optimization process of the gain parameter constraints of the FOPID-1 controller 604-1 and first FOPID-2 controller 608-1 using the first sooty terns controller 610-1, IETE-1 block 612. The entire process repeats for plurality of iterations until the ACEᵢ completely minimized to zero. Accordingly, the CFMPC-FOPID-1 controller 502, 600-1 continues to iterate the process till the ACEᵢ signal is completely minimized at plurality of gain parameter constraints of the FOPID-1 controller 604-1 and first FOPID-2 controller 608-1 using the first sooty terns controller 610-1. The similar process is also repeated for CFMPC-FOPID controller 524, 600-2 for finding the minimized value of ACE₂.

When the ACEᵢ and ACE₂ signal are minimized at the optimal gain parameter constraints of the FOPID-1 controller 604-1, first FOPID-2 controller 608-1 and the third FOPID-3 controller 604-2, the fourth FOPID-4 controller 608-2, extracted from the iteration from the first sooty terns controller 610-1 and the second sooty terns controller 610-2, respectively, both areas are completely stabilized and no more frequency deviation occurs in either area. Accordingly, the frequency disturbances of power plants 504, 526 are regulated by minimizing the ACEᵢ and ACE₂ signal.

Table 1 below shows a comparative observation on determining the parameters of the CFMPC processor 402, FOPID-1 controller 404 and FOPID-2 controller 408 for both areas using the sooty terns controller 410 and plurality of other controller known in the art. In Table 1, reference [26] is Tasnin, Washima, and Lalit Chandra Saikia. “Deregulated AGC of multi-area system incorporating dish-Stirling solar thermal and geothermal power plants using fractional order cascade controller.” International Journal of Electrical Power & Energy Systems 101 (2018): 60-74; reference [24] is Veerasamy, Veerapandiyan, Noor Izzri Abdul Wahab, Rajeswari Ramachandran, Mohammad Lutfi Othman, Hashim Hizam, Andrew Xavier Raj Irudayaraj, Josep M. Guerrero, and Jeevitha Satheesh Kumar. “A Hankel matrix based reduced order model for stability analysis of hybrid power system using PSO-GSA optimized cascade PI-PD controller for automatic load frequency control.” IEEE Access 8 (2020): 71422-71446; reference [22] is çelik, Emre. “Design of new fractional order PI-fractional order PD cascade controller through dragonfly search algorithm for advanced load frequency control of power systems.” Soft Computing 25, no. 2 (2021): 1193-1217; [31] is Gulzar, Muhammad Majid, Syed Tahir Hussain Rizvi, Muhammad Yaqoob Javed, Daud Sibtain, and Rubab Salah ud Din. “Mitigating the load frequency fluctuations of interconnected power systems using model predictive controller.” Electronics 8, no. 2 (2019): 156.

TABLE 1
Optimal parameters of different controller at 100 iterations

| | SCA: FOPI-FOPID | GWO: PI-PD | DSA-FOPI | MPC/PI | |
|---|---|---|---|---|---|
| Multi-area | [26] | [24] | [22] | [31] | Present Controller |
| Area-1 | K_{P1} = 0.0216 | K_{P1} = −3.018 | K_{P} = 1.207 | K_{P} = 0.301 | K_{P1} = 2.110 |
| | K_{I1} = 0.580 | K_{I1} = −2.167 | K_{I} = 5.199 | K_{I} = 0.870 | K_{I1} = 4.122 |
| | λ₁ = 0.891 | K_{P1} = −2.501 | K_{D} = 0.289 | | K_{D1} = 0.0281 |
| | K_{P12} = 0.1061 | K_{D1} = −1.012 | λ = 0.699 | | λ₁ = 0.991 |
| | K_{I12} = 0.8139 | | | | μ₁ = 0.809 |
| | K_{D12} = 0.0311 | | | | K_{P2} = 1.652 |
| | λ₁₂ = 0.679 | | | | K_{I2} = 3.788 |
| | μ₁₂ = 0.081 | | | | K_{D2} = 0.0382 |
| | | | | | λ₂ = 0.728 |
| | | | | | μ₂ = 0.791 |
| | | | | | MPC Parameters |
| | | | | | P = 10 |
| | | | | | M = 2.357 |
| | | | | | R = 3.895 |
| | | | | | Q = 1.000 |
| Area-2 | K_{P2} = 0.0408 | K_{P1} = −2.019 | K_{P} = 0.873 | K_{P} = 0.196 | K_{P1} = 1.933 |
| | K_{I2} = 0.3111 | K_{I1} = −3.022 | K_{I} = 5.158 | K_{I} = 0.827 | K_{I1} = 5.281 |
| | λ₂ = 0.607 | K_{P1} = −3.514 | K_{D} = 1.991 | | K_{D1} = 0.0301 |
| | K_{P22} = 0.0871 | K_{D1} = −0.828 | λ = 0.801 | | λ₁ = 0.902 |
| | K_{I22} = 0.9024 | | | | μ₁ = 0.930 |
| | K_{D22} = 0.0732 | | | | K_{P2} = 0.885 |
| | λ₂₂ = 0.841 | | | | K_{I2} = 2.551 |
| | μ₂₂ = 0.974 | | | | K_{D2} = 0.0112 |
| | | | | | λ₂ = 0.898 |
| | | | | | μ₂ = 0.995 |
| | | | | | MPC Parameters |
| | | | | | P = 6 |
| | | | | | M = 4.237 |
| | | | | | R = 5.285 |
| | | | | | Q = 1.003 |

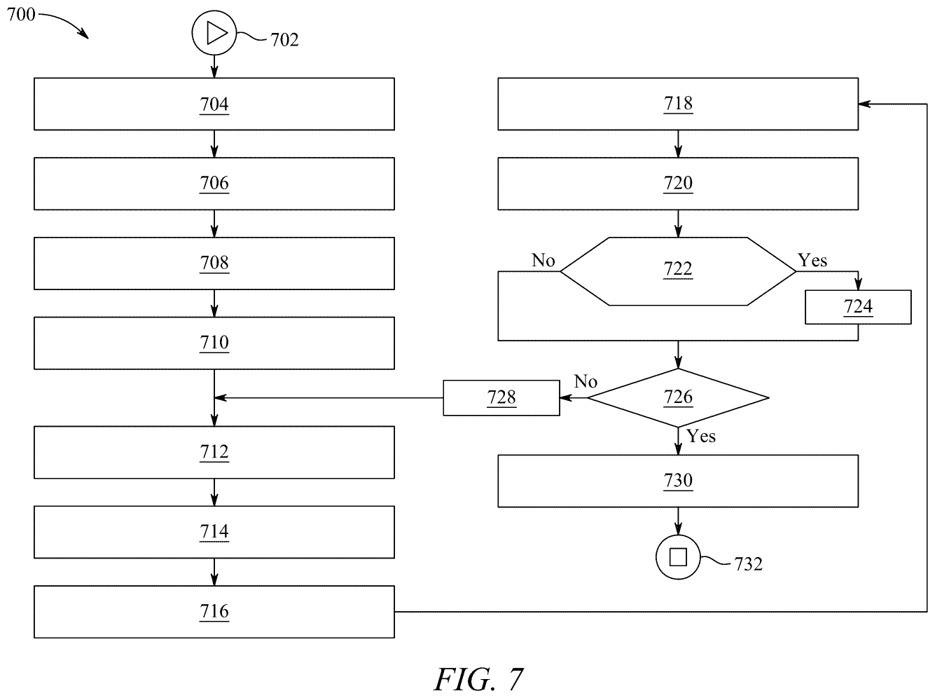

FIG. 7 illustrates an STOA flowchart for the CFMPC-FOPID based controller 104, 400, 502, 524, 600-1, 600-2. At step 702, the process begins. At step 704, a Simulink model of the STOA flowchart is initialized in a MATLAB3 platform. At step 706, all the controlling parameters of the STOA is specified in the MATLAB. At step 708, all parameters of CFMIPC processor 402, 602-1, FOPID-1 controller 404, 604-1, 604-2 and FOPID-2 controller 408, 608-1, 608-2 are initialized in the MATLAB. When the frequency disturbance is encountered, the sooty terns controller 410, 610-1 and 610-2 is configured to compute the associated fitness formula i.e., IETE. This step is represented as step 710. At step 712 and 714, the sooty terns controller 410, 610-1 and 610-2 starts to iterate the computation of the optimal parameters for FOPID-1, FOPID-2, FOPID-3 and FOPID-4 at which the ACE1,2 (or ACEᵢ in general) are minimized or reduced to zero. At step 716, the sooty terns controller 410, 610-1 and 610-2 updates the sooty tern positions. At step 718, the sooty terns controller 410, 610-1 and 610-2 updates the value of S_{A} and C_{B}. At step 720 the sooty terns controller 410, 610-1 and 610-2 computes an updated fitness function ITAE. At step 722, the sooty terns controller 410, 610-1 and 610-2 determines if the ACE1,2 (or ACEᵢ in general) is minimized at the current values of the computed parameters of the FOPID-1, FOPID-2, FOPID-3 and FOPID-4. If yes, step the sooty terns controller 410, 610-1 and 610-2 updates the P_{best}. At step 726, the sooty terns controller 410, 610-1 and 610-2 identifies if iterations are needed and the cycle repeats to find the optimal parameters of FOPID-1, FOPID-2, FOPID-3 and FOPID-4 and CFMPC through step 728. After performing multiple iterations, the sooty terns controller 410, 610-1 and 610-2 identifies and displays the optimal parameters of FOPID-1, FOPID-2, FOPID-3 and FOPID-4 and CFMPC at step 730. At step 732, the process ends.

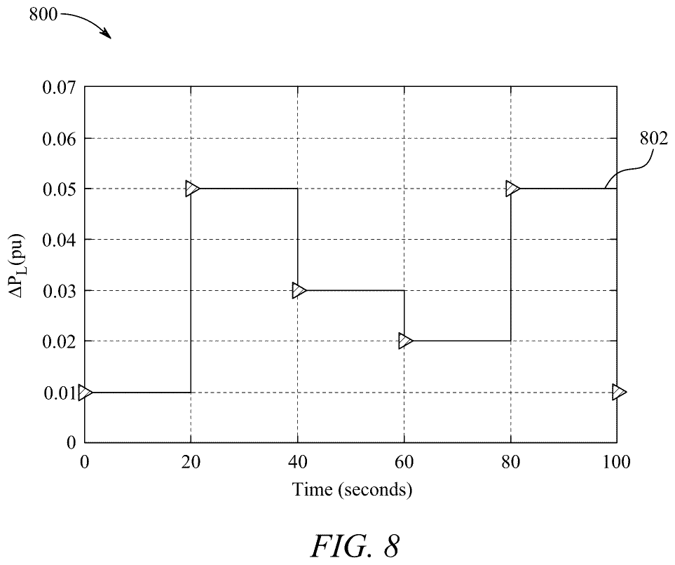

FIG. 8 illustrates a load pattern 800 applied in both areas for testing the performance of the CFMPC-FOPID based controller 104, according to an embodiment. Thermal energy generators 100-1 and 100-2 includes at least one PV array 130 and at least one wind energy source 132. A plotline 802 shows a fluctuating load pattern is applied to the CFMPC-FOPID based controller 104. The fluctuating load pattern is applied in both areas.

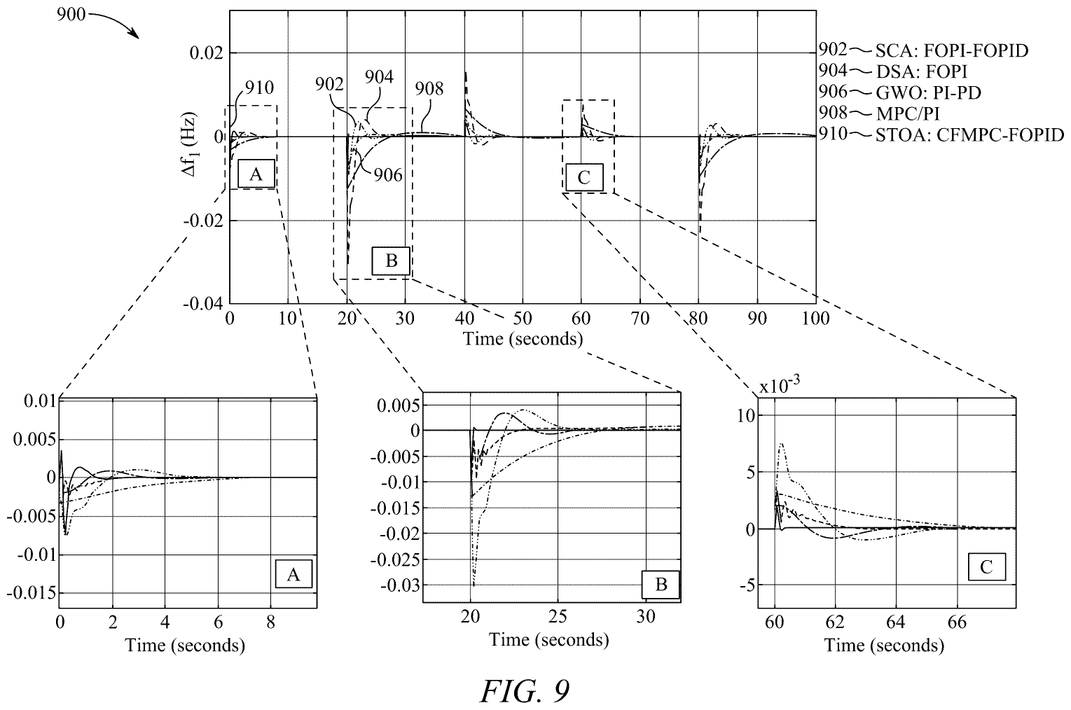

FIG. 9 illustrates frequency deviation response curves 900 of the CFMPC-FOPID based controller 104 in the first area on application of fluctuating load pattern in both areas, according to an embodiment. A plotline 902, a plotline 904, a plotline 906, plotline 908 and a plotline 910 shows the frequency deviation response from a FOPI-FOPID based controller, a FOPI based controller, a PI-PD based controller, a MPC-PI based controller and the CFMPC-FOPID based controller 104, respectively. A magnified representation at three points A, B and C is shown in inset A, B and C. The tabular study of the responses of the plurality of controllers under changing load condition is observed. The controller response at Point-A, Point-B and Point-C on graph is chosen to monitor the performance of the controllers in areal is presented in Table-2. The disclosed controller (CFMPC-FOPID) shows a settling time of 1.21 sec, 0.727 sec and 0.689 sec for Point-A, Point-B and Point-C respectively. It is clear from plurality of plotlines A, B and C as well as from Table 2, that the frequency deviation response of the CFMPC-FOPID based controller 104 achieves better results compared to other controllers known in the art.

TABLE 2
Controller analysis in area-1 for Point-A, B and C on graph under similar load conditions

| | Area-1 | | | | | | | | |
|---|---|---|---|---|---|---|---|---|---|
| | Point-A | | | Point-B | | | Point-C | | |
| | S.T | U.S | O.S | S.T | U.S | O.S | S.T | U.S | O.S |
| Controllers | (s) | (Hz) | (Hz) | (s) | (Hz) | (Hz) | (s) | (Hz) | (Hz) |
| Present | 1.21 | 0.0068 | 0.0031 | 0.727 | 0.0062 | 0 | 0.689 | 0 | 0.0032 |
| Disclosure | | | | | | | | | |
| MPC/PI | 7.89 | 0.0042 | 0 | 11.58 | 0.014 | 0.0010 | 5.728 | 0 | 0.0044 |
| DSA-FOPID | 5.67 | 0.0065 | 0.0020 | 5.308 | 0.03 | 0.00431 | 5.211 | 0.00129 | 0.00785 |
| GWO: PI-PD | 1.98 | 0.0052 | 0 | 2.89 | 0.0098 | 0 | 2.014 | 0 | 0.00304 |
| SCA: FOPI- | 3.047 | 0.0041 | 0.0019 | 5.101 | 0.0079 | 0.048 | 3.108 | 0.00108 | 0.00312 |
| FOPID | | | | | | | | | |

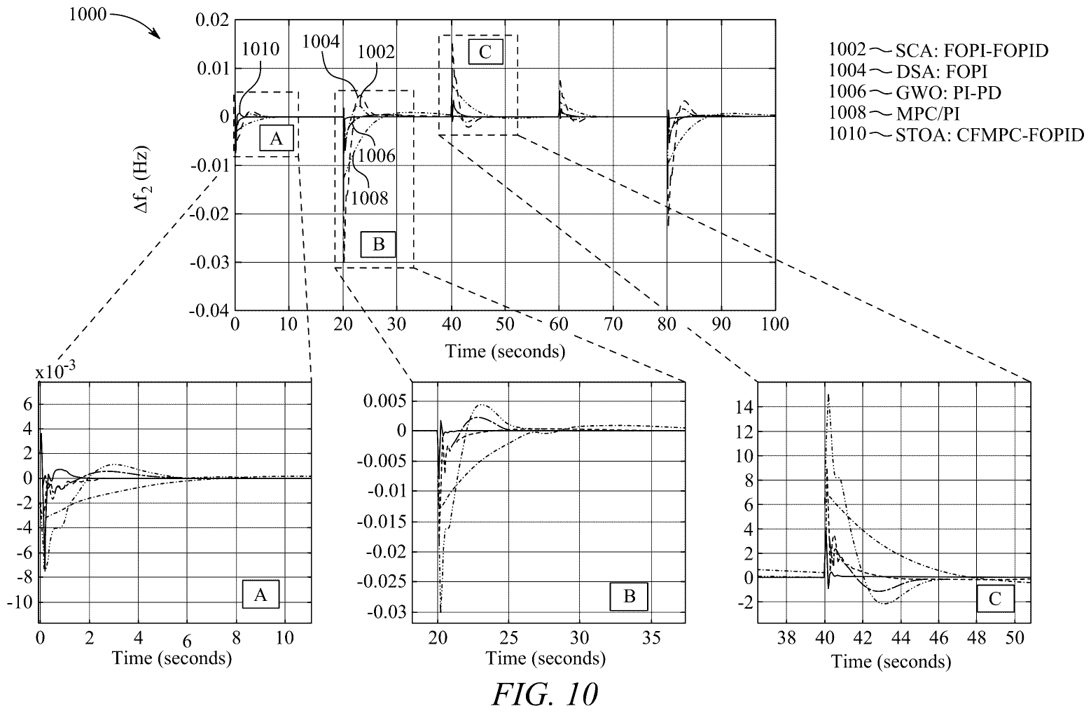

FIG. 10 illustrates frequency deviation response curves 1000 of the CFMPC-FOPID based controller 104 in the second area on application of a fluctuating load pattern in both areas, according to an embodiment. A plotline 1002, a plotline 1004, a plotline 1006, a plotline 1008 and a plotline 1010 shows the frequency deviation response from FOPI-FOPID based controller, FOPI based controller, PI-PD based controller, MPC-PI based controller and CFMPC-FOPID based controller 104, respectively. A magnified representation at three points A, B and C is shown in inset A, B and C. The tabular study of the responses of the plurality of controllers under changing load conditions is observed for the second area. The response of the CFMPC-FOPID based controller 104 at Point-A, Point-B and Point-C on graph is chosen to monitor the performance of the controllers in area 2 and is presented in Table-3. The frequency response analysis indicates that the controller of the present disclosure has successfully reduced the frequency of abrupt reaction times. The reaction time of the CFMPC-FOPID based controller 104 is 1.79 sec for Point-A, 0.651 sec for Point-B, and 0.86 sec for Point-C. It is clear from plurality of plotlines A, B and C as well as from Table 2, that the frequency deviation response of the CFMPC-FOPID based controller 104 achieves better results compared to other controllers known in the art.

TABLE 3
Controller analysis in area-2 for Point-A, B and C on graph under similar load conditions

| | Area-2 | | | | | | | | |
|---|---|---|---|---|---|---|---|---|---|
| | Point-A | | | Point-B | | | Point-C | | |
| | S.T | U.S | O.S | S.T | U.S | O.S | S.T | U.S | O.S |
| Controllers | (s) | (Hz) | (Hz) | (s) | (Hz) | (Hz) | (s) | (Hz) | (Hz) |
| Disclosure | 1.79 | 0.0072 | 0.0038 | 0.651 | 00.0061 | 0.0011 | 0.86 | 0.0008 | 0.0038 |
| MPC/PI | 6.708 | 0.0035 | 0 | 7.88 | 0.013 | 0 | 9.087 | 0 | 0.0065 |
| DSA-FOPID | 5.71 | 0.0076 | 0.0011 | 6.08 | 0.03 | 0.00480 | 5.701 | 0.0020 | 0.0148 |
| GWO: PI-PD | 2.08 | 0.0041 | 0 | 2.72 | 0.0161 | 0 | 3.211 | 0 | 0.0090 |
| SCA: FOPI- | 4.022 | 0.0038 | 0.0008 | 5.09 | 0.0036 | 0.037 | 4.801 | 0.00137 | 0.00332 |
| FOPID | | | | | | | | | |

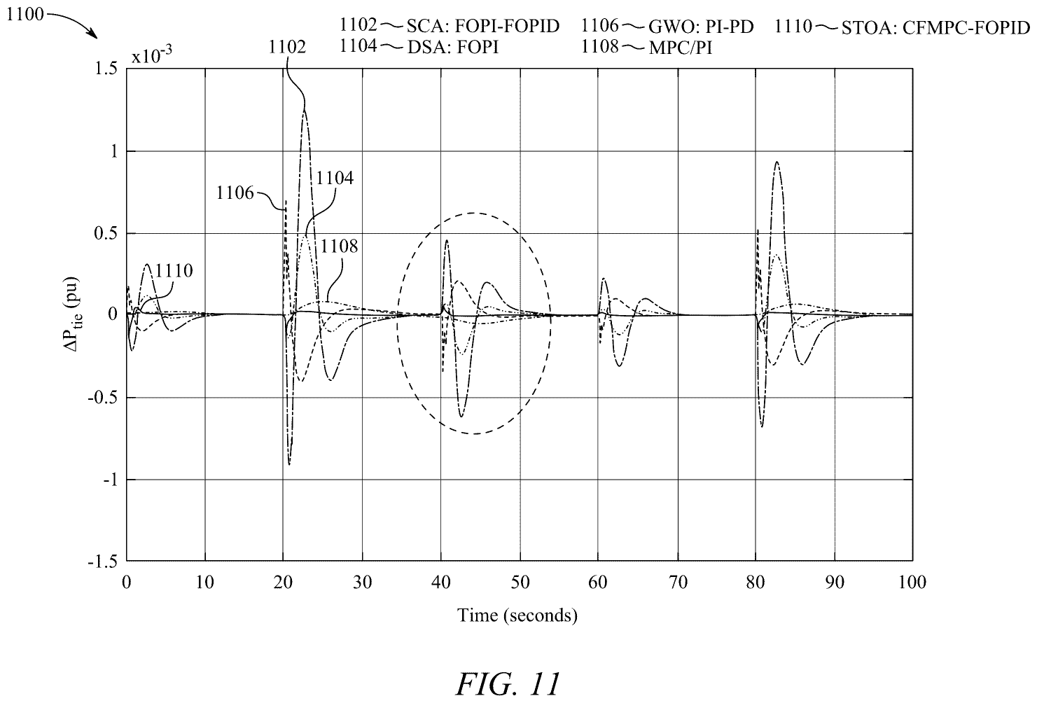

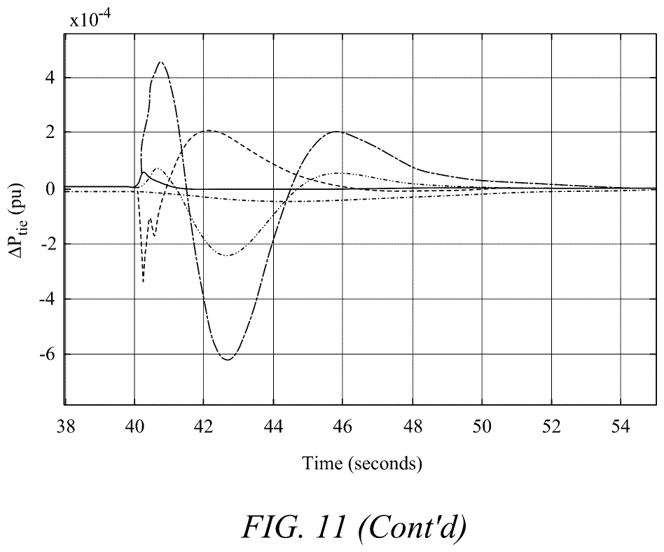

FIG. 11 illustrates power exchange pattern (tie-line) curves 1100 between the two-areas under similar load condition, according to an embodiment. A plotline 1102, a plotline 1104, a plotline 1106, a plotline 1108 and a plotline 1110 show the power exchange pattern (tie-line) between the two-areas of FOPI-FOPID based controller, FOPI based controller, PI-PD based controller, MPC-PI based controller and CFMPC-FOPID based controller 104, respectively. A magnified representation is also shown. Based upon the plurality of plotlines, it was identified that the exchange of power response of the CFMPC-FOPID based controller 104 is robust as compared to other controllers. The CFMPC-FOPID based controller 104 shows a minute fluctuation in power curve with respect to other controllers.

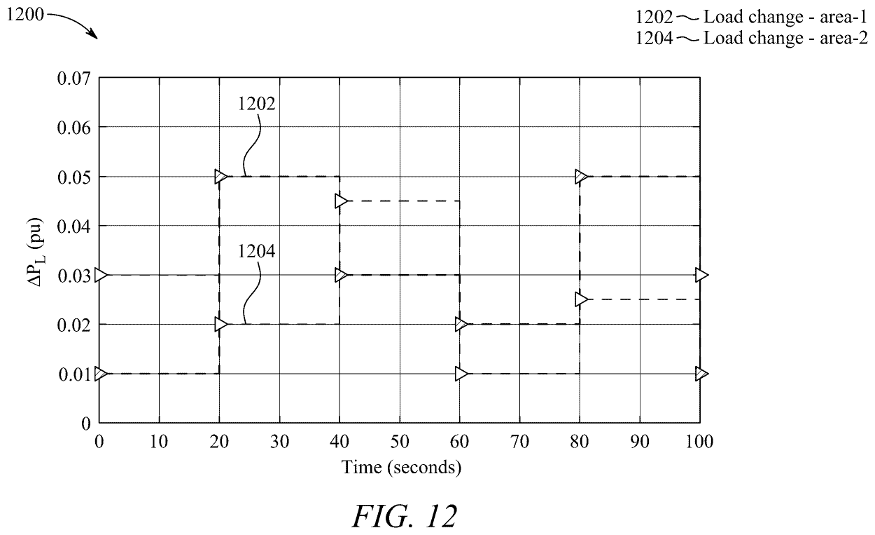

FIG. 12 illustrates different load pattern curves 1200 applied in both areas for testing the performance of the CFMPC-FOPID based controller 104, according to an embodiment. A plotline 1202 shows a fluctuating load pattern in a first area whereas a plotline 1204 shows a fluctuating load pattern in a second area. Both type of load patterns are applied to the CFMPC-FOPID based controller 104.

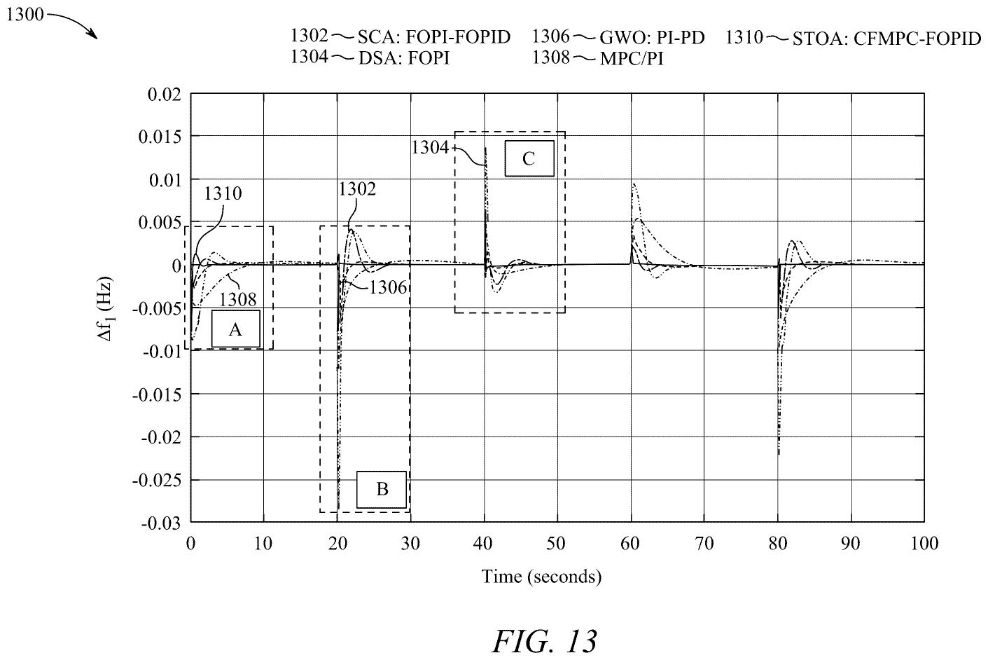

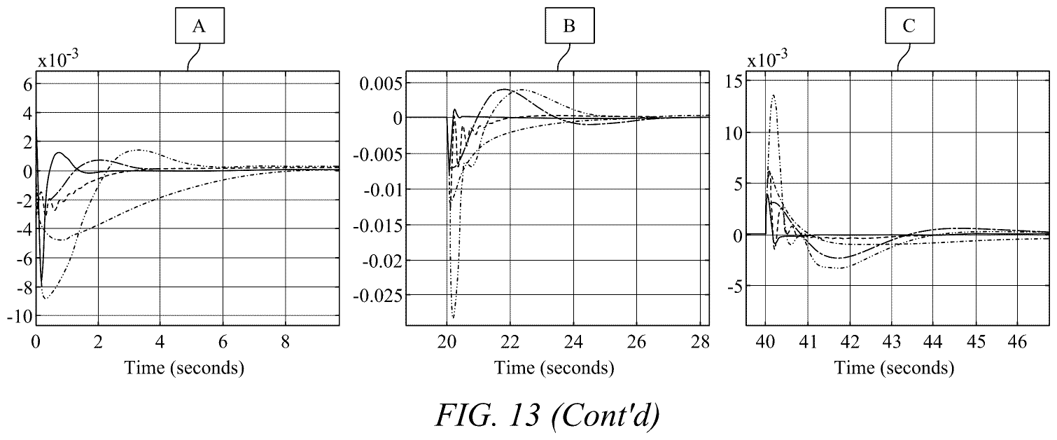

FIG. 13 illustrates frequency deviation response curves 1300 of the CFMPC-FOPID based controller 104 in the first area on application of a fluctuating but distinct load pattern in both areas, according to an aspect. A plotline 1302, a plotline 1304, a potline 1306, a plotline 1308 and a plotline 1310 show the frequency deviation response from FOPI-FOPID based controller, FOPI based controller, PI-PD based controller, MPC-PI based controller and CFMPC-FOPID based controller 104, respectively. A magnified representation at three points A, B and C is shown in inset A, B and C. The tabular study of the responses of the plurality of controllers under changing load condition is observed. The controller response at Point-A, Point-B and Point-C on graph is chosen to monitor the performance of the controllers in areal is presented in Table-4. The controller (CFMPC-FOPID) of disclosure shows a settling time of 1.34 sec, 0.601 sec and 0.410 sec for Point-A, Point-B and Point-C respectively for area-1. It is clear from plurality of points A, B and C as well as from Table 4, that the frequency deviation response of the CFMPC-FOPID based controller 104 achieves better results compared to other controllers known in the art.

TABLE 4
Controller analysis in area-1 for Point-A, B and C on graph under distinct load condition

| | Area-1 | | | | | | | | |
|---|---|---|---|---|---|---|---|---|---|
| | Point-A | | | Point-B | | | Point-C | | |
| | S.T | U.S | O.S | S.T | U.S | O.S | S.T | U.S | O.S |
| Controllers | (s) | (Hz) | (Hz) | (s) | (Hz) | (Hz) | (s) | (Hz) | (Hz) |
| Disclosure | 1.34 | 0.0077 | 0.0038 | 0.601 | 0.006 | 0 | 0.410 | 0 | 0.0031 |
| MPC/P | 7.98 | 0.0050 | 0 | 5.051 | 0.015 | 0 | 9.985 | 0.0009 | 0.0052 |
| DSA-FOPID | 5.13 | 0.0087 | 0.0018 | 4.981 | 0.034 | 0.00401 | 3.928 | 0.00301 | 0.01381 |
| GWO: PI-PD | 2.312 | 0.00557 | 0 | 2.00 | 0.0128 | 0 | 1.011 | 0 | 0.00289 |
| SCA: FOPI- | 3.126 | 0.00308 | 0.0012 | 6.005 | 0.0061 | 0.047 | 5.027 | 0.00201 | 0.01302 |
| FOPID | | | | | | | | | |

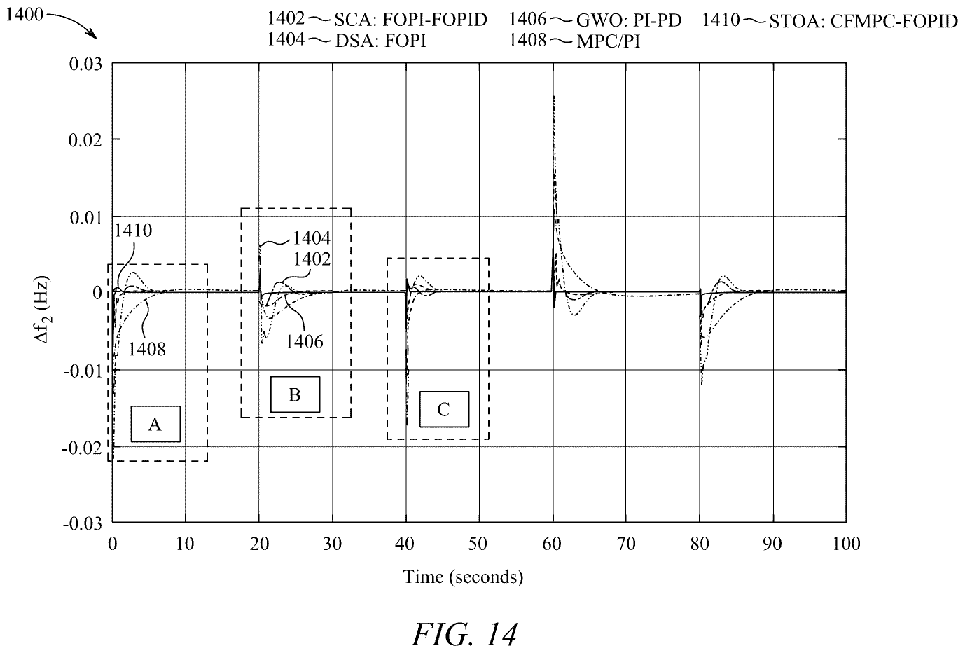

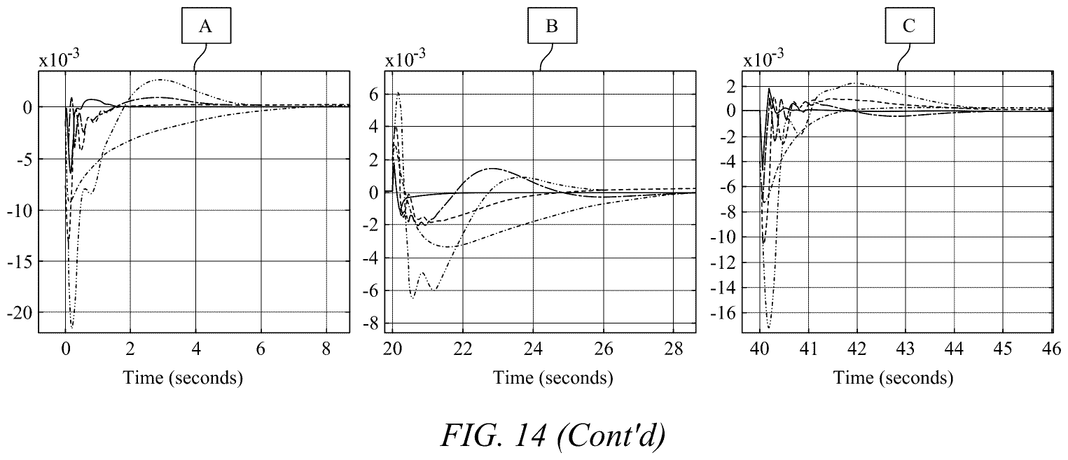

FIG. 14 illustrates frequency deviation response curves 1400 of the CFMPC-FOPID based controller 104 in the second area on application of fluctuating but distinct load pattern in both areas, according to an embodiment. A plotline 1402, a plotline 1404, a plotline 1406, a plotline 1408 and a plotline 1410 show the frequency deviation response from FOPI-FOPID based controller, FOPI based controller, PI-PD based controller, MPC-PI based controller and CFMPC-FOPID based controller 104, respectively in the first area. A magnified representation at three points A, B and C is shown in inset A, B and C. The tabular study of the responses of the plurality of controllers under changing load condition is observed. The controller response at Point-A, Point-B and Point-C on the graph is chosen to monitor the performance of the controllers in areal as presented in Table-5. The controller (CFMPC-FOPID) shows a settling time of 1.401 sec for Point-A, 0.891 sec for Point-B, and 0.560 sec for Point-C. The controller of the present disclosure shows fast settling time in restraining the frequency disturbance. It is clear from plurality of points A, B and C as well as from Table 5, that the frequency deviation response of the CFMPC-FOPID based controller 104 achieves better results compared to other controllers known in the art.

TABLE 5
Controller analysis in area-2 for Point-A, B and C on graph under distinct load conditions

| | Area-2 | | | | | | | | |
|---|---|---|---|---|---|---|---|---|---|
| | Point-A | | | Point-B | | | Point-C | | |
| | S.T | U.S | O.S | S.T | U.S | O.S | S.T | U.S | O.S |
| Controllers | (s) | (Hz) | (Hz) | (s) | (Hz) | (Hz) | (s) | (Hz) | (Hz) |
| Disclosed | 1.401 | 0.0062 | 0.0007 | 0.891 | 0.001 | 0.0018 | 0.560 | 0.0046 | 0.0018 |
| MPC/PI | 6.87 | 0.0091 | 0 | 7.631 | 0.038 | 0 | 4.902 | 0.0072 | 0.00018 |
| DSA-FOPID | 5.60 | 0.0297 | 0.0039 | 5.68 | 0.00612 | 0.00603 | 4.108 | 0.017 | 0.0021 |
| GWO: PI-PD | 1.809 | 0.00601 | 0 | 5.01 | 0.0022 | 0.0038 | 3.521 | 0.0102 | 0.001 |
| SCA: FOPI- | 4.028 | 0.00308 | 0.00015 | 7.010 | 0.0021 | 0.00187 | 4.019 | 0.00611 | 0.01302 |
| FOPID | | | | | | | | | |

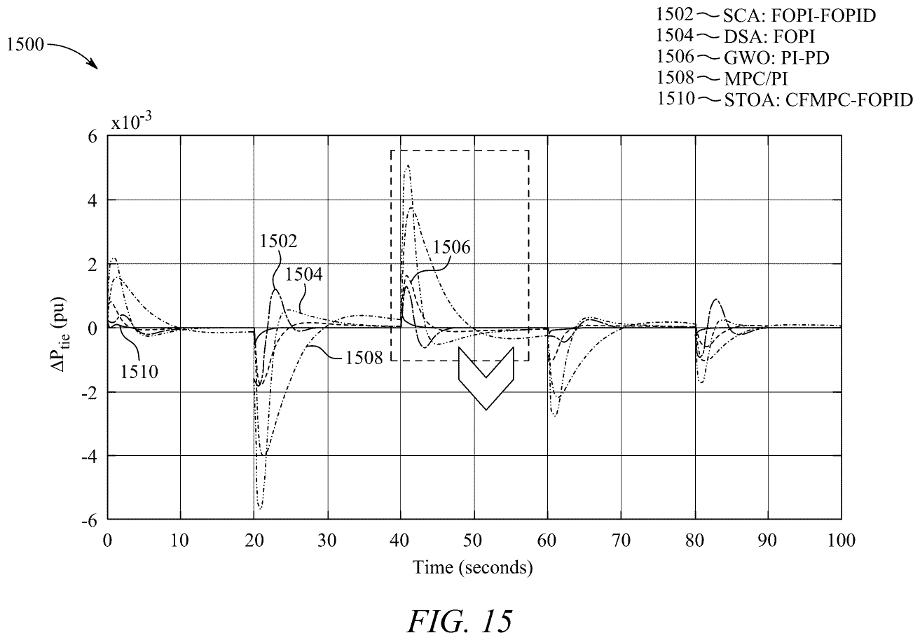

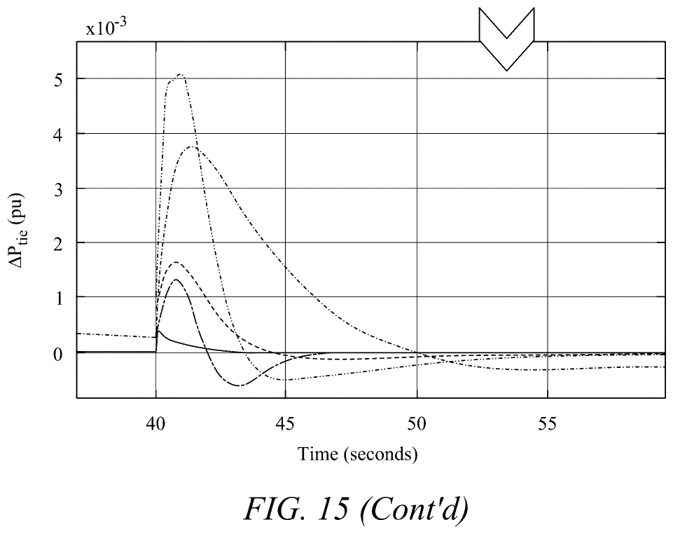

FIG. 15 illustrates a power exchange pattern (tie-line) curves 1500 between the two-areas under distinct load. A plotline 1502, a plotline 1504, a plotline 1506, a plotline 1508 and a plotline 1510 show the power exchange pattern (tie-line) between the two-areas at an application of distinct loads using FOPI-FOPID based controller, FOPI based controller, PI-PD based controller, MPC-PI based controller and CFMPC-FOPID based controller 104, respectively. A magnified representation at a point is also shown. It is evident from the response that the CFMPC-FOPID based controller 104 performs efficiently over other controllers and showing better power flow.

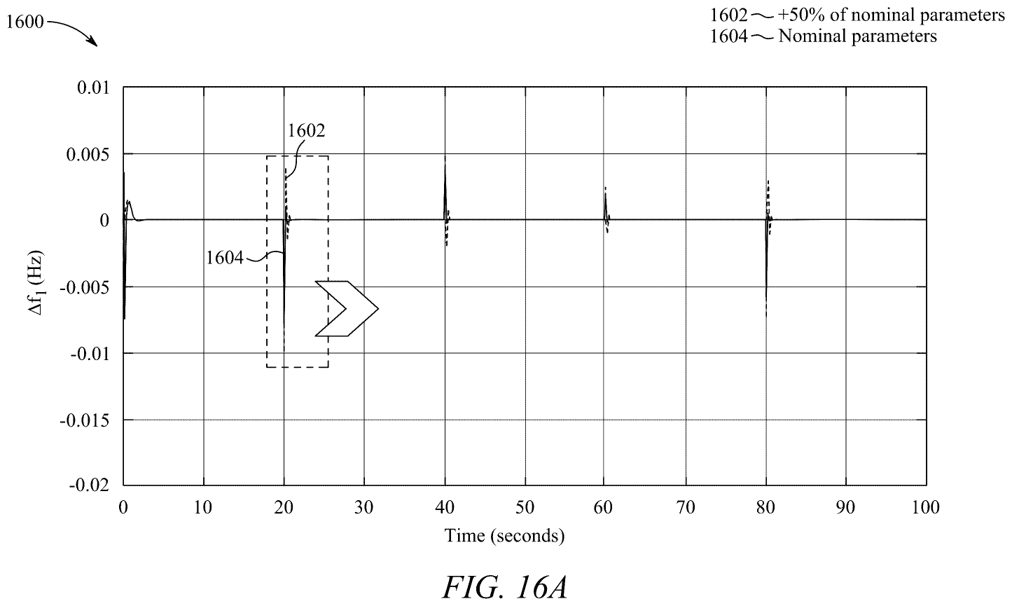

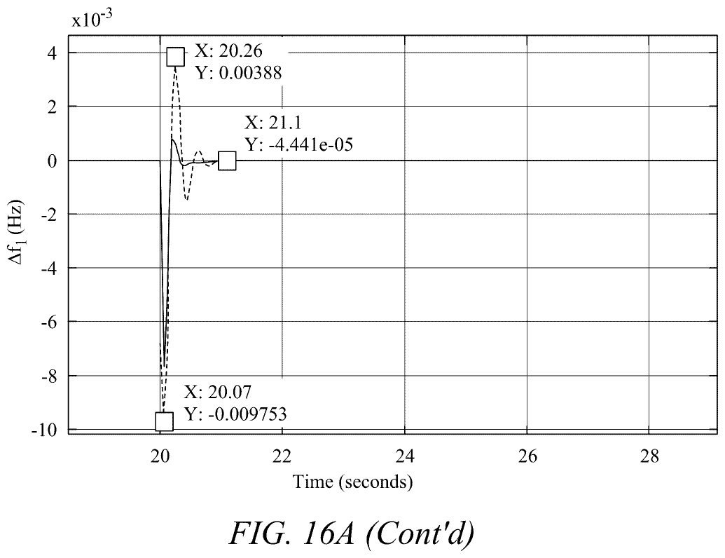

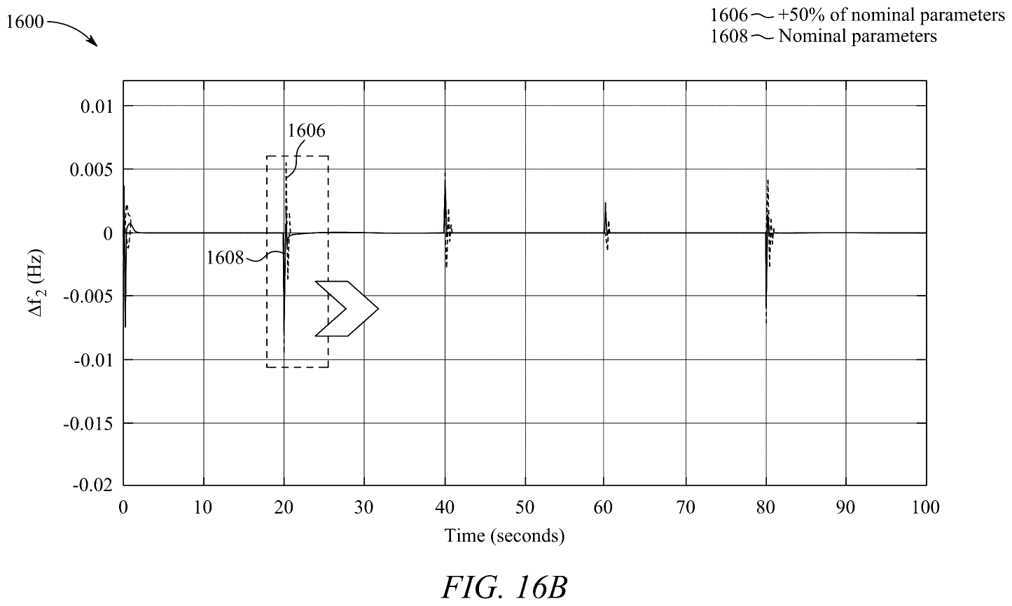

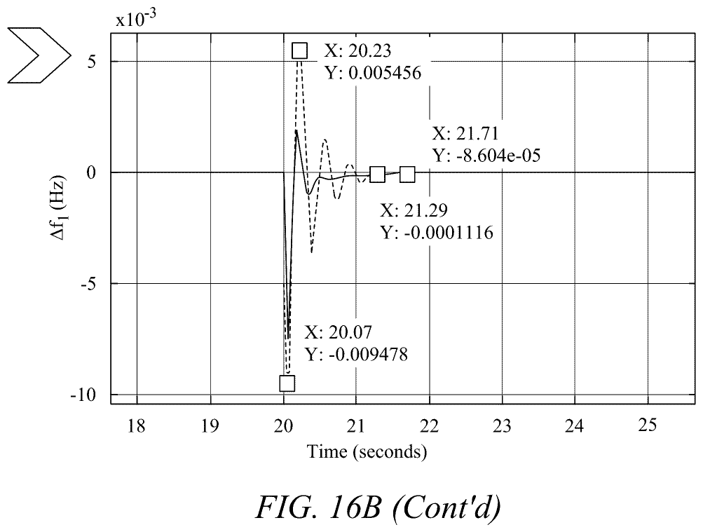

FIG. 16A illustrates analysis curves 1600 of the CFMPC-FOPID based controller 104 for area-1 under uncertainty in the system parameters at +50% variation of parameter. Due to unexpected uncertainty in thermal energy generators 100-1 and 100-2, the performance of the CFMPC-FOPID based controller 104 is tested. At the time of examining the performance of the CFMPC-FOPID based controller 104, a +50% variation is applied in governor parameter of the thermal energy generators 100-1 and 100-2 to monitor the control and settling performance of the CFMPC-FOPID based controller 104. A plotline 1602 represents an application of ±50% variation in the nominal parameter of the CFMPC-FOPID based controller 104 and a plotline 1604 represents a nominal parameters. It was observed that the nominal settling time of frequency was 1.1 sec in area 1. It is evident from the response that the CFMPC-FOPID based controller 104 performs efficiently.

FIG. 16B illustrates frequency deviation curves of the CFMPC-FOPID based controller 104 (also referred to as hybrid controller 104) for area-2 under uncertainty in the system parameters at +50% variation of parameter. A plotline 1606 represents an application of +50% variation in the nominal parameter of the CFMPC-FOPID based controller 104 and a plotline 1608 represents a nominal parameters. It was observed that the nominal settling time of frequency was 1.29 sec in area 2. It is evident from the response that the CFMPC-FOPID based controller 104 performs efficiently.

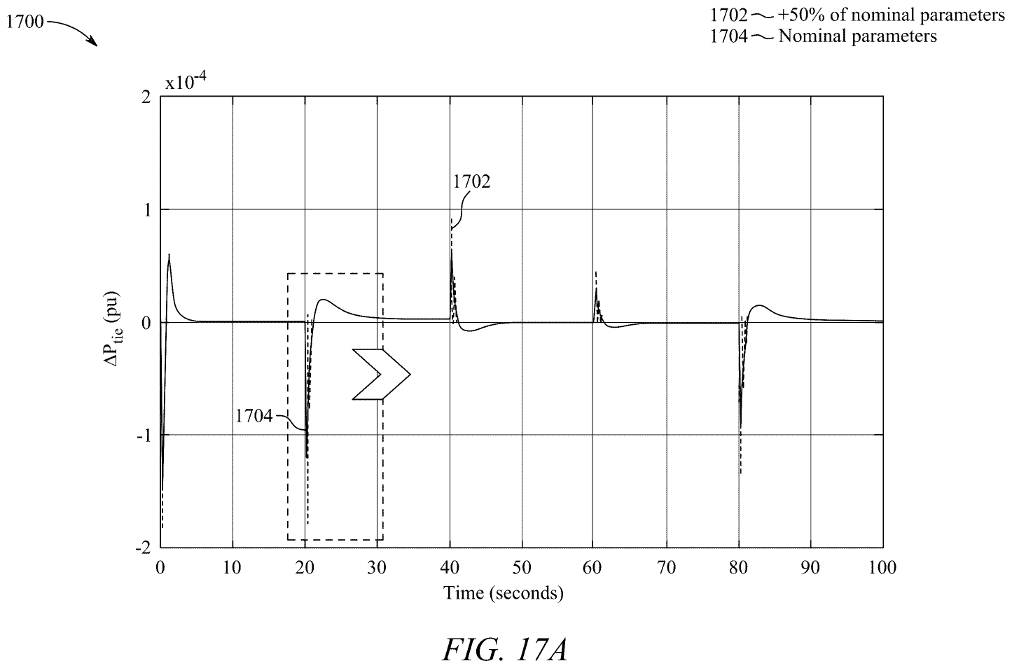

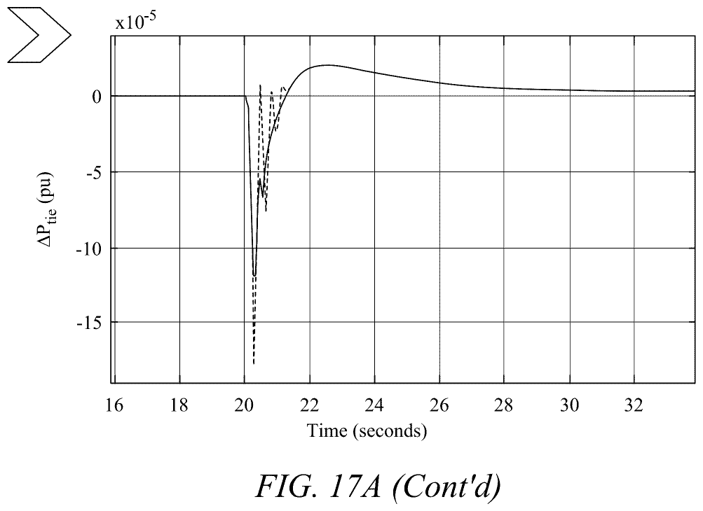

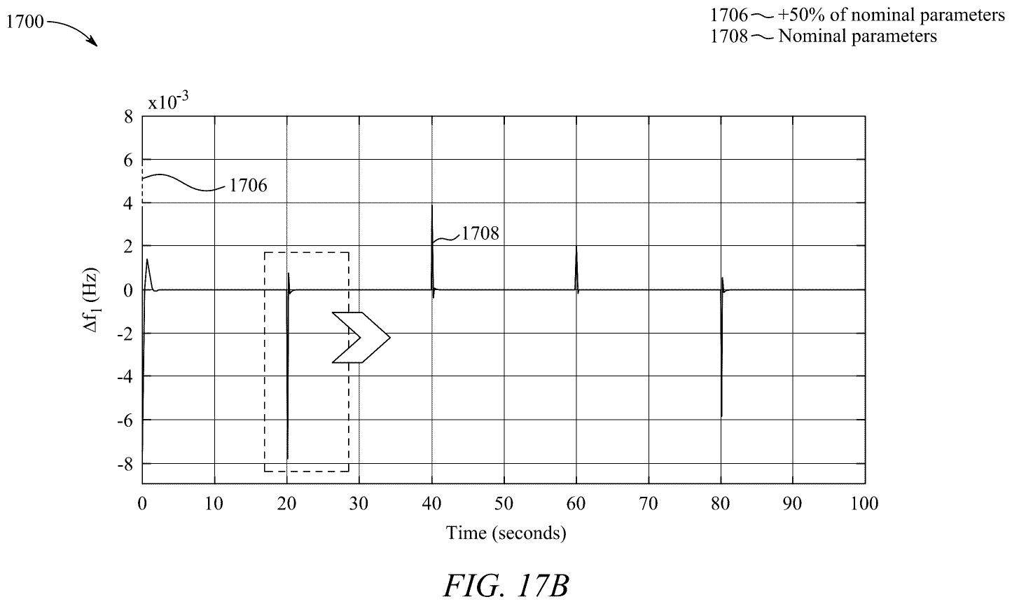

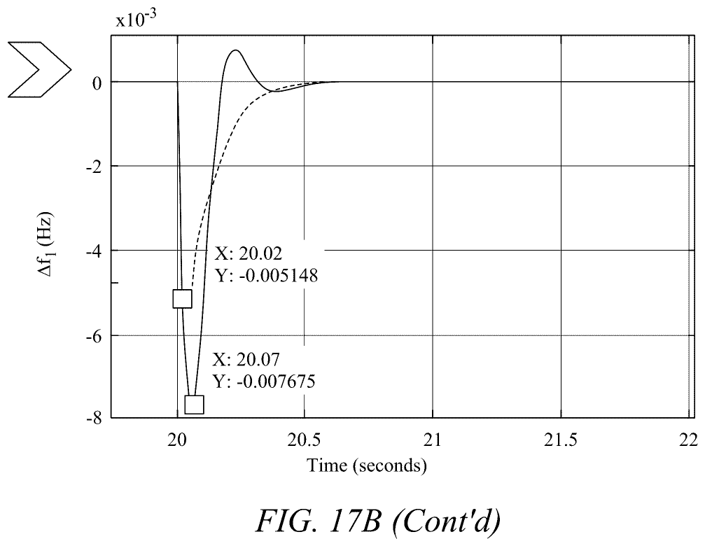

FIG. 17A illustrates tie-line power response curves 1700 of the CFMPC-FOPID based controller 104 under uncertainty in the system parameters at +50% variation of parameter. A plotline 1702 represents an application of +50% variation in the nominal parameter of the CFMPC-FOPID based controller 104 and a plotline 1704 represents a nominal parameters. A magnified view of the tie-line power response of the CFMPC-FOPID based controller 104 is also shown. It is evident from the response that the CFMPC-FOPID based controller 104 performs efficiently.

FIG. 17B illustrates analysis curves of the CFMPC-FOPID based controller 104 for area-1 under uncertainty in the system parameters at −50% variation of parameter. At the time of examining the performance of the CFMPC-FOPID based controller 104, a −50% variation is applied in governor parameter of thermal energy generators 100-1 and 100-2 to monitor the control and settling performance of the CFMPC-FOPID based controller 104. A plotline 1706 represents an application of −50% variation in the nominal parameter of the CFMPC-FOPID based controller 104 and a plotline 1708 represents a nominal parameters. It was observed that the nominal settling time of frequency was again 1.1 sec in area 1. It is evident from the response that the CFMPC-FOPID based controller 104 performs efficiently.

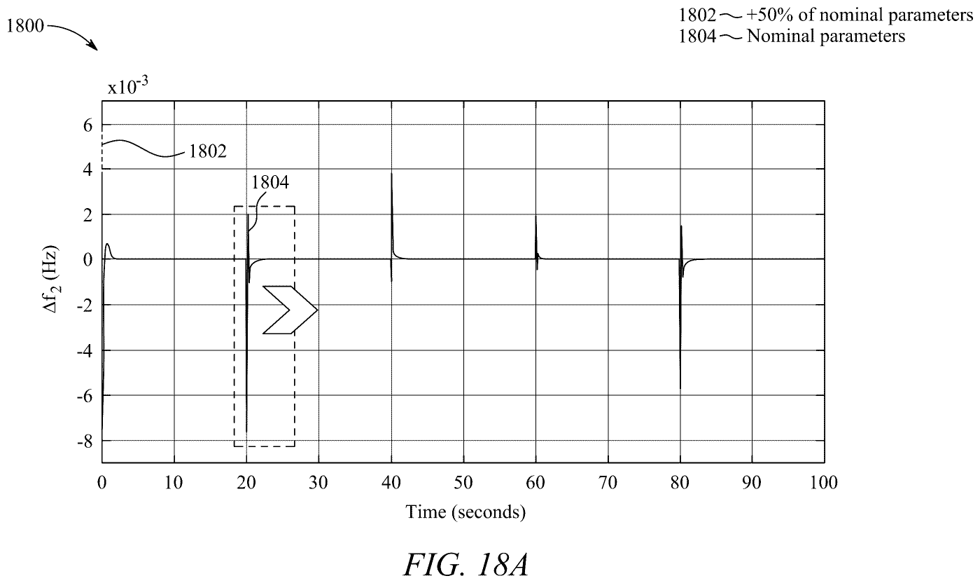

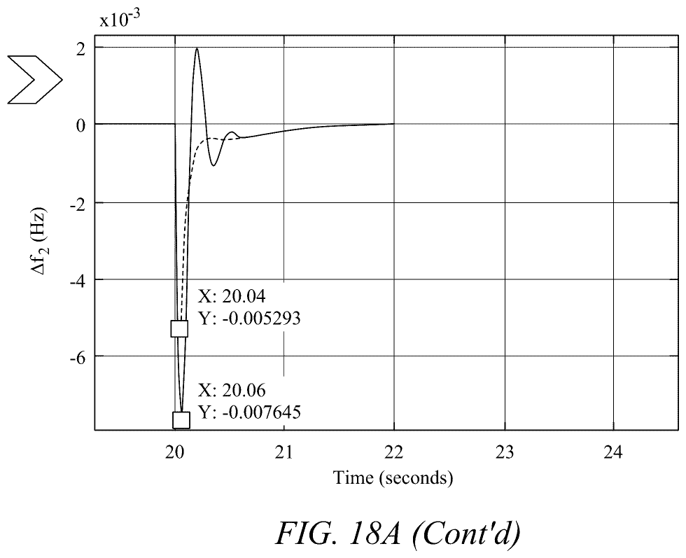

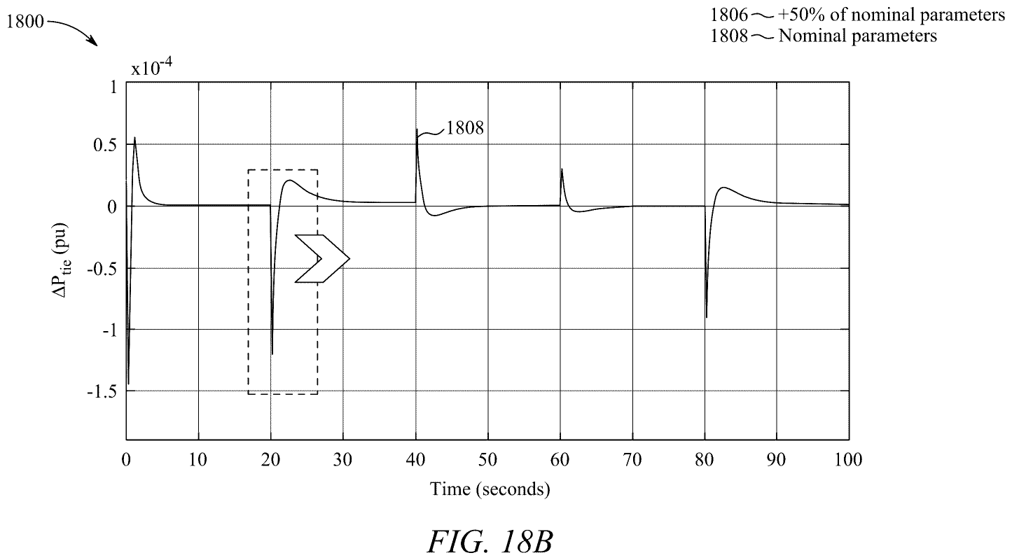

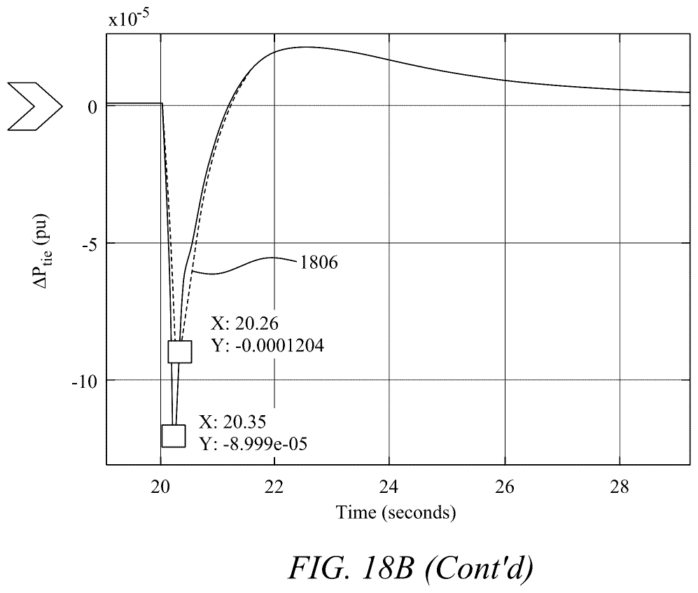

FIG. 18A illustrates frequency deviation curves 1800 of the CFMPC-FOPID based controller 104 for area-2 under uncertainty in the system parameters at −50% variation of parameter. A plotline 1802 represents an application of −50% variation in the nominal parameter of the CFMPC-FOPID based controller 104 and a plotline 1804 represents a nominal parameters. It was observed that the nominal settling time of frequency was again close to 1.29 sec in area 2. It is evident from the response that the CFMPC-FOPID based controller 104 performs efficiently.

FIG. 18B illustrates tie-line power response curves of the CFMPC-FOPID based controller 104 under uncertainty in the system parameters at −50% variation of parameter. A plotline 1806 represents an application of −50% variation in the nominal parameter of the CFMPC-FOPID based controller 104 and a plotline 1808 represents a nominal parameters. A magnified view of the tie-line power response of the CFMPC-FOPID based controller 104 is also shown. It is evident from the response that the CFMPC-FOPID based controller 104 performs efficiently.

Table 6 provides a system parameter variation analysis under uncertainty in the system parameters.

TABLE 6
System parameter variation analysis

| | Area-1 | | | Area-2 | | | Tie-line (MW · pu) | | | |
|---|---|---|---|---|---|---|---|---|---|---|
| | OS | US | Time | OS | US | Time | OS (pu) | US (pu) | Time | |
| Controllers | (Hz) | (Hz) | (s) | (Hz) | (Hz) | (s) | 10⁻⁵ | 10⁻⁵ | (s) | ITAE |
| Disclosure | 0.0010 [symbol] | 0.00791 | 1.1 | 0.00218 | 0.00762 | 1.29 | 3.18 | 8.99 | 10 | 0.0021 |
| Disclosure | 0.0038 [symbol] | 0.00975 | 1.1 | 0.00548 | 0.00947 | 1.29 | 3.19 | 17.6 | 10 | 0.0048 |
| (+50%) | | | | | | | | | | |
| Disclosure | 0 | 0.0051 | 0.438 | 0 | 0.00529 | 1.03 | 3.18 | 12.02 | 10 | 0.0018 |
| (−50%) | | | | | | | | | | |

[symbol]

indicates data missing or illegible when filed

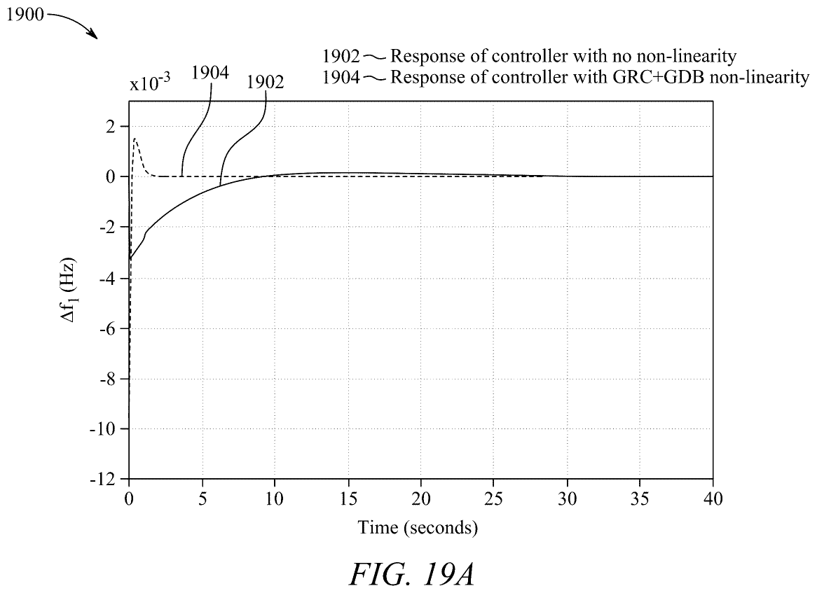

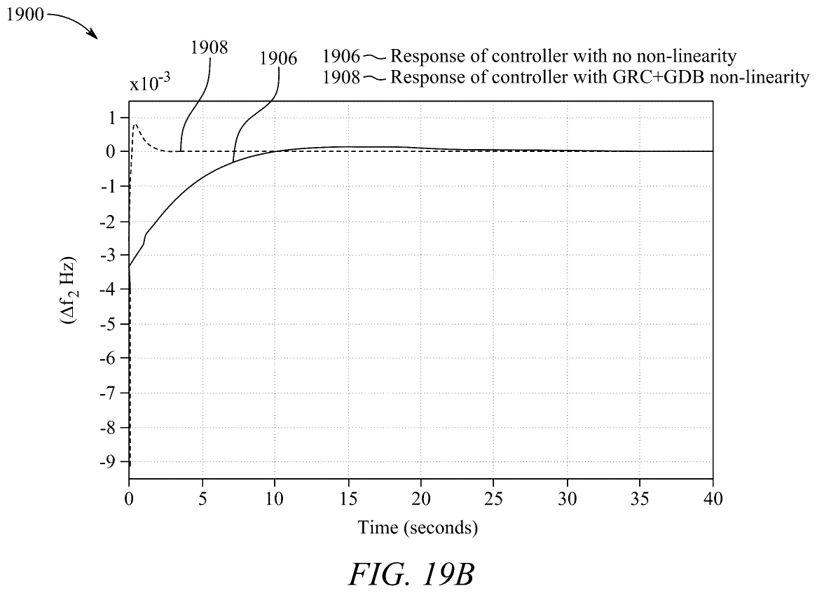

FIG. 19A illustrates nonlinearities and sensitivity response analysis curves 1900 of the CFMPC-FOPID based controller 104 in a first area. The dead band of the speed governor has a significant impact on the efficiency of the power system. The analyzed system becomes nonlinear after the governor dead band (GDB) is incorporated into it. Before a shift in valve position triggers an oscillatory response in the system, the GDB slows things down. In the investigation of the response of the CFMPC-FOPID based controller 104, the backlash nonlinearity is set to 0.05% for the thermal power system. The generation rate constraint (GRC) restricts the power generation when it reaches the maximum value. During designing of the thermal power system, the GRC is set at value 0:002puMW sec. A plotline 1902 shows a response of the CFMPC-FOPID based controller 104 with no-non-linearity, whereas a plotline 1904 shows a response of the CFMPC-FOPID based controller 104 with GRC and GDB non-linearity.

FIG. 19B illustrates nonlinearities and sensitivity response analysis curves of the CFMPC-FOPID based controller 104 in a second area. A plotline 1906 shows a response of the CFMPC-FOPID based controller 104 with no-non-linearity in the second area, whereas a plotline 1908 shows a response of the CFMPC-FOPID based controller 104 with GRC and GDB non-linearity in the second area.

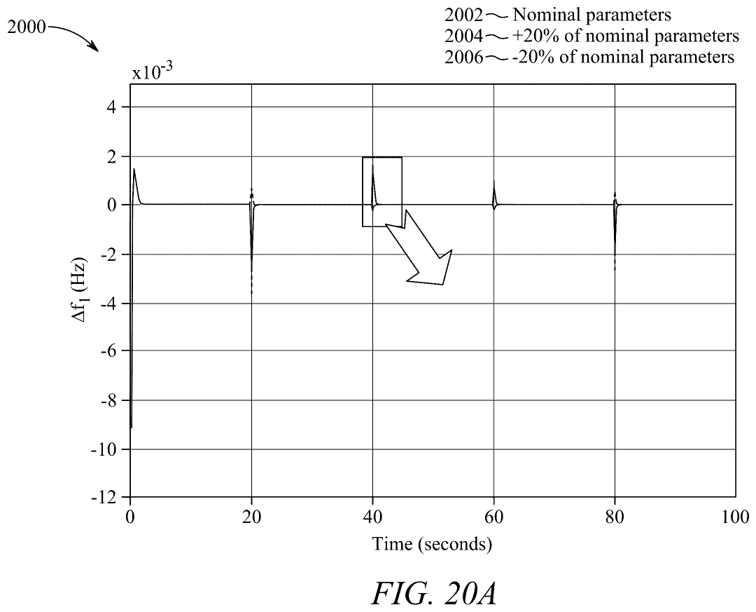

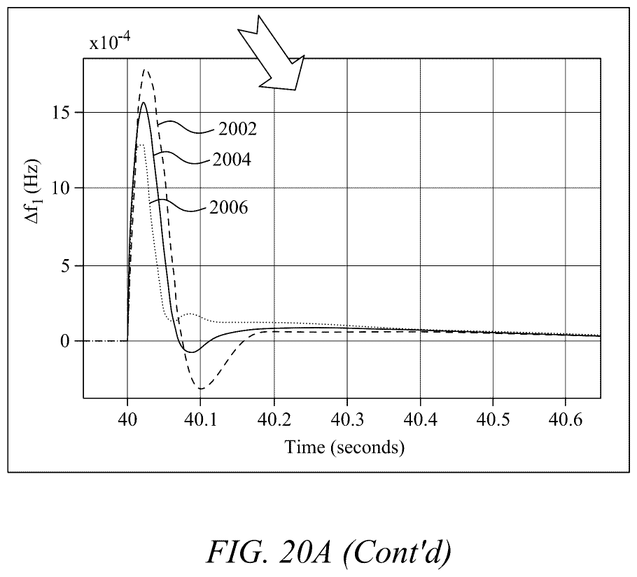

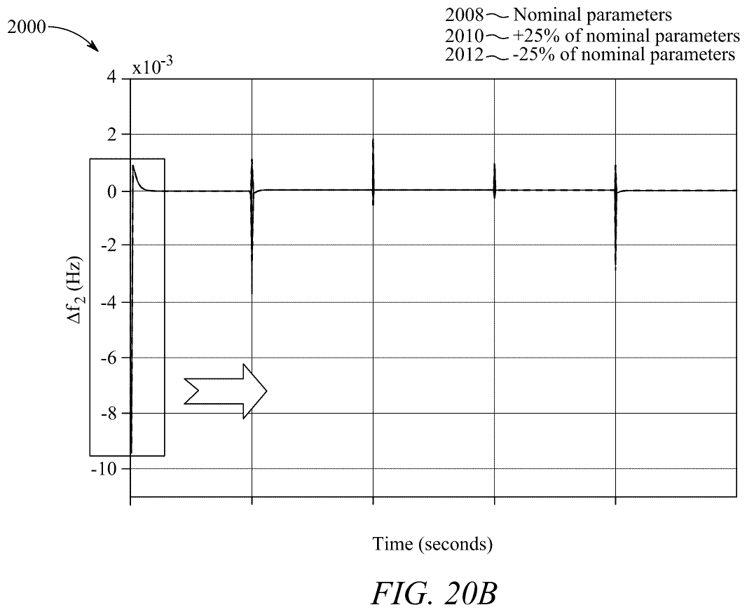

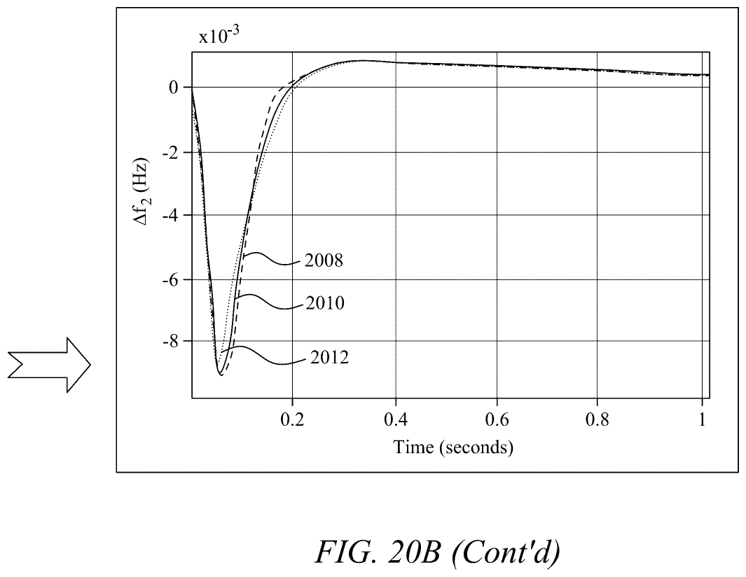

FIG. 20A illustrates a sensitivity response analysis curves 2000 for CFMPC-FOPID based controller 104 in a first area to verify the robustness of the CFMPC-FOPID based controller 104. The system parameter deviations are applied with ±20% change in the nominal parameters of the power system. As such, a plotline 2002, a plotline 2004 and a plotline 2006 show a nominal parameter variation, +20% parameter variation in the nominal parameter and −20% parameter variation in the nominal parameter, respectively. The magnified view is also shown. It is clear from the plotlines that the CFMPC-FOPID based controller 104 efficiently perform even in the ±20% parameter variation.

FIG. 20B illustrates sensitivity response analysis curves for CFMPC-FOPID based controller 104 in a second area to verify the robustness of the CFMPC-FOPID based controller 104, according to an embodiment. The system parameter deviations are applied with ±25% change in the nominal parameters of the power system. As such, a plotline 2008, a 2010 and a plotline 2012 shows a nominal parameter variation, +25% parameter variation in the nominal parameter and −25% parameter variation in the nominal parameter, respectively. The magnified view is also shown. It is clear from the plotlines that the CFMPC-FOPID based controller 104 efficiently perform even in the ±25% parameter variation.

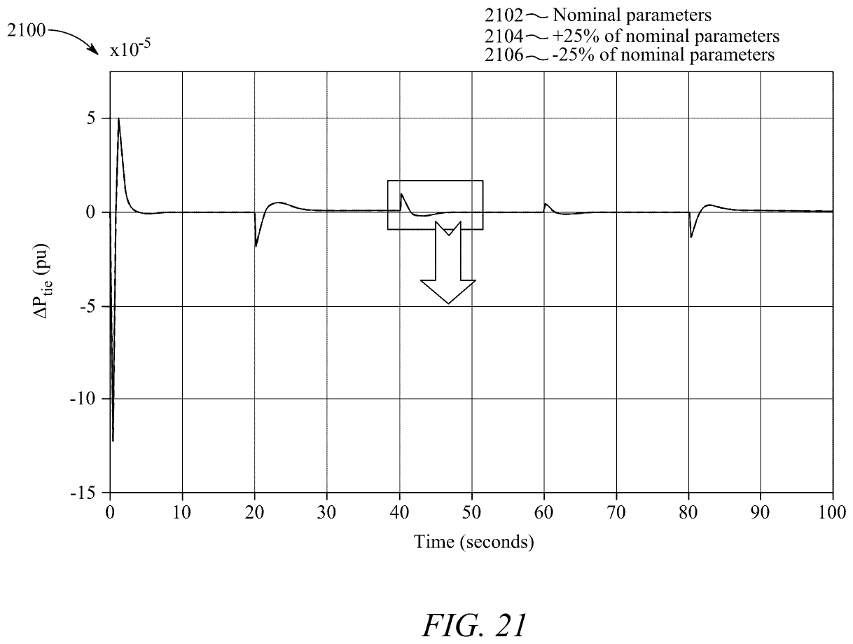

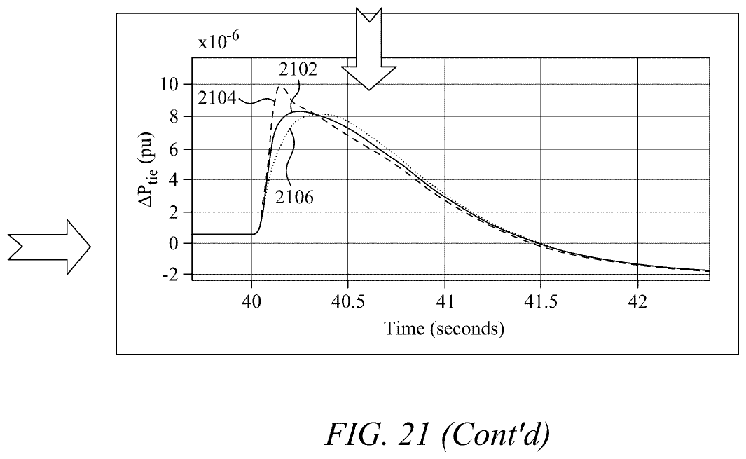

FIG. 21 illustrates a sensitivity response analysis curves 2100 for the tie-line to verify the robustness of the CFMPC-FOPID based controller 104, according to an embodiment. The system parameter deviations are applied with ±25% change in the nominal parameters of the power system. As such, a plotline 2102, a plotline 2104 and a plotline 2062 shows a nominal parameter variation, +25% parameter variation in the nominal parameter and −25% parameter variation in the nominal parameter, respectively. The magnified view is also shown. It is clear from the plotlines that the CFMPC-FOPID based controller 104 efficiently perform even in the ±25% parameter variation.

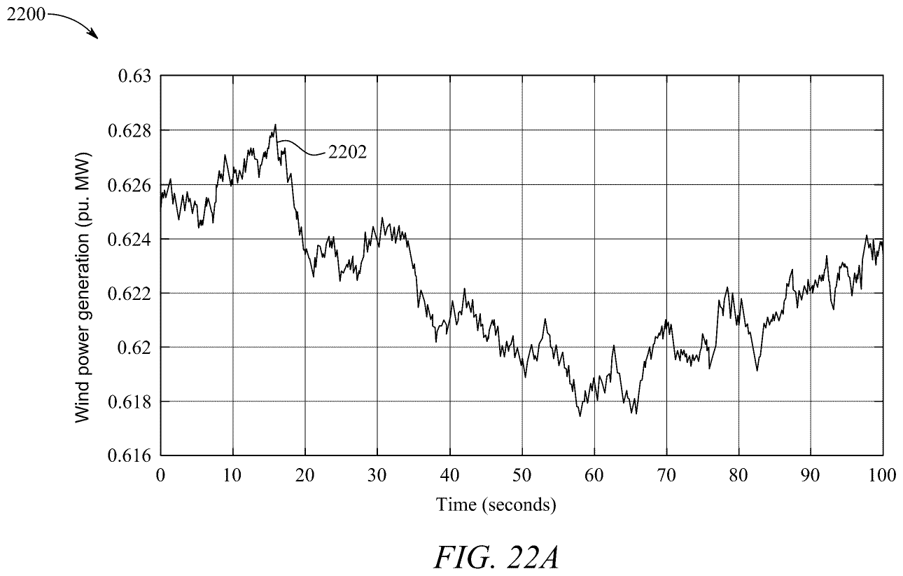

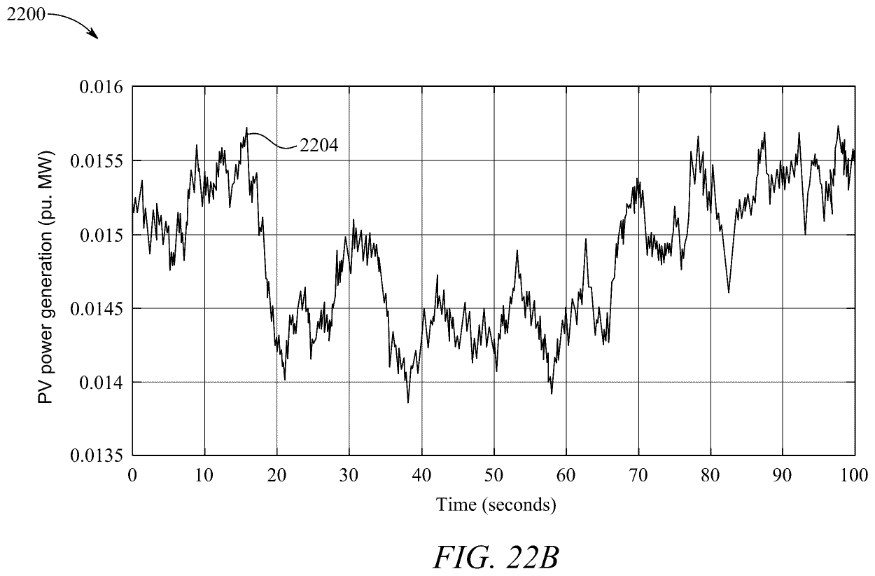

FIG. 22A illustrates a generation response of the wind power output curve 2200. Since the output power from the wind system is intermittent in nature, a fluctuating power is obtained from the wind system. A plotline 2202 shows the fluctuating output from the wind system used in the present disclosure.

FIG. 22B illustrates a generation response of the PV system output curve. Since the output power from the PV system is also intermittent in nature, a fluctuating power is obtained from the PV system. A plotline 2204 shows the fluctuating output from the PV system used in the current disclosure.

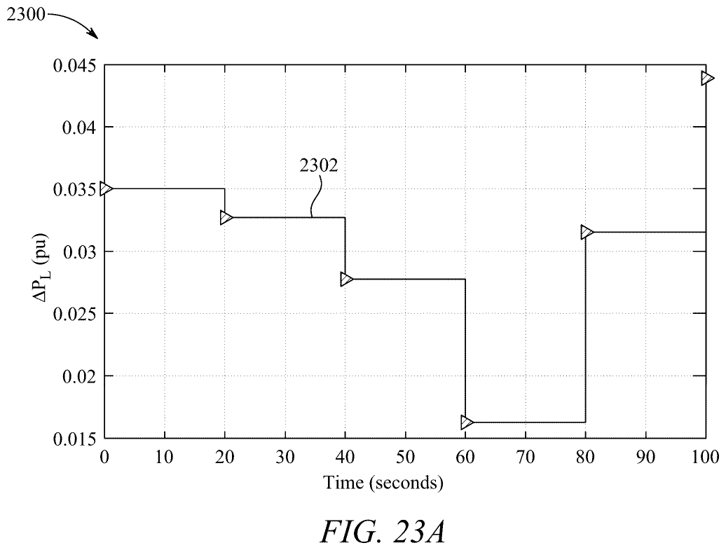

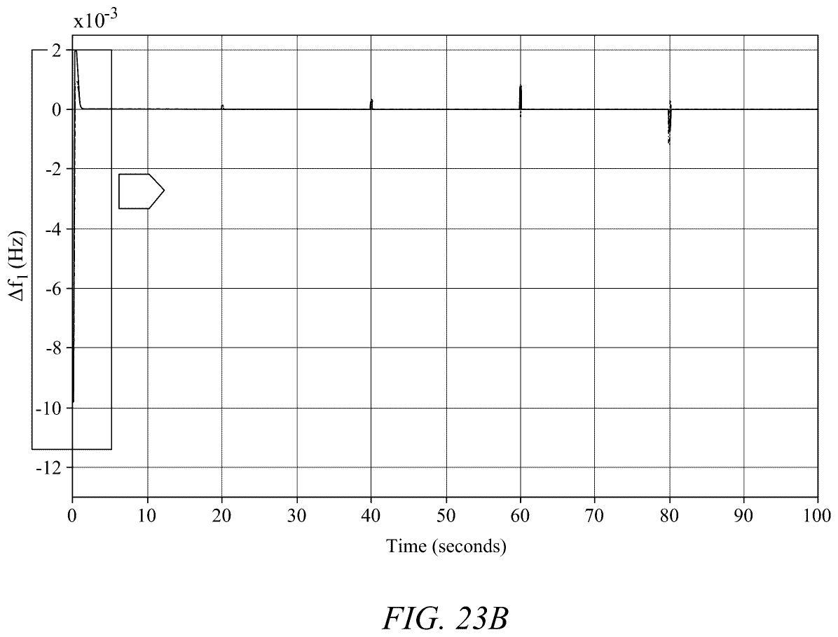

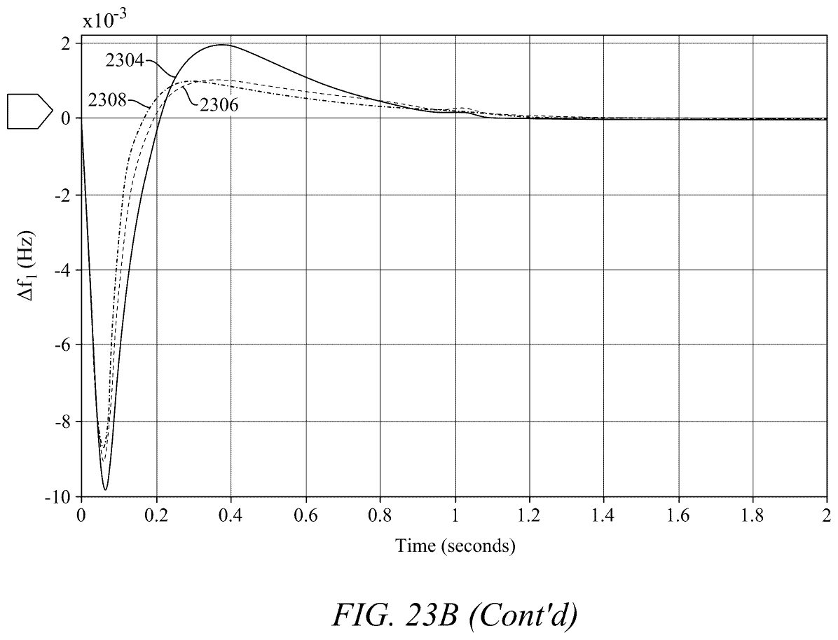

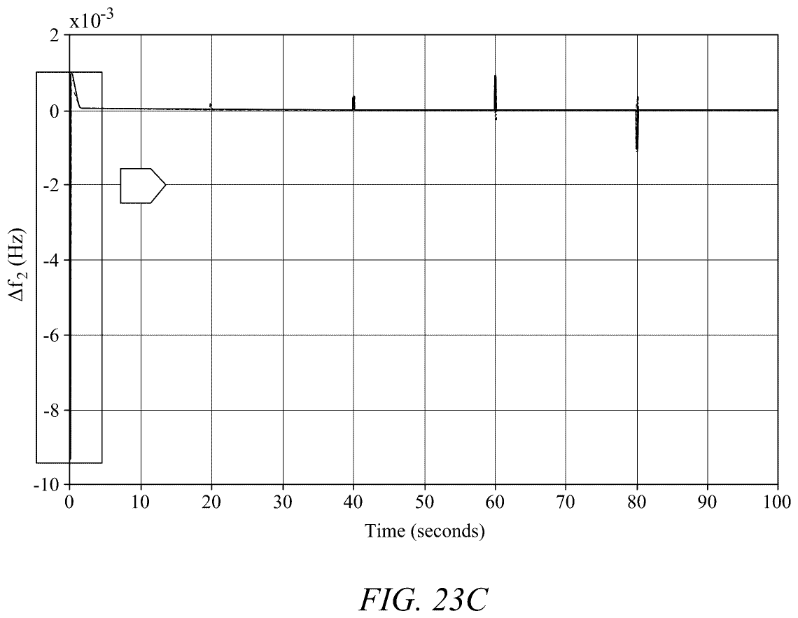

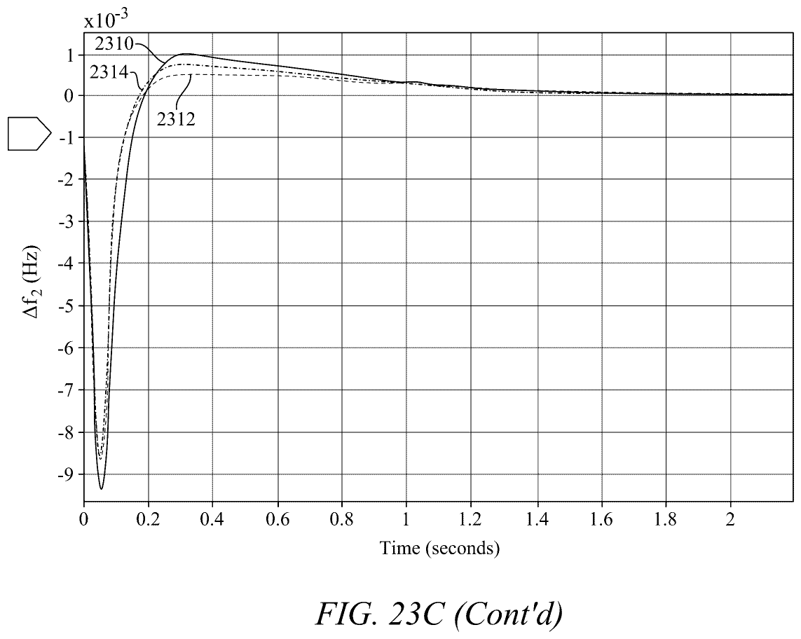

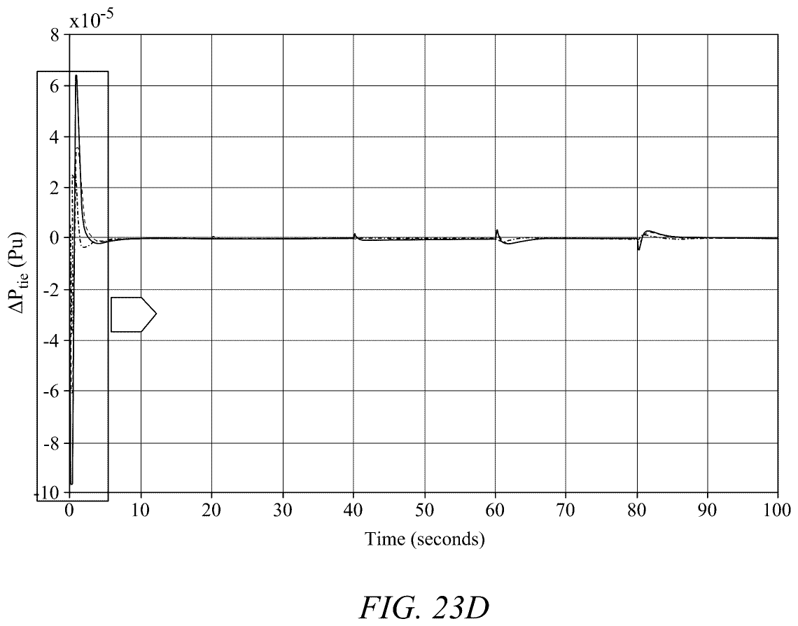

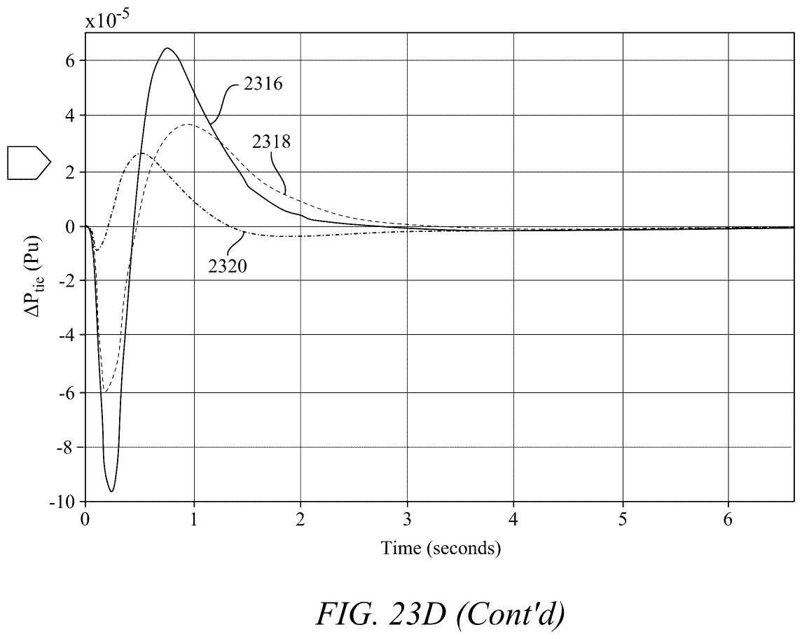

FIG. 23A illustrates a load pattern generation curve 2300 in an AGC-deregulated environment, according to an embodiment. A plotline 2302 shows a load pattern curve from the when renewable power sources are acting in the system.

FIG. 23B illustrates an overall impact analysis of the renewable source into the power system and the performance of the CFMPC-FOPID based controller 104 in a first area in an AGC-deregulated environment. A plotline 2304 shows frequency deviation in the first area when a PV system, a wind power system as well as the thermal system are operating. A plotline 2306 shows frequency deviation in the first area when a wind power system as well as the thermal system are operating together. A plotline 2308 shows frequency deviation in the first area when a PV system and a thermal system are operating.

FIG. 23C illustrates an overall impact analysis of the renewable source into the power system and the performance of the CFMPC-FOPID based controller 104 in a second area in an AGC-deregulated environment, according to an embodiment. A plotline 2310 shows the frequency deviation in the first area when a PV system, a wind power system as well as the thermal system are operating. A plotline 2312 shows frequency deviation in the first area when a wind power system as well as the thermal system are operating. A plotline 2314 shows frequency deviation in the first area when a PV system and a thermal system are operating.

FIG. 23D illustrates an overall impact analysis of the renewable source over the tie-line power pattern in an AGC-deregulated environment, according to an embodiment. A plotline 2316 shows a tie-line power pattern when a PV system, a wind power system as well as the thermal system are operating. A plotline 2318 shows a tie-line power pattern when a wind power system and the thermal system are operating. A plotline 2320 shows a tie-line power pattern when a PV system and a thermal system are operating.

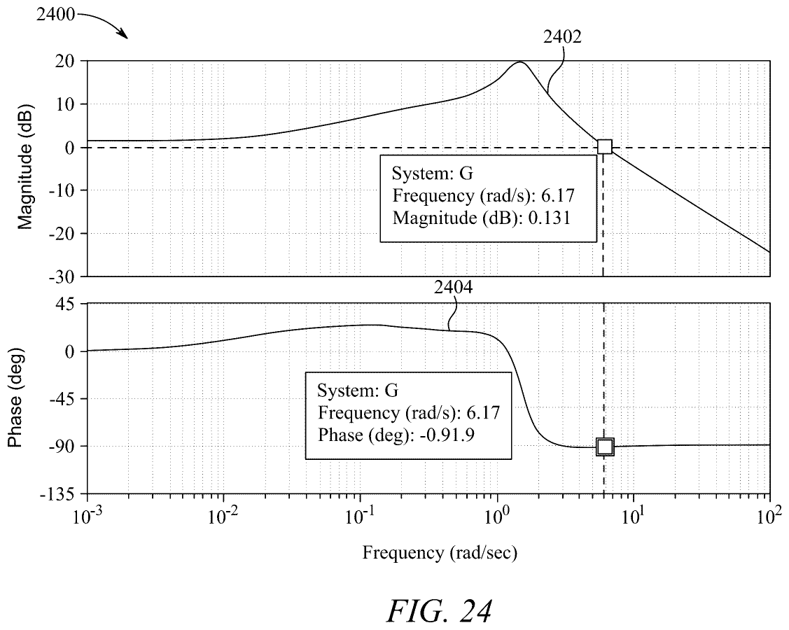

FIG. 24 illustrates power system stability response curves 2400 with the CFMPC-FOPID based controller 104, according to an embodiment. A plotline 2402 shows a magnitude response curve of the CFMPC-FOPID based controller 104 in dB scale. A plotline 2404 shows a phase response curve of the CFMPC-FOPID based controller 104 in degree scale. Collectively, the magnitude and the phase response curve illustrates a bode plotline curve of the CFMPC-FOPID based controller 104. From the bode plotline, it is conspicuous that the overall system remains stable under the CFMPC-FOPID based controller 104.

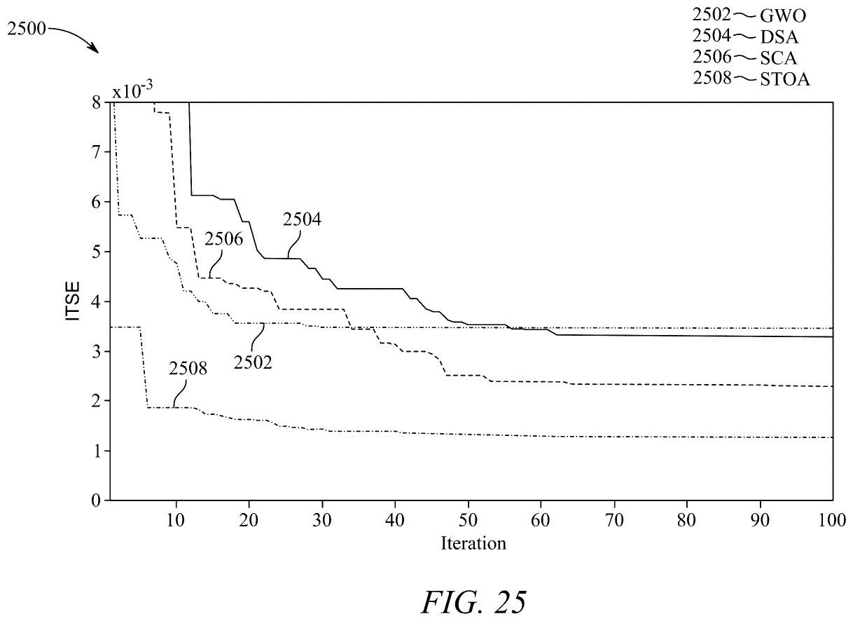

FIG. 25 illustrates a comparison of convergence analysis curves 2500 with the CFMPC-FOPID based controller 104, according to an embodiment. A plotline 2502 shows an ITSE pattern for a GWO based controller well known in the prior art. A plotline 2504 shows an ITSE pattern for a DSA based controller. A plotline 2506 shows an ITSE pattern for a SCA based controller. A plotline 2508 shows an ITSE pattern for the CFMPC-FOPID based controller 104. From the comparative analysis considering the convergence curves of all the controller and the CFMPC-FOPID based controller 104, it is clear that the CFMPC-FOPID based controller 104 converges more quickly than controllers known in the art.

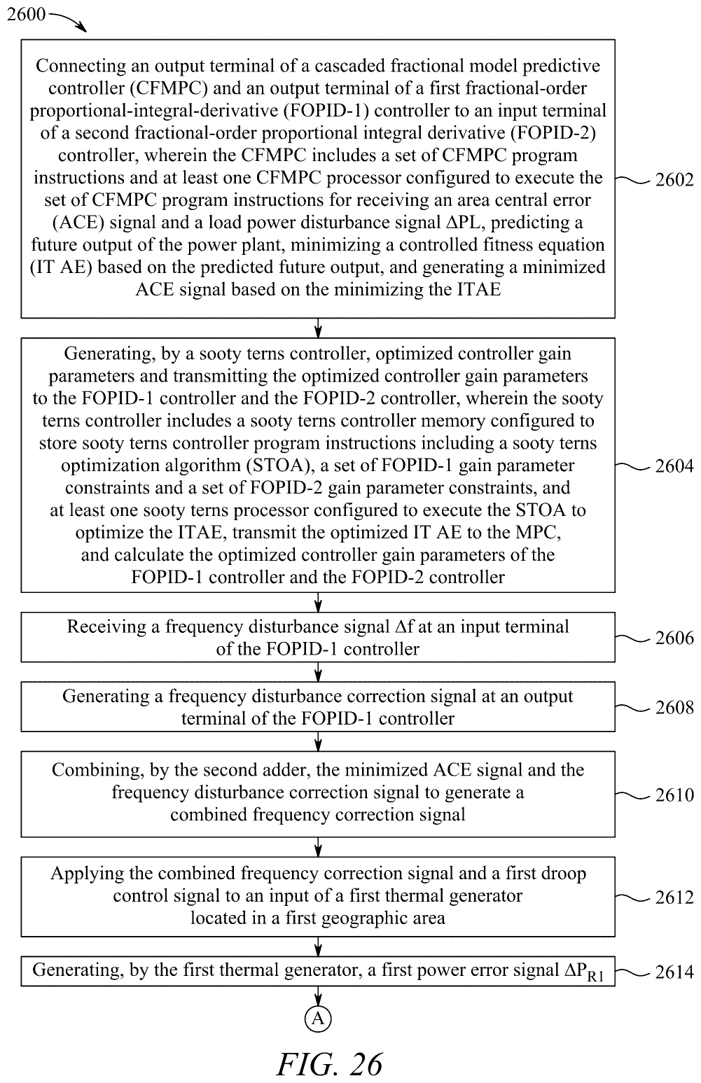

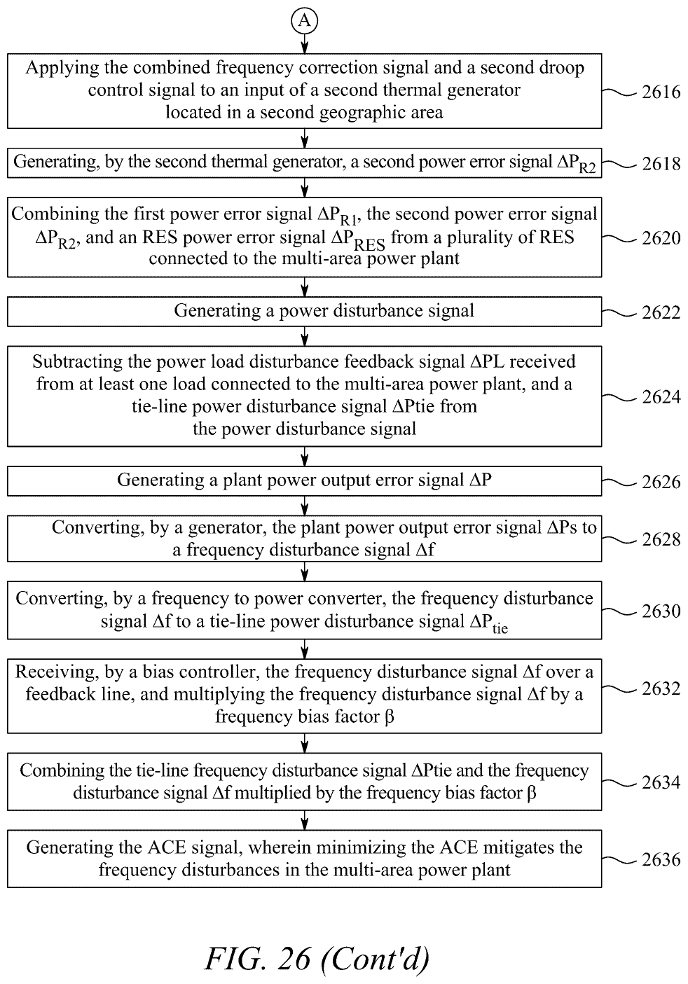

FIG. 26 illustrates a flowchart of a method 2600 for mitigating frequency disturbances in a multi-area power plant 100, according to an embodiment. The multi-area power plant 100 includes a plurality of thermal energy generators 100-1 and 100-2 and a plurality of renewable energy sources (RES) 130, 132. The method 2600 is described in conjunction with FIGS. 1-4 and plurality of experiment observation in FIGS. 8-25. Various steps of the method 2600 are included through blocks in FIG. 26. One or more blocks may be combined or eliminated to achieve method 2600 for mitigating frequency disturbances in the multi-area power plant 100, without departing from the scope of the present disclosure. Further, the method 2600 is described with reference to multi-area power plant 100 as disclosed in FIG. 1. However, the method 2600 is equally applicable to the method of mitigating frequency disturbances in a two-area hybrid power control system 500, as disclosed in FIG. 5 and FIG. 6.

At step 2602, the method 2600 includes connecting, by an adder 406, an output terminal of a cascaded fractional model predictive controller (CFMPC) (or simply a CFMPC processor 402) and an output terminal of a first fractional-order proportional-integral-derivative (FOPID-1) controller 404 to an input terminal of a second fractional-order proportional integral derivative (FOPID-2) controller 408. The CFMPC processor 402 includes a set of CFMPC program instructions and at least one CFMPC processor configured to execute the set of CFMPC program instructions for receiving an area central error (ACEᵢ) signal and a load power disturbance signal ΔP_{L}, predicting a future output of the power plant or thermal energy generators 100-1 and 100-2, minimizing a controlled fitness equation (ITAE) based on the predicted future output, and generating a minimized ACE signal based on the minimizing the ITAE.

At step 2604, the method 2600 includes generating, by a sooty terns controller 410, optimized controller gain parameters and transmitting the optimized controller gain parameters to the FOPID-1 controller 404 and the FOPID-2 controller 408. The sooty terns controller 410 includes a sooty terns controller memory configured to store sooty terns controller program instructions including a sooty terns optimization algorithm (STOA), a set of FOPID-1 gain parameter constraints and a set of FOPID-2 gain parameter constraints, and at least one sooty terns controller configured to execute the STOA to optimize the ITAE, transmit the optimized ITAE to the MPC 402, and calculate the optimized controller gain parameters of the FOPID-1 controller 404 and the FOPID-2 controller 408;

At step 2606, the method 2600 includes receiving a frequency disturbance signal Δf at an input terminal of the FOPID-1 controller 404. The frequency disturbance signal is generated based upon disturbance in the load variation connected to the multi-area power plant 100 or due to intermittent nature of the renewable energy sources such as PV array 130 or wind system 132.

At step 2608, the method 2600 includes generating a frequency disturbance correction signal at an output terminal of the FOPID-1 controller 404. The frequency disturbance correction signal is generated based upon the frequency disturbance signal Δf and the transfer function of the FOPID-1 controller 404 defined in the memory (not shown) of the hybrid controller 400.

At step 2610, the method 2600 includes combining, by the adder 406, the minimized ACE signal and the frequency disturbance correction signal to generate a combined frequency correction signal. The minimized ACE signal is generated at the output of the CFMPC controller or the CFMPC processor 402. The combined frequency correction signal is generated at the output of the adder 406.

At step 2612, the method 2600 includes applying the combined frequency correction signal and a first droop control signal to an input of a first thermal energy generator 100-1 located in a first geographic area. The combined frequency correction signal is generated at the output terminal of the adder 406. The first droop control signal is generated by multiplying the frequency disturbance signal Δf with a first droop controller 112 having droop value of 1/R1.

At step 2614, the method 2600 includes generating, by the first thermal energy generator 100-1, a first power error signal ΔP_{R}_{₁}. The first power error signal ΔP_{R}_{₁} is generated at the output of a first reheater 118.

At step 2616, the method 2600 includes applying the combined frequency correction signal and a second droop control signal to an input of a second thermal energy generator 100-2 located in a second geographic area. The second droop control signal is generated by multiplying the frequency disturbance signal Δf with a second droop controller 110 having droop value of 1/R2.

At step 2618, the method 2600 includes, generating, by the second thermal energy generator 100-2, a second power error signal ΔPR₂. The first power error signal ΔP_{R2} is generated at the output of a second reheater 124.

At step 2620, the method 2600 includes, combining, by a third adder 128, the first power error signal ΔP_{R}_{₁}, the second power error signal ΔP_{R2}, an RES power error signal ΔP_{RES} from a plurality of RES 130, 132 connected to the multi-area power plant or thermal energy generators 100-1 and 100-2.

At step 2622, the method 2600 includes, generating, by the third adder 128, a power disturbance signal.

At step 2624, the method 2600 includes, subtracting, by a third subtractor 136, the power load disturbance feedback signal ΔP_{L} received from at least one load connected to the multi-area power plant or thermal energy generators 100-1 or 100-2, and a tie-line power disturbance signal ΔPₜᵢₑ from the power disturbance signal.

At step 2626, the method 2600 includes, generating, by the third subtractor 136, a plant power output error signal ΔPₛ.

At step 2628, the method 2600 includes, converting, by a generator 138, the plant power output error signal ΔPₛ to a frequency disturbance signal Δfᵢ. In an embodiment, the generator is a output generator 138. The input terminal of the output generator 138 is connected with the output terminal of the third subtractor 136.

At step 2630, the method 2600 includes, converting, by a frequency to power converter 146, the frequency disturbance signal Δf to a tie-line power disturbance signal ΔPtie. The ΔPtie is provided as an input to the third subtractor 136 as well as a first adder 102.

At step 2632, the method 2600 includes, receiving, by a frequency bias factor βᵢ controller 142, the frequency disturbance signal Δf over a feedback connection line 144, and multiplying the frequency disturbance signal Δf by a frequency bias factor β.

At step 2634, the method 2600 includes, combining, by the first adder 102, the tie-line frequency disturbance signal ΔPₜᵢₑ and the frequency disturbance signal Δf multiplied by the frequency bias factor μ.

At step 2636, the method 2600 includes, generating, by the first adder 102, the ACE signal. Minimizing the ACE mitigates the frequency disturbances in the multi-area power plant or thermal energy generators 100-1 and 100-2.

Embodiments of the present disclosure are illustrated with respect to FIG. 1 to FIG. 7. A first embodiment of a hybrid control system for mitigating frequency disturbances in a multi-area power plant 100 is described in FIG. 1 to FIG. 4. The multi-area power plant 100 includes a first thermal energy generator 100-1 located in a first geographic area, a second thermal energy generator 100-2 located in a second geographic area. An output terminal of the second thermal energy generator is connected to an output terminal of the first thermal energy generator by a tie-line 140. The multi-area power plant 100 further includes a plurality of renewable energy sources (RES) 130, 132 having output terminals connected to the tie-line 140, a plurality of loads connected to the tie-line 140, a first adder 102 configured to receive a frequency disturbance value Δfᵢ multiplied by a frequency bias factor βᵢ and to receive a tie-line power disturbance signal ΔP_{tie,i} from the tie-line 140 over a measurement interval i, add the frequency disturbance value Δfᵢ multiplied by the frequency bias factor βᵢ to the tie-line power disturbance signal ΔP_{tie,i} and generate an area central error (ACE) signal, a cascaded fractional model predictive controller (CFMPC) 104 including, a set of CFMPC program instructions and at least one CFMPC processor configured to execute the set of CFMPC program instructions to receive the area central error (ACE) signal and a load power disturbance signal ΔP_{L}, predict a future output of the power plant, minimize a controlled fitness equation (ITAE) based on the predicted future output, and generate a minimized ACE signal based on the minimizing the ITAE. The cascaded fractional model predictive controller (CFMPC) 104 further includes a first fractional-order proportional-integral-derivative (FOPID-1) controller 400 configured to receive the frequency disturbance value Δfᵢ and generate a frequency disturbance correction signal based on a set of FOPID-1 gain parameters and the frequency disturbance value Δfᵢ, an adder 406 configured to add a negative of the minimized ACE signal to a negative of the frequency disturbance correction signal and generate a combined frequency correction signal, a second fractional-order proportional integral derivative (FOPID-2) controller 408 configured to receive the combined frequency correction signal from the adder 406 and generate a frequency error correction signal, a sooty terns controller 410 configured to generate optimized controller gain parameters and transmit the optimized controller gain parameters to the FOPID-1 controller 404 and the FOPID-2 controller 408. The multi-area power plant 100 further includes a first droop controller 112 configured to receive the frequency disturbance value Δfᵢ, calculate a first droop value 1/R₁, multiply the frequency disturbance value Δfᵢ by the first droop value 1/R₁, and generate a first droop control signal, a first subtractor 108 configured to receive the frequency error correction signal and the first droop control signal, subtract the first droop control signal from the frequency error correction signal, and transmit a first frequency error difference signal to the first thermal energy generator. The first thermal energy generator 100-1 is configured to receive the first frequency error difference signal and generate a first power error signal ΔP_{R}_{₁}. The multi-area power plant 100 further includes a second droop controller 110 configured to receive the frequency disturbance value Δfᵢ, calculate a second droop value 1/R₂, multiply the frequency disturbance value Δfᵢ by the second droop value 1/R₂, and generate a second droop control signal, a second subtractor 106 configured to receive the frequency error signal and the second droop control signal, subtract the second droop control signal from the frequency error correction signal and transmit a second frequency error difference signal to the second thermal energy generator. The second thermal energy generator 100-2 is configured to receive the second frequency error difference signal and generate a second power error signal ΔP_{R}_{₂}. The multi-area power plant 100 further includes a third adder 128 configured to add the first power error signal ΔP_{R}_{₁}, the second power error signal ΔP_{R}_{₂}, and an RES power error signal ΔP_{RES}, and generate a plant power error signal ΔPₛ, a third subtractor 136 configured to receive the plant power error signal ΔPₛ and subtract the load power disturbance signal ΔP_{L}_{ᵢ} and the tie-line power disturbance signal ΔP_{tie,i} from the plant power error signal ΔPₛ and generate a plant power output error signal, an output generator 138 configured to receive the plant power output error signal and generate the frequency disturbance value Δfᵢ; and a feedback connection line 144 configured to transmit the frequency disturbance value Δfᵢ to the first droop controller 112, the second droop controller 110 and the first adder 102.

In an aspect, the plurality of renewable energy sources (RES) 130, 132 includes at least one photovoltaic array and at least one wind turbine.

In an aspect, the sooty terns controller 410 includes a sooty terns controller memory configured to store sooty terns controller program instructions including a sooty terns optimization algorithm (STOA), a set of FOPID-1 gain parameter constraints and a set of FOPID-2 gain parameter constraints, and at least one sooty terns controller configured to execute the STOA to optimize the ITAE, transmit the optimized ITAE to the MPC 402, and calculate the optimized controller gain parameters of the FOPID-1 controller 404 and the FOPID-2 controller 408.

In an aspect, the frequency disturbances of the power plant are regulated by minimizing the ACE.

In an aspect, the first thermal energy generator 100-1 comprises: a first governor 114 having a dead band, wherein the first governor 114 is configured to receive the first droop control signal and output a power change signal ΔP_{g}_{₁}; a first turbine having a rotor 116, wherein the power change signal ΔP_{g}_{₁} is configured to modify a speed of the rotor; and a first reheater 118, wherein the first power error signal ΔP_{R}_{₁} is output from the first reheater 118.

In an aspect, the second thermal energy generator 100-2 comprises: a second governor having a dead band 120, wherein the second governor 120 is configured to receive the second droop control signal and output a power change signal ΔP_{g}_{₂}; a second turbine having a rotor 122, wherein the power change signal ΔP_{g}_{₂} is configured to modify a speed of the rotor; and a second reheater 124, wherein the second power error signal ΔP_{R}_{₂} is output from the second reheater 124.

In an aspect, the set of FOPID-1 gain parameter constraints include a first integrator fractional parameter constraint λ₁ and a first differentiator fractional parameter constraint μ₁, where 0<λ₁<1 and 0<μ₁<1; and the set of FOPID-2 gain parameter constraints include a second integrator fractional parameter constraint λ₂ and a second differentiator fractional parameter constraint μ₂, where 0<λ₂<1 and 0<μ₂<1.

In an aspect, the sooty terns controller 410 is configured to: optimize the first integrator fractional parameter constraint λ₁ and the first differentiator fractional parameter constraint μ₁ and transmit the optimized first integrator fractional parameter constraint λ₁ and the optimized first differentiator fractional parameter constraint μ₁ to the FOPID-1 controller 404; and optimize the second integrator fractional parameter constraint λ₂ and the second differentiator fractional parameter constraint μ₂ and transmit the optimized second integrator fractional parameter constraint λ₂ and the optimized second differentiator fractional parameter constraint μ₂ to the FOPID-2 controller 408.

In an aspect, a transfer function of the FOPID-1 controller 404 is given by:

$${G}_{1} ( s ) = {K}_{{p}_{1}} + {K}_{{I}_{1}} / {s}^{{λ}_{1}} + {K}_{{D}_{1}} {s}^{{μ}_{1}} ;$$

and
a transfer function of the FOPID-2 controller 408 is given by:

$${G}_{2} ( s ) = {K}_{{p}_{2}} + {K}_{{I}_{2}} / {s}^{{λ}_{2}} + {K}_{{D}_{2}} {s}^{μ 2} ,$$

where s is a complex frequency value of a Laplace transform.

In an aspect, the ITAE is given by:

$$ITAE = {\int }_{0}^{∞} t ( \vert Δ {f}_{i} \vert + \vert Δ {P}_{tie , i} \vert ) dt$$

where t is time.

In a second embodiment illustrated in FIGS. 5, 6A and 6B, a two-area hybrid power control system 500 for mitigating frequency disturbances is described. The two-area hybrid power control system 500 includes a first power system 504 located in a first geographic area, a second power system 526 located in a second geographic area, a tie-line 552 configured to connect an output terminal of the first power system with an output terminal of the second power system, The first power system 504 includes a first controller (CSMPC-FOPID-1) 502, a first thermal energy generator 504 connected in series with the CSMPC-FOPID-1 502. The first thermal energy generator 504 is configured to generate a first thermal generator power disturbance signal ΔP_{R}_{₁}. The first power system 504 further includes a first plurality of renewable energy resources (RES-1) 506, 510. Each RES-1 has an RES-1 output terminal configured to generate a first RES-1 power disturbance signal ΔPᵣₑₛ_{₁}. The first power system 504 further includes a first load configured to generate a first load power disturbance signal ΔP_{L}_{₁} at a load output terminal, a first adder 502 connected to an input terminal of the CSMPC-FOPID-1 502. The first adder 520 is configured to generate a first area central error (ACE-1) signal. The first power system 504 further includes a second adder 512 connected to receive the first thermal generator power disturbance signal ΔP_{R}_{₁}, the first RES-1 power disturbance signal ΔPᵣₑₛ_{₁}, the load power disturbance signal ΔP_{L}_{₁}, and a tie-line power disturbance signal ΔPₜᵢₑ from the tie-line 552, sum the first thermal generator power disturbance signal ΔP_{R}_{₁} with the first RES-1 power disturbance signal ΔPᵣₑₛ_{₁}, subtract the first load power disturbance signal ΔP_{L}_{₁}, subtract the tie-line power disturbance signal ΔPₜᵢₑ, and generate a first geographic area power disturbance signal ΔPₛ_{₁}. The first power system 504 further includes a first output generator 514 configured to receive the first geographic area power disturbance signal ΔPₛ_{₁} convert the first geographic area power disturbance signal ΔPₛ_{₁} to a first geographic area frequency disturbance value Δfᵢ, and output the first geographic area frequency disturbance value Δfᵢ at a first output generator output terminal connected to the tie-line and a first feedback connection line 554 connected to the tie-line 552. The first feedback connection line 554 is configured to transmit the first geographic area frequency disturbance value Δfᵢ to an input terminal of the first adder 520. The second power system 526 includes a second controller (CSMPC-FOPID-2) 524 and a second thermal energy generator 526 connected in series with the CSMPC-FOPID-2 524. The second thermal energy generator 526 is configured to generate a second thermal generator power disturbance signal ΔP_{R}_{₂}. The second power system 526 further includes a second plurality of renewable energy resources (RES-2) 528, 532. Each RES-2 has an RES-2 output terminal configured to generate a second RES-2 power disturbance signal ΔPᵣₑₛ_{₂}. The second power system 526 further includes a second load configured to generate a second load power disturbance signal ΔP_{L}_{₂} from a load output terminal, a third adder 542 connected to an input terminal of the CSMPC-FOPID-2 524. The third adder 542 is configured to generate a second area central error (ACE-2) signal. The second power system 526 further includes an fourth adder 534 connected to receive the second thermal generator power disturbance signal ΔP_{R}_{₂}, the second RES-2 power disturbance signal ΔPᵣₑₛ_{₂}, the load power disturbance signal ΔP_{L}_{₂}, and the tie-line power disturbance signal ΔPₜᵢₑ, sum the second thermal generator power disturbance signal ΔP_{R}_{₂} with the second RES-2 power disturbance signal ΔPᵣₑₛ_{₂}, subtract the second load power disturbance signal ΔP_{L}_{₂}, subtract the tie-line power disturbance signal ΔPₜᵢₑ, and generate a second geographic area power disturbance signal ΔPₛ_{₂}. The second power system 526 further includes a second output generator 536 configured to receive the second geographic area power disturbance signal ΔPₛ_{₂} convert the second geographic area power disturbance signal ΔPₛ_{₂} to a second geographic area frequency disturbance value Δf₂, and output the second geographic area frequency disturbance value Δf₂ at a second output generator output terminal connected to the tie-line, and a second feedback connection line 556 connected to the tie-line 552. The second feedback connection line 556 is configured to transmit the second geographic area frequency disturbance value Δf₂ to an input terminal of the third adder 542; and
a fifth adder connected to the tie-line, wherein the fifth adder is configured to subtract the second geographic area frequency disturbance value Δf₂ from the first geographic area frequency disturbance value Δfᵢ.

The CSMPC-FOPID-1 502 includes a first cascaded fractional model predictive controller (CFMPC₁) 602-1 including a set of CFMPC₁ program instructions and at least one CFMPC₁ processor configured to execute the set of CFMPC₁ program instructions to receive the ACE-1 signal and the first load power disturbance signal ΔP_{L}_{₁}, predict a future power output of the first power system, minimize a first controlled fitness equation (ITAE₁) based on the predicted future power output of the first power system, and generate a minimized ACE-1 signal based on the minimizing the ITAE₁, a first fractional-order proportional-integral-derivative (FOPID-1) controller 604-1 configured to receive the frequency disturbance value Δfᵢ and generate a first frequency disturbance correction signal based on a set of first FOPID-1 gain parameters and the first frequency disturbance value Δfᵢ, a sixth adder 606-1 configured to add a negative of the minimized ACE-1 signal to a negative of the first frequency disturbance correction signal and generate a first combined frequency correction signal, a second fractional-order proportional integral derivative (FOPID-2) controller 608-1 configured to receive the first combined frequency correction signal from the sixth adder 606-1 and generate a first frequency error correction signal, a first sooty terns controller 610-1 configured to generate a set of first optimized controller gain parameters and transmit the set of first optimized controller gain parameters to the FOPID-1 controller 604-1 and the FOPID-2 controller 608-1. The CSMPC-FOPID-2 524 includes a second cascaded fractional model predictive controller (CFMPC₂) 602-2 including a set of CFMPC₂ program instructions and at least one CFMPC₂ processor configured to execute the set of CFMPC₂ program instructions to receive the ACE-2 signal and the second load power disturbance signal ΔP_{L}_{₂}, predict a future output of the second power system, minimize a second controlled fitness equation (ITAE₂) based on the predicted future output of the second power system, and generate a minimized ACE-2 signal based on the minimizing the ITAE₂, a third fractional-order proportional-integral-derivative (FOPID-3) controller 604-2 configured to receive the second frequency disturbance value Δf₂ and generate a second frequency disturbance correction signal based on a set of FOPID-3 gain parameters and the second frequency disturbance value Δf₂, a seventh adder 606-2 configured to add a negative of the minimized ACE-2 signal to a negative of the second frequency disturbance correction signal and generate a second combined frequency correction signal, a fourth fractional-order proportional integral derivative (FOPID-4) controller 608-2 configured to receive the second combined frequency correction signal from the seventh adder and generate a second frequency error correction signal, a second sooty terns controller 610-2 configured to generate a set of second optimized controller gain parameters and transmit the set of second optimized controller gain parameters to the FOPID-3 controller 604-2 and the FOPID-4 controller 608-2; and a transmission line 558 connected at a first end to the tie-line 552. A first terminal of a second end is connected to a second input terminal of first adder 520 and a second terminal of the second end is connected to a second input terminal of the third adder 542. The transmission line 558 is configured to feed back a combined area tie-line power disturbance value ΔPₜᵢₑ_{_{1,2}} to the first adder 520 and the third adder 542.

In an aspect, the first plurality of renewable energy resources (RES-1) includes at least one photovoltaic array (PV₁) 506 and at least one wind farm (WF₁) 510, and the second plurality of renewable energy resources (RES-2) include at least one photovoltaic array (PV₂) 528 and at least one wind farm (WF₂) 532.

In an aspect, the first sooty terns controller 610-1 includes a first sooty terns controller memory configured to store first sooty terns controller program instructions including a first sooty terns optimization algorithm (STOA-1), a set of FOPID-1 gain parameter constraints and a set of FOPID-2 gain parameter constraints, and at least one first sooty terns controller configured to execute the STOA-1 to optimize the ITAE₁, transmit the optimized ITAE₁ to the CSMPC₁ 602-1, and calculate the first optimized controller gain parameters of the FOPID-1 controller 604-1 and the FOPID-2 controller 608-1; and the second sooty terns controller 610-2 includes a second sooty terns controller memory configured to store second sooty terns controller program instructions including a second sooty terns optimization algorithm (STOA-2), a set of FOPID-3 gain parameter constraints and a set of FOPID-4 gain parameter constraints, and at least one second sooty terns controller configured to execute the STOA-2 to optimize the ITAE₂, transmit the optimized ITAE₂ to the CSMPC₂ 602-2, and calculate the second optimized controller gain parameters of the FOPID-3 controller 604-2 and the FOPID-4 controller 608-2.

In an aspect, the first thermal energy generator 504 comprises a first droop controller 518 configured to receive the frequency disturbance value Δf1 from the first feedback connection line 554, calculate a first droop value 1/R1, multiply the frequency disturbance value Δf1 by the first droop value 1/R1, and generate a first droop control signal; and a first subtractor 522 configured to receive the frequency error correction signal and the first droop control signal, subtract the first droop control signal from the frequency error correction signal, and transmit a first frequency error difference signal to the first thermal energy generator 504.

In an aspect, the second thermal energy generator 526 comprises a second droop controller 540 configured to receive the frequency disturbance value Δf₂ from the second feedback connection line 556, calculate a second droop value 1/R₂, multiply the frequency disturbance value Δf₂ by the second droop value 1/R₂, and generate a second droop control signal; and a second subtractor 544 configured to receive the frequency error correction signal and the second droop control signal, subtract the second droop control signal from the frequency error correction signal, and transmit a second frequency error difference signal to the second thermal energy generator 526.

In an aspect, a first bias controller 516 is connected to the first feedback connection line 554 between the tie-line 552 and the first adder 520. The first bias controller 516 is configured to multiply the first geographic area frequency disturbance value Δfᵢ by a first frequency bias factor β1; and a second bias controller 538 is connected to the second feedback connection line 556 between the tie-line 552 and the third adder 542. The second bias controller 538 is configured to multiply the second geographic area frequency disturbance value Δf₂ by a second frequency bias factor β₂.

In an aspect, the set of FOPID-1 gain parameter constraints include a first integrator fractional parameter constraint λ₁ and a first differentiator fractional parameter constraint μ₁, where 0<λ₁<1 and 0<μ₁<1. The set of FOPID-2 gain parameter constraints include a second integrator fractional parameter constraint λ₂ and a second differentiator fractional parameter constraint μ₂, where 0<λ₂<1 and 0<μ₂<1. The set of FOPID-3 gain parameter constraints include a first integrator fractional parameter constraint λ₃ and a first differentiator fractional parameter constraint μ₃, where 0<λ₃<1 and 0<μ₃<1. The set of FOPID-4 gain parameter constraints include a second integrator fractional parameter constraint λ₄ and a second differentiator fractional parameter constraint W, where 0<λ₄<1 and 0<μ₄<1.

In an aspect, the first sooty terns controller 610-1 is configured to generate the set of first optimized controller gain parameters by optimizing the first integrator fractional parameter constraint λ₁ and the first differentiator fractional parameter constraint μ₁; transmit the optimized first integrator fractional parameter constraint λ₁ and the optimized first differentiator fractional parameter constraint μ₁ to the FOPID-1 controller 604-1; generate the set of second optimized controller gain parameters by optimizing the second integrator fractional parameter constraint λ₂ and the second differentiator fractional parameter constraint μ₂; and transmit the optimized second integrator fractional parameter constraint λ₂ and the optimized second differentiator fractional parameter constraint λ₂ to the FOPID-2 controller 608-1. The second sooty terns controller 610-2 is configured to: generate the set of third optimized controller gain parameters by optimizing the third integrator fractional parameter constraint λ₃ and the third differentiator fractional parameter constraint μ₃; transmit the optimized third integrator fractional parameter constraint λ₃ and the optimized third differentiator fractional parameter constraint μ₃ to the FOPID-3 controller 604-2; generate the set of fourth optimized controller gain parameters by optimizing the fourth integrator fractional parameter constraint λ₄ and the fourth differentiator fractional parameter constraint μ₄; and transmit the optimized fourth integrator fractional parameter constraint λ₄ and the optimized fourth differentiator fractional parameter constraint μ₄ to the FOPID-4 controller 608-2.

In an aspect, a frequency to power converter 550 is located on the transmission line 558 between the tie-line 552 and the first adder 520 and the third adder 542. The frequency to power converter 550 is configured to convert the first frequency disturbance value Δfᵢ and the second frequency disturbance value Δf₂ to the combined area tie-line power disturbance value ΔP_{tie1,2}.

In another aspect, a method for mitigating frequency disturbances in a multi-area power plant 100 which includes a plurality of generators 100-1, 100-2 and a plurality of renewable energy sources (RES) 130, 132. The method comprises connecting, by an adder 406, an output terminal of a cascaded fractional model predictive controller (CFMPC) 402 and an output terminal of a first fractional-order proportional-integral-derivative (FOPID-1) controller 404 to an input terminal of a second fractional-order proportional integral derivative (FOPID-2) controller 408, wherein the CFMPC includes a set of CFMPC program instructions and at least one CFMPC processor configured to execute the set of CFMPC program instructions for receiving an area central error (ACE) signal and a load power disturbance signal ΔP_{L}, predicting a future output of the power plant, minimizing a controlled fitness equation (ITAE) based on the predicted future output, and generating a minimized ACE signal based on the minimizing the ITAE. The method further comprises generating, by a sooty terns controller 410, optimized controller gain parameters and transmitting the optimized controller gain parameters to the FOPID-1 controller 404 and the FOPID-2 controller 408, wherein the sooty terns controller 410 includes a sooty terns controller memory configured to store sooty terns controller program instructions including a sooty terns optimization algorithm (STOA), a set of FOPID-1 gain parameter constraints and a set of FOPID-2 gain parameter constraints, and at least one sooty terns controller configured to execute the STOA to optimize the ITAE, transmit the optimized ITAE to the MPC 402, and calculate the optimized controller gain parameters of the FOPID-1 controller 404 and the FOPID-2 controller 408. The method further comprises receiving a frequency disturbance signal Δf at an input terminal of the FOPID-1 controller 404. The method further comprises generating a frequency disturbance correction signal at an output terminal of the FOPID-1 controller 404. The method further comprises combining, by the adder 406, the minimized ACE signal and the frequency disturbance correction signal to generate a combined frequency correction signal. The method further comprises applying the combined frequency correction signal and a first droop control signal to an input of a first thermal energy generator 100-1 located in a first geographic area. The method further comprises generating, by the first thermal energy generator 100-1, a first power error signal ΔP_{R}_{₁} The method further comprises applying the combined frequency correction signal and a second droop control signal to an input of a second thermal energy generator 100-2 located in a second geographic area. The method further comprises generating, by the second thermal energy generator 100-2, a second power error signal ΔP_{R}_{₂}. The method further comprises combining, by a third adder 128, the first power error signal ΔP_{R}_{₁} the second power error signal ΔP_{R}_{₂}, an RES power error signal ΔP_{RES} from a plurality of RES 130, 132 connected to the multi-area power plant 100. The method further comprises generating, by the third adder 128, a power disturbance signal. The method further comprises subtracting, third subtractor 136, the power load disturbance feedback signal ΔP_{L} received from at least one load connected to the multi-area power plant, and a tie-line power disturbance signal ΔPₜᵢₑ from the power disturbance signal. The method further comprises generating, by the third subtractor 136, a plant power output error signal ΔPₛ. The method further comprises converting, by a generator 138, the plant power output error signal ΔPₛ to a frequency disturbance signal Δf. The method further comprises converting, by a frequency to power converter 146, the frequency disturbance signal Δf to a tie-line power disturbance signal ΔPₜᵢₑ. The method further comprises receiving, by a bias controller 142, the frequency disturbance signal Δf over a feedback connection line 144, and multiplying the frequency disturbance signal Δf by a frequency bias factor β. The method further comprises combining, by the first adder 102, the tie-line frequency disturbance signal ΔPₜᵢₑ and the frequency disturbance signal Δf multiplied by the frequency bias factor β. The method further comprises generating, by the first adder 102, the ACE signal. Minimizing the ACE mitigates the frequency disturbances in the multi-area power plant 100.

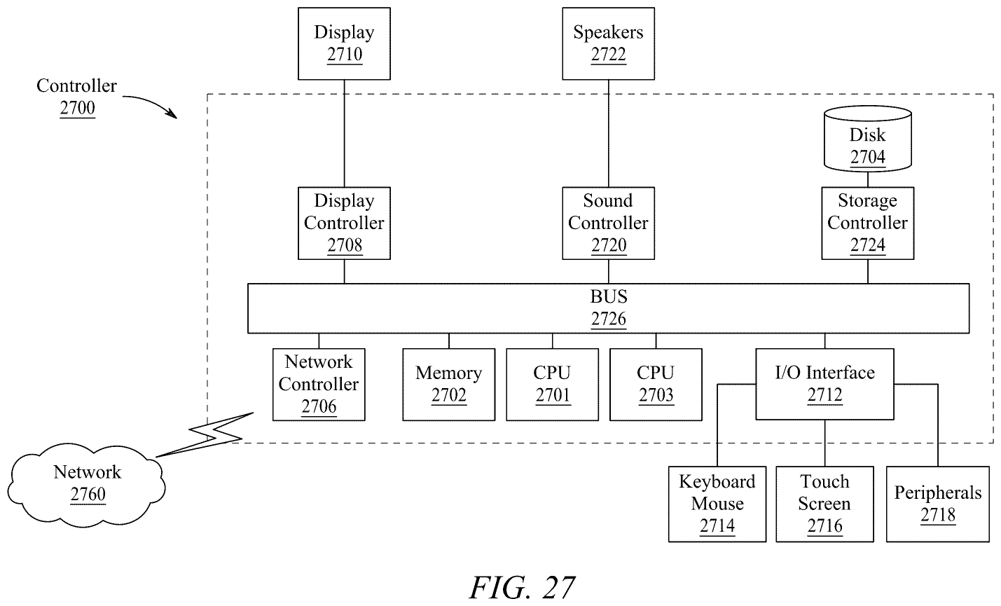

Next, further details of the hardware description of the computing environment according to exemplary embodiments is described with reference to FIG. 27. In FIG. 27, a controller 2700 is described is representative of the system and controllers 104, 400, 502, 524 of FIGS. 1, 4 and 5 in which the controller is a computing device which includes a CPU 2701 which performs the processes described above/below. The process data and instructions may be stored in memory 2702. These processes and instructions may also be stored on a storage medium disk 2704 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 2701, 2703 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 2701 or CPU 2703 may be a Xenon or Core processor from Intel of America or an Opteron processor from AMD of America, or may be other processor types that would be recognized by one of ordinary skill in the art. Alternatively, the CPU 2701, 703 may be implemented on an FPGA, ASIC, PLD or using discrete logic circuits, as one of ordinary skill in the art would recognize. Further, CPU 2701, 2703 may be implemented as multiple processors cooperatively working in parallel to perform the instructions of the inventive processes described above.

The computing device in FIG. 27 also includes a network controller 2706, such as an Intel Ethernet PRO network interface card from Intel Corporation of America, for interfacing with network 2760. As can be appreciated, the network 2760 can be a public network, such as the Internet, or a private network such as an LAN or WAN network, or any combination thereof and can also include PSTN or ISDN sub-networks. The network 2760 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 2708, such as a NVIDIA GeForce GTX or Quadro graphics adaptor from NVIDIA Corporation of America for interfacing with display 2710, such as a Hewlett Packard HPL2445w LCD monitor. A general purpose I/O interface 2712 interfaces with a keyboard and/or mouse 2714 as well as a touch screen panel 2716 on or separate from display 2710. General purpose I/O interface also connects to a variety of peripherals 2718 including printers and scanners, such as an OfficeJet or DeskJet from Hewlett Packard.

A sound controller 2720 is also provided in the computing device such as Sound Blaster X-Fi Titanium from Creative, to interface with speakers/microphone 2722 thereby providing sounds and/or music.

The general-purpose storage controller 2724 connects the storage medium disk 2704 with communication bus 2726, which may be an ISA, EISA, VESA, PCI, or similar, for interconnecting all of the components of the computing device. A description of the general features and functionality of the display 2710, keyboard and/or mouse 2714, as well as the display controller 2708, storage controller 2724, network controller 2706, sound controller 2720, and general purpose I/O interface 2712 is omitted herein for brevity as these features are known.

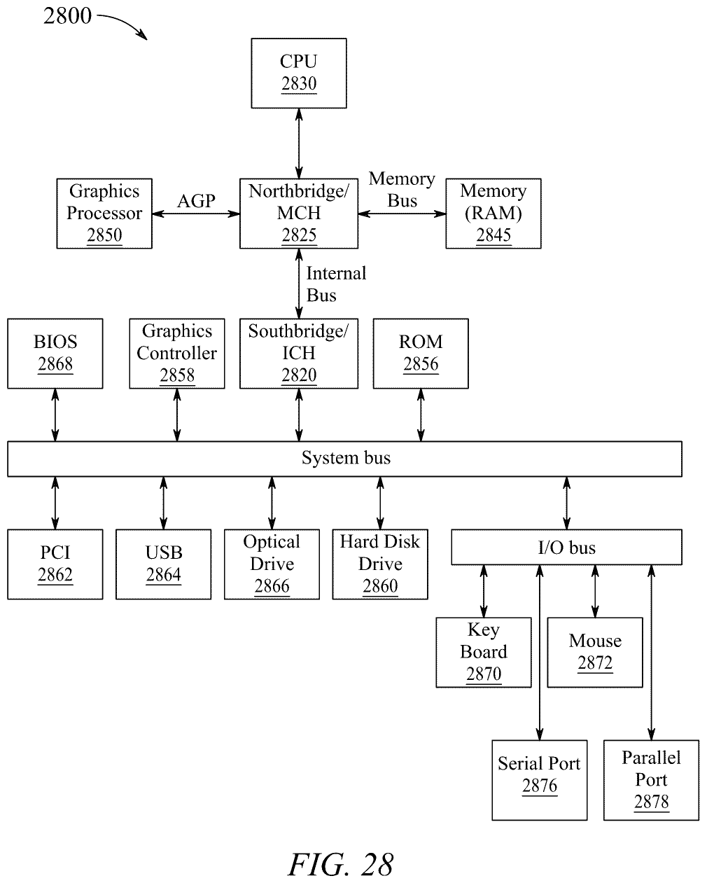

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 28.

FIG. 28 shows a schematic diagram of a data processing system, according to certain embodiments, for performing the functions of the exemplary embodiments. The data processing system is an example of a computer in which code or instructions implementing the processes of the illustrative embodiments may be located.

In FIG. 28, data processing system 2800 employs a hub architecture including a north bridge and memory controller hub (NB/MCH) 825 and a south bridge and input/output (I/O) controller hub (SB/ICH) 2820. The central processing unit (CPU) 2830 is connected to NB/MCH 2825. The NB/MCH 825 also connects to the memory 2845 via a memory bus, and connects to the graphics processor 2850 via an accelerated graphics port (AGP). The NB/MCH 2825 also connects to the SB/ICH 2820 via an internal bus (e.g., a unified media interface or a direct media interface). The CPU Processing unit 2830 may contain one or more processors and even may be implemented using one or more heterogeneous processor systems.

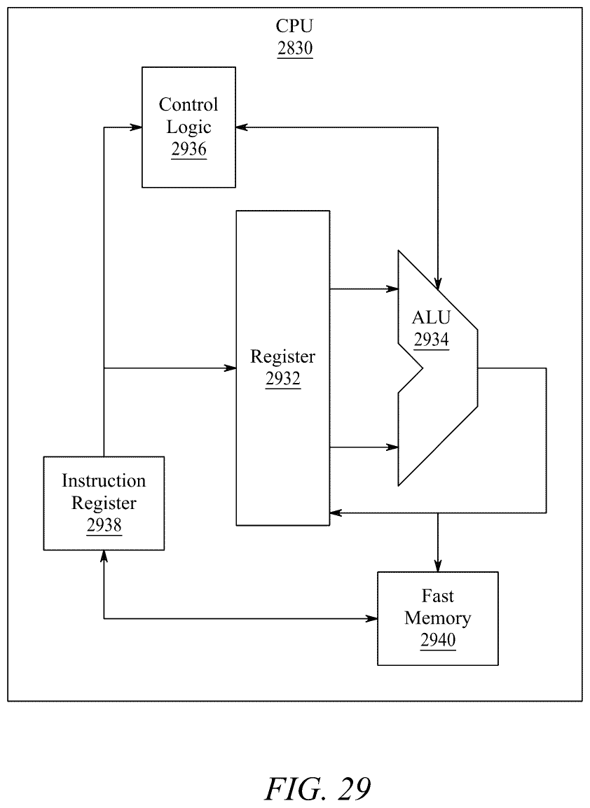

For example, FIG. 29 shows one implementation of CPU 2830. In one implementation, the instruction register 2938 retrieves instructions from the fast memory 2940. At least part of these instructions are fetched from the instruction register 2938 by the control logic 2936 and interpreted according to the instruction set architecture of the CPU 2830. Part of the instructions can also be directed to the register 2932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 2934 that loads values from the register 2932 and performs logical and mathematical operations on the loaded values according to the instructions. The results from these operations can be feedback into the register and/or stored in the fast memory 2940. According to certain implementations, the instruction set architecture of the CPU 830 can use a reduced instruction set architecture, a complex instruction set architecture, a vector processor architecture, a very large instruction word architecture. Furthermore, the CPU 2830 can be based on the Von Neuman model or the Harvard model. The CPU 2830 can be a digital signal processor, an FPGA, an ASIC, a PLA, a PLD, or a CPLD. Further, the CPU 2830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 28, the data processing system 2800 can include that the SB/ICH 2820 is coupled through a system bus to an I/O Bus, a read only memory (ROM) 2856, universal serial bus (USB) port 2864, a flash binary input/output system (BIOS) 2868, and a graphics controller 2858. PCI/PCIe devices can also be coupled to SB/ICH 2888 through a PCI bus 2862.

The PCI devices may include, for example, Ethernet adapters, add-in cards, and PC cards for notebook computers. The Hard disk drive 2860 and CD-ROM 2866 can use, for example, an integrated drive electronics (IDE) or serial advanced technology attachment (SATA) interface. In one implementation the I/O bus can include a super I/O (SIO) device.

Further, the hard disk drive (HDD) 2860 and optical drive 2866 can also be coupled to the SB/ICH 2820 through a system bus. In one implementation, a keyboard 2870, a mouse 2872, a parallel port 2878, and a serial port 2876 can be connected to the system bus through the I/O bus. Other peripherals and devices that can be connected to the SB/ICH 2820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

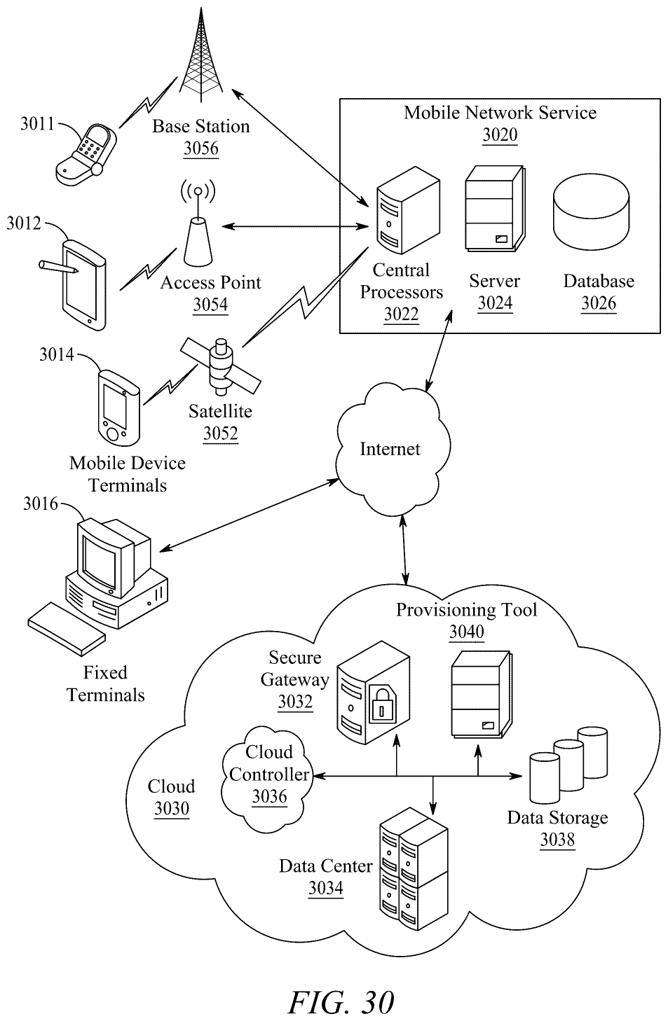

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 30, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A hybrid control system for mitigating frequency disturbances in a multi-area power plant, comprising:
a first thermal energy generator located in a first geographic area;
a second thermal energy generator located in a second geographic area, wherein an output terminal of the second thermal energy generator is connected to an output terminal of the first thermal energy generator by a tie-line;
a plurality of renewable energy sources (RES) having output terminals connected to the tie-line;
a plurality of loads connected to the tie-line;
a first adder configured to receive a frequency disturbance value Δfᵢ multiplied by a frequency bias factor βᵢ and to receive a tie-line power disturbance signal ΔP_{tie,i} from the tie-line over a measurement interval i, add the frequency disturbance value Δfᵢ multiplied by the frequency bias factor βᵢ to the tie-line power disturbance signal ΔP_{tie,i} and generate an area central error (ACE) signal;
a cascaded fractional model predictive controller (CFMPC) including:
a set of CFMPC program instructions and at least one CFMPC processor configured to execute the set of CFMPC program instructions to receive the area central error (ACE) signal and a load power disturbance signal ΔP_{L}, predict a future output of the power plant, minimize a controlled fitness equation (ITAE) based on the predicted future output, and generate a minimized ACE signal based on the minimizing the ITAE;
a first fractional-order proportional-integral-derivative (FOPID-1) controller configured to receive the frequency disturbance value Δfᵢ and generate a frequency disturbance correction signal based on a set of FOPID-1 gain parameters and the frequency disturbance value Δfᵢ;
a second adder configured to add a negative of the minimized ACE signal to a negative of the frequency disturbance correction signal and generate a combined frequency correction signal;
a second fractional-order proportional integral derivative (FOPID-2) controller configured to receive the combined frequency correction signal from the second adder and generate a frequency error correction signal;
a sooty terns controller configured to generate optimized controller gain parameters and transmit the optimized controller gain parameters to the FOPID-1 controller and the FOPID-2 controller;
a first droop controller configured to receive the frequency disturbance value Δfᵢ, calculate a first droop value 1/R₁, multiply the frequency disturbance value Δfᵢ by the first droop value 1/R₁, and generate a first droop control signal;
a first subtractor configured to receive the frequency error correction signal and the first droop control signal, subtract the first droop control signal from the frequency error correction signal, and transmit a first frequency error difference signal to the first thermal energy generator, wherein the first thermal energy generator is configured to receive the first frequency error difference signal and generate a first power error signal ΔP_{R}_{₁};
a second droop controller configured to receive the frequency disturbance value Δfᵢ, calculate a second droop value 1/R₂, multiply the frequency disturbance value Δfᵢ by the second droop value 1/R₂, and generate a second droop control signal;
a second subtractor configured to receive the frequency error signal and the second droop control signal, subtract the second droop control signal from the frequency error correction signal and transmit a second frequency error difference signal to the second thermal energy generator, wherein the second thermal energy generator is configured to receive the second frequency error difference signal and generate a second power error signal ΔP_{R}_{₂};
a third adder configured to add the first power error signal ΔP_{R}_{₁}, the second power error signal ΔP_{R}_{₂}, and an RES power error signal ΔP_{RES} and generate a plant power error signal ΔPₛ;
a third subtractor configured to receive the plant power error signal ΔPₛ and subtract the load power disturbance signal ΔP_{L}_{ᵢ} and the tie-line power disturbance signal ΔP_{tie,i} from the plant power error signal ΔPₛ and generate a plant power output error signal;
an output generator configured to receive the plant power output error signal and generate the frequency disturbance value Δfᵢ; and
a feedback connection line configured to transmit the frequency disturbance value Δfᵢ to the first droop controller, the second droop controller and the first adder.

2. The hybrid control system of claim 1, wherein the plurality of renewable energy sources (RES) include at least one photovoltaic array and at least one wind turbine.

3. The hybrid control system of claim 2, wherein the sooty terns controller includes a sooty terns controller memory configured to store sooty terns controller program instructions including a sooty terns optimization algorithm (STOA), a set of FOPID-1 gain parameter constraints and a set of FOPID-2 gain parameter constraints, and at least one sooty terns controller configured to execute the STOA to optimize the ITAE, transmit the optimized ITAE to the CFMPC, and calculate the optimized controller gain parameters of the FOPID-1 controller and the FOPID-2 controller.

4. The hybrid control system of claim 3, wherein the frequency disturbances of the power plant are regulated by minimizing the ACE.

5. The hybrid control system of claim 3, wherein the first thermal energy generator comprises:
a first governor having a dead band, wherein the first governor is configured to receive the first droop control signal and output a power change signal ΔP_{g}_{₁};
a first turbine having a rotor, wherein the power change signal ΔP_{g}_{₁} is configured to modify a speed of the rotor; and
a first reheater, wherein the first power error signal ΔP_{R}_{₁} is output from the first reheater.

6. The hybrid control system of claim 3, wherein the second thermal energy generator comprises:
a second governor having a dead band, wherein the second governor is configured to receive the second droop control signal and output a power change signal ΔPg₂;
a second turbine having a rotor, wherein the power change signal ΔP_{g}_{₂} is configured to modify a speed of the rotor; and
a second reheater, wherein the second power error signal ΔP_{R}_{₂} is output from the reheater.

7. The hybrid control system of claim 3, wherein:
the set of FOPID-1 gain parameter constraints includes a first integrator fractional parameter constraint λ₁ and a first differentiator fractional parameter constraint μ₁, where 0<λ₁<1 and 0<μ₁<1; and
the set of FOPID-2 gain parameter constraints include a second integrator fractional parameter constraint λ₂ and a second differentiator fractional parameter constraint λ₂, where 0<λ₂<1 and 0<μ₂<1.

8. The hybrid control system of claim 7, wherein the sooty terns controller is configured to:
optimize the first integrator fractional parameter constraint λ₁ and the first differentiator fractional parameter constraint μ₁ and transmit the optimized first integrator fractional parameter constraint λ₁ and the optimized first differentiator fractional parameter constraint μ₁ to the FOPID-1 controller; and
optimize the second integrator fractional parameter constraint λ₂ and the second differentiator fractional parameter constraint μ₂ and transmit the optimized second integrator fractional parameter constraint λ₂ and the optimized second differentiator fractional parameter constraint μ₂ to the FOPID-2 controller.

9. The hybrid control system of claim 8, wherein:
a transfer function of the FOPID-1 controller is given by:
$${G}_{1} ( s ) = {K}_{{p}_{1}} + {K}_{{I}_{1}} / {s}^{{λ}_{1}} + {K}_{{D}_{1}} {s}^{μ1} ;$$
and
a transfer function of the FOPID-2 controller is given by:
$${G}_{2} ( s ) = {K}_{{p}_{2}} + {K}_{{I}_{2}} / {s}^{{λ}_{2}} + {K}_{{D}_{2}} {s}^{μ 2} ,$$
where s is a complex frequency value of a Laplace transform.

10. The hybrid control system of claim 3, wherein the ITAE is given by:
$$ITAE = {\int }_{0}^{∞} t ( \vert Δ {f}_{i} \vert + \vert Δ {P}_{tie , i} \vert ) dt$$
where t is time.

11. A two-area hybrid power control system for mitigating frequency disturbances, comprising:
a first power system located in a first geographic area;
a second power system located in a second geographic area;
a tie-line configured to connect an output terminal of the first power system with an output terminal of the second power system;
wherein the first power system includes:
a first controller (CSMPC-FOPID-1);
a first thermal energy generator connected in series with the CSMPC-FOPID-1, wherein the first thermal energy generator is configured to generate a first thermal generator power disturbance signal ΔP_{R}_{₁};
a first plurality of renewable energy resources (RES-1), wherein each RES-1 has an RES-1 output terminal configured to generate a first RES-1 power disturbance signal ΔPᵣₑₛ_{₁};
at least one first load configured to generate a first load power disturbance signal ΔP_{L}_{₁} at a load output terminal;
a first adder connected to an input terminal of the CSMPC-FOPID-1, wherein the first adder is configured to generate a first area central error (ACE-1) signal;
a second adder connected to receive the first thermal generator power disturbance signal ΔP_{R}_{₁}, the first RES-1 power disturbance signal ΔPᵣₑₛ_{₁} the load power disturbance signal ΔP_{L}_{₁}, and a tie-line power disturbance signal ΔPₜᵢₑ from the tie-line, sum the first thermal generator power disturbance signal ΔP_{R}_{₁} with the first RES-1 power disturbance signal ΔPᵣₑₛ_{₁}, subtract the first load power disturbance signal ΔP_{L}_{₁}, subtract the tie-line power disturbance signal ΔPₜᵢₑ, and generate a first geographic area power disturbance signal ΔPₛ_{₁};
a first output generator configured to receive the first geographic area power disturbance signal ΔPₛ_{₁}, convert the first geographic area power disturbance signal ΔPₛ_{₁} to a first geographic area frequency disturbance value Δf₁, and output the first geographic area frequency disturbance value Δf₁ at a first output generator output terminal connected to the tie-line; and
a first feedback connection line connected to the tie-line, wherein the first feedback connection line is configured to transmit the first geographic area frequency disturbance value Δf₁ to an input terminal of the first adder;
wherein the second power system includes:
a second controller (CSMPC-FOPID-2);
a second thermal energy generator connected in series with the CSMPC-FOPID-2, wherein the second thermal energy generator is configured to generate a second thermal generator power disturbance signal ΔP_{R}_{₂};
a second plurality of renewable energy resources (RES-2), wherein each RES-2 has an RES-2 output terminal configured to generate a second RES-2 power disturbance signal ΔPᵣₑₛ_{₂};
a second load configured to generate a second load power disturbance signal ΔP_{L}_{₂} from a load output terminal;
a third adder connected to an input terminal of the CSMPC-FOPID-2, wherein the third adder is configured to generate a second area central error (ACE-2) signal;
a fourth adder connected to receive the second thermal generator power disturbance signal ΔP_{R}_{₂}, the second RES-2 power disturbance signal ΔPᵣₑₛ_{₂}, the load power disturbance signal ΔP_{L}_{₂}, and the tie-line power disturbance signal ΔPₜᵢₑ, sum the second thermal generator power disturbance signal ΔP_{R}_{₂} with the second RES-2 power disturbance signal ΔPᵣₑₛ_{₂}, subtract the second load power disturbance signal ΔP_{L}_{₂}, subtract the tie-line power disturbance signal ΔPₜᵢₑ, and generate a second geographic area power disturbance signal ΔPₛ_{₂};
a second output generator configured to receive the second geographic area power disturbance signal ΔPₛ_{₂} convert the second geographic area power disturbance signal ΔPₛ_{₂} to a second geographic area frequency disturbance value Δf₂, and output the second geographic area frequency disturbance value Δf₂ at a second output generator output terminal connected to the tie-line; and
a second feedback connection line connected to the tie-line, wherein the second feedback connection line is configured to transmit the second geographic area frequency disturbance value Δf₂ to an input terminal of the third adder;
a fifth adder connected to the tie-line, wherein the fifth adder is configured to subtract the second geographic area frequency disturbance value Δf₂ from the first geographic area frequency disturbance value Δf₁;
wherein the CSMPC-FOPID-1 includes:
a first cascaded fractional model predictive controller (CFMPC₁) including a set of CFMPC₁ program instructions and at least one CFMPC₁ processor configured to execute the set of CFMPC₁ program instructions to receive the ACE-1 signal and the first load power disturbance signal ΔP_{L}_{₁}, predict a future power output of the first power system, minimize a first controlled fitness equation (ITAE₁) based on the predicted future power output of the first power system, and generate a minimized ACE-1 signal based on the minimizing the ITAE₁;
a first fractional-order proportional-integral-derivative (FOPID-1) controller configured to receive the frequency disturbance value Δfᵢ and generate a first frequency disturbance correction signal based on a set of first FOPID-1 gain parameters and the first frequency disturbance value Δf₁;
a sixth adder configured to add a negative of the minimized ACE-1 signal to a negative of the first frequency disturbance correction signal and generate a first combined frequency correction signal;
a second fractional-order proportional integral derivative (FOPID-2) controller configured to receive the first combined frequency correction signal from the sixth adder and generate a first frequency error correction signal;
a first sooty terns controller configured to generate a set of first optimized controller gain parameters and transmit the set of first optimized controller gain parameters to the FOPID-1 controller and the FOPID-2 controller;
wherein the CSMPC-FOPID-2 includes:
a second cascaded fractional model predictive controller (CFMPC₂) including a set of CFMPC₂ program instructions and at least one CFMPC₂ processor configured to execute the set of CFMPC₂ program instructions to receive the ACE-2 signal and the second load power disturbance signal ΔP_{L}_{₂}, predict a future output of the second power system, minimize a second controlled fitness equation (ITAE₂) based on the predicted future output of the second power system, and generate a minimized ACE-2 signal based on the minimizing the ITAE₂;
a third fractional-order proportional-integral-derivative (FOPID-3) controller configured to receive the second frequency disturbance value Δf₂ and generate a second frequency disturbance correction signal based on a set of FOPID-3 gain parameters and the second frequency disturbance value Δf₂;
a seventh adder configured to add a negative of the minimized ACE-2 signal to a negative of the second frequency disturbance correction signal and generate a second combined frequency correction signal;
a fourth fractional-order proportional integral derivative (FOPID-4) controller configured to receive the second combined frequency correction signal from the seventh adder and generate a second frequency error correction signal;
a second sooty terns controller configured to generate a set of second optimized controller gain parameters and transmit the set of second optimized controller gain parameters to the FOPID-3 controller and the FOPID-4 controller; and
a transmission line connected at a first end to the tie-line, wherein a first terminal of a second end of the transmission line is connected to a second input terminal of the first adder and a second terminal of the second end of the transmission line is connected to a second input terminal of the third adder, wherein the transmission line is configured to feed back a combined area tie-line power disturbance value ΔPₜᵢₑ_{_{1,2}} to the first adder and the third adder.

12. The two-area hybrid power control system of claim 11, wherein:
the first plurality of renewable energy resources (RES-1) includes at least one photovoltaic array (PV₁) and at least one wind farm (WF₁); and
the second plurality of renewable energy resources (RES-2) includes at least one photovoltaic array (PV₂) and at least one wind farm (WF₂).

13. The two-area hybrid power control system of claim 12, wherein:
the first sooty terns controller includes a first sooty terns controller memory configured to store first sooty terns controller program instructions including a first sooty terns optimization algorithm (STOA-1), a set of FOPID-1 gain parameter constraints and a set of FOPID-2 gain parameter constraints, and at least one first sooty terns controller configured to execute the STOA-1 to optimize the ITAE₁, transmit the optimized ITAE₁ to the CSMPC₁, and calculate the first optimized controller gain parameters of the FOPID-1 controller and the FOPID-2 controller; and
the second sooty terns controller includes a second sooty terns controller memory configured to store second sooty terns controller program instructions including a second sooty terns optimization algorithm (STOA-2), a set of FOPID-3 gain parameter constraints and a set of FOPID-4 gain parameter constraints, and at least one second sooty terns controller configured to execute the STOA-2 to optimize the ITAE₂, transmit the optimized ITAE₂ to the CSMPC₂, and calculate the second optimized controller gain parameters of the FOPID-3 controller and the FOPID-4 controller.

14. The two-area hybrid power control system of claim 13, wherein the first thermal energy generator comprises:
a first droop controller configured to receive the frequency disturbance value Δfᵢ from the first feedback connection line, calculate a first droop value 1/R₁, multiply the frequency disturbance value Δf₁ by the first droop value 1/R₁, and generate a first droop control signal; and
a first subtractor configured to receive the frequency error correction signal and the first droop control signal, subtract the first droop control signal from the frequency error correction signal, and transmit a first frequency error difference signal to the first thermal energy generator 504.

15. The two-area hybrid power control system of claim 14, wherein the second thermal energy generator comprises:
a second droop controller configured to receive the frequency disturbance value Δf₂ from the second feedback connection line, calculate a second droop value 1/R₂, multiply the frequency disturbance value Δf₂ by the second droop value 1/R₂, and generate a second droop control signal; and
a second subtractor configured to receive the frequency error correction signal and the second droop control signal, subtract the second droop control signal from the frequency error correction signal, and transmit a second frequency error difference signal to the second thermal energy generator.

16. The two-area hybrid power control system of claim 15, further comprising:
a first bias controller connected to the first feedback connection line between the tie-line and the fifth adder, wherein the first bias controller is configured to multiply the first geographic area frequency disturbance value Δf₁ by a first frequency bias factor βᵢ; and
a second bias controller connected to the second feedback connection line between the tie-line and the seventh adder, wherein the second bias controller is configured to multiply the second geographic area frequency disturbance value Δf₂ by a second frequency bias factor β₂.

17. The two-area hybrid power control system of claim 16, wherein:
the set of FOPID-1 gain parameter constraints include a first integrator fractional parameter constraint λ₁ and a first differentiator fractional parameter constraint μ₁, where 0<λ₁<1 and 0<μ₁<1;
the set of FOPID-2 gain parameter constraints include a second integrator fractional parameter constraint λ₂ and a second differentiator fractional parameter constraint μ₂, where 0<λ₂<1 and 0<μ₂<1;
the set of FOPID-3 gain parameter constraints include a first integrator fractional parameter constraint λ₃ and a first differentiator fractional parameter constraint μ₃, where 0<λ₃<1 and 0<μ₃<1; and
the set of FOPID-4 gain parameter constraints include a second integrator fractional parameter constraint λ₄ and a second differentiator fractional parameter constraint μ₄, where 0<λ₄<1 and 0<μ₄<1.

18. The two-area hybrid power control system of claim 17, wherein:
the first sooty terns controller is configured to:
generate the set of first optimized controller gain parameters by optimizing the first integrator fractional parameter constraint λ₁ and the first differentiator fractional parameter constraint μ₁;
transmit the optimized first integrator fractional parameter constraint λ₁ and the optimized first differentiator fractional parameter constraint μ₁ to the FOPID-1 controller;
generate the set of second optimized controller gain parameters by optimizing the second integrator fractional parameter constraint λ₂ and the second differentiator fractional parameter constraint μ₂; and
transmit the optimized second integrator fractional parameter constraint λ₂ and the optimized second differentiator fractional parameter constraint λ₂ to the FOPID-2 controller;
the second sooty terns controller is configured to:
generate the set of third optimized controller gain parameters by optimizing the third integrator fractional parameter constraint λ₃ and the third differentiator fractional parameter constraint μ₃;
transmit the optimized third integrator fractional parameter constraint λ₃ and the optimized third differentiator fractional parameter constraint μ₃ to the FOPID-3 controller;
generate the set of fourth optimized controller gain parameters by optimizing the fourth integrator fractional parameter constraint λ₄ and the fourth differentiator fractional parameter constraint μ₄; and
transmit the optimized fourth integrator fractional parameter constraint λ₄ and the optimized fourth differentiator fractional parameter constraint μ₄ to the FOPID-4 controller.

19. The two-area hybrid power control system of claim 18, further comprising:
a frequency to power converter located on the transmission line between the tie-line and the first adder and the third adder, wherein the frequency to power converter is configured to convert the difference between the first frequency disturbance value Δfᵢ and the second frequency disturbance value Δf₂ output by the fifth adder to the combined area tie-line power disturbance value ΔPₜᵢₑ_{_{1,2}}.

20. A method for mitigating frequency disturbances in a multi-area power plant which includes a plurality of generators and a plurality of renewable energy sources (RES), comprising:
connecting an output terminal of a cascaded fractional model predictive controller (CFMPC) and an output terminal of a first fractional-order proportional-integral-derivative (FOPID-1) controller to an input terminal of a second fractional-order proportional integral derivative (FOPID-2) controller 408, wherein the CFMPC includes a set of CFMPC program instructions and at least one CFMPC processor configured to execute the set of CFMPC program instructions for receiving an area central error (ACE) signal and a load power disturbance signal ΔP_{L}, predicting a future output of the power plant, minimizing a controlled fitness equation (ITAE) based on the predicted future output, and generating a minimized ACE signal based on the minimizing the ITAE;
generating, by a sooty terns controller, optimized controller gain parameters and transmitting the optimized controller gain parameters to the FOPID-1 controller and the FOPID-2 controller, wherein the sooty terns controller includes a sooty terns controller memory configured to store sooty terns controller program instructions including a sooty terns optimization algorithm (STOA), a set of FOPID-1 gain parameter constraints and a set of FOPID-2 gain parameter constraints, and at least one sooty terns controller configured to execute the STOA to optimize the ITAE, transmit the optimized ITAE to the MPC, and calculate the optimized controller gain parameters of the FOPID-1 controller 404 and the FOPID-2 controller;
receiving a frequency disturbance signal Δf at an input terminal of the FOPID-1 controller;
generating a frequency disturbance correction signal at an output terminal of the FOPID-1 controller;
combining the minimized ACE signal and the frequency disturbance correction signal to generate a combined frequency correction signal;
applying the combined frequency correction signal and a first droop control signal to an input of a first thermal generator located in a first geographic area;
generating, by the first thermal generator, a first power error signal ΔP_{R}_{₁};
applying the combined frequency correction signal and a second droop control signal to an input of a second thermal generator located in a second geographic area;
generating, by the second thermal generator, a second power error signal ΔP_{R}_{₂};
combining the first power error signal ΔP_{R}_{₁}, the second power error signal ΔP_{R}_{₂}, an RES power error signal ΔP_{RES} from a plurality of RES connected to the multi-area power plant;
generating a power disturbance signal;
subtracting the power load disturbance feedback signal ΔP_{L} received from at least one load connected to the multi-area power plant, and a tie-line power disturbance signal ΔPₜᵢₑ from the power disturbance signal;
generating a plant power output error signal ΔPₛ;
converting, by a generator, the plant power output error signal ΔPₛ to a frequency disturbance signal Δf;
converting, by a frequency to power converter, the frequency disturbance signal Δf to a tie-line power disturbance signal ΔPₜᵢₑ;
receiving, by a bias controller, the frequency disturbance signal Δf over a feedback line, and multiplying the frequency disturbance signal Δf by a frequency bias factor μ;
combining, by the first adder, the tie-line frequency disturbance signal ΔPₜᵢₑ and the frequency disturbance signal Δf multiplied by the frequency bias factor β; and
generating the ACE signal,
wherein minimizing the ACE mitigates the frequency disturbances in the multi-area power plant.
